(19) United States
(12) Patent Application Publication
(10) Pub. No.: US 2013/0073306 A1
(43) Pub. Date: Mar. 21, 2013

(54) HEALTHCARE PRE-VISIT AND FOLLOW-UP SYSTEM

(71) Applicants: JORDAN SHLAIN, San Francisco, CA (US); Mayank Thanawala, San Jose, CA (US); Benjamin Rosner, Woodside, CA (US); Cheryl Toth, San Jose, CA (US); Ted Meisel, Los Angeles, CA (US); Steven Cohen, San Francisco, CA (US)

(72) Inventors: JORDAN SHLAIN, San Francisco, CA (US); Mayank Thanawala, San Jose, CA (US); Benjamin Rosner, Woodside, CA (US); Cheryl Toth, San Jose, CA (US); Ted Meisel, Los Angeles, CA (US); Steven Cohen, San Francisco, CA (US)

(21) Appl. No.: 13/617,774

(22) Filed: Sep. 14, 2012

Related U.S. Application Data
(60) Provisional application No. 61/535,647, filed on Sep. 16, 2011.

(51) Int. Cl. G06Q 50/22

(52) U.S. Cl. 705/2

(57) ABSTRACT

Data processing methods facilitate an exchange, between healthcare providers and patients or other users, of structured data for objective health signs and subjective symptoms from the patient or caregiver during a pre-visit and/or follow-up period of care; standardized data-informed Loop protocols for following health conditions; data-informed ARC OF RECOVERY profiles that represent population-based recovery standards for signs, symptoms, or composites; automated alerts, based on analytics or machine learning, to warn health care providers regarding impending treatment failures or worsening of conditions. Patients in pre-visit or follow-up stages of healthcare respond to questions structured by a provider for objective signs and subjective symptoms, and may view questions and responses with associated alerts or status updates in a consolidated display that provides patient graphic images and comments about conditions. Aspects of pre-visit or follow-up care are Tracker historical graphical displays for evaluation by the physician against expected profiles, protocols or other standards.

### BENEFIT CLAIM

This application claims the benefit under 35 U.S.C. 119 of prior provisional application 61/535,647, filed Sep. 16, 2011, the entire contents of which is hereby incorporated by reference for all purposes as if fully set forth herein.

### TECHNICAL FIELD

This disclosure generally relates to computer systems in healthcare. The disclosure relates more specifically to exchanging structured and/or codified data using computer networks, defining and tracking healthcare pre-visit and recovery paths, and generating automated alert messages.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. Copyright © 2010-2012 HealthLoop, Inc. HEALTHLOOP, ARC OF RECOVERY and ARC OF PRECOVERY are trademarks or registered trademarks of HealthLoop, Inc.

### BACKGROUND

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

Follow-up care may be defined as aspects of healthcare that occur after a clinical visit, procedure, hospitalization, or other encounter with a healthcare provider. While the effectiveness of follow-up care is known to have a significant impact on treatment failure, hospital readmissions, morbidity or mortality, in current practice the processes for carrying out follow-up care are poorly defined. Inadequate follow-up care also may be associated with increased healthcare costs arising from complications, treatment failures or readmissions.

Pre-operative, pre-procedure, or pre-visit care may be defined as aspects of healthcare that occur before a clinical visit, surgery or other procedure, hospitalization, or other encounter with a healthcare provider. While the effectiveness of pre-visit care is known to have a significant impact on the success of a subsequent treatment, in current practice the processes for carrying out pre-visit care are poorly defined. Inadequate pre-visit care also may be associated with increased healthcare costs arising from cancellation or rescheduling because a patient is unprepared or improperly prepared, complications, treatment failures or readmissions.

Certain computer systems are capable of facilitating the exchange of structured and/or codified data and generating alert messages; however, at present these systems are not applied to the special problems and challenges inherent in tracking follow-up or pre-visit care in the modern healthcare environment.

### SUMMARY OF INVENTION

The appended claims may serve as a summary of the invention.

### BRIEF DESCRIPTION OF THE DRAWINGS

In the drawings:

FIG. 1A illustrates an embodiment of a healthcare pre-visit and follow-up system.

FIG. 1B illustrates an example screen display for a computer graphical user interface providing a consolidated view, for a healthcare provider, of patients that the provider is tracking.

FIG. 1C illustrates another embodiment of a healthcare pre-visit and follow-up system.

FIG. 1D illustrates an example healthcare pre-visit and follow-up process.

FIG. 2 illustrates an example screen display for a computer graphical user interface for a provider showing entering a new Loop.

FIG. 3 illustrates an example screen display for a computer graphical user interface for a provider showing selecting an existing patient.

FIG. 4 illustrates an example screen display for a computer graphical user interface for a provider showing entering a new patient.

FIG. 5 illustrates an example screen display for a computer graphical user interface for a provider showing entering a new caregiver.

FIG. 6 illustrates an example screen display for a computer graphical user interface for a provider showing selecting a Loop template.

FIG. 7 illustrates an example screen display for a computer graphical user interface for a provider showing elements of a Trackers tab.

FIG. 8 illustrates an example screen display for a computer graphical user interface for a provider showing elements of a Reminders tab.

FIG. 9 illustrates an example screen display for a computer graphical user interface for a provider showing elements of a Medications tab.

FIG. 10 illustrates an example screen display for a computer graphical user interface for a provider showing a Patient Material tab.

FIG. 11 illustrates an example screen display for a computer graphical user interface for a provider showing a Loop Feed.

FIG. 12 illustrates an example screen display for a computer graphical user interface for a provider showing a Loop Feed with graphs.

FIG. 13 illustrates an example screen display for a computer graphical user interface for a provider showing a Loop Feed with engagement information.

FIG. 14 illustrates an example screen display for a computer graphical user interface for a provider showing Loop details.

FIG. 15 illustrates an example screen display for a computer graphical user interface for a provider showing displaying Trackers.

FIG. 16 illustrates an example screen display for a computer graphical user interface for a provider showing creating a new Tracker.

FIG. 17 illustrates an example screen display for a computer graphical user interface for a provider showing adding a multiple choice question to a Tracker.

FIG. 18 illustrates an example screen display for a computer graphical user interface for a provider showing adding a numeric question to a Tracker.

FIG. 19 illustrates an example screen display for a computer graphical user interface for a provider showing entering Reminders.

FIG. 20A illustrates an example screen display for a computer graphical user for a provider interface showing entering a new Reminder.

FIG. 20B illustrates an example screen display for a computer graphical user interface for a provider showing entering a new medication.

FIG. 21 illustrates an example screen display for a computer graphical user interface for a provider showing entering patient material or care instructions.

FIG. 22 illustrates an example screen display for a computer graphical user interface for a patient and showing a check in page.

FIG. 23 illustrates an example screen display for a computer graphical user interface for a patient and showing a patient Loop Feed.

FIG. 24 illustrates an example screen display for a computer graphical user interface for a patient and showing a patient Loop Feed.

FIG. 25 illustrates an example screen display for a computer graphical user interface for a patient and showing a patient Loop Feed with downloads.

FIG. 26 illustrates an example screen display for a computer graphical user interface for a patient and showing a patient Loop Feed with graphs.

FIG. 27 illustrates an example screen display for a computer graphical user interface for a provider and showing a clinic practice management page.

FIG. 28 is a block diagram that illustrates a computer system upon which an embodiment of the invention may be implemented.

FIG. 29 depicts one rendition of normal and abnormal ARC OF RECOVERY profiles.

FIG. 30 illustrates a functional overview of an embodiment.

FIG. 31 illustrates an example graphical user interface of an embodiment that is generated by application logic for creating a new treatment Loop.

FIG. 32 illustrates an example acute Loop message that may be automatically communicated from or on behalf of a manager to a user.

FIG. 33 illustrates an example chronic Loop message that may be automatically communicated from or on behalf of a manager to a user.

FIG. 34 illustrates an example online update request page that may be generated in response to a user selecting a hyperlink prompting a response to a trackable item.

FIG. 35 illustrates an example healthcare provider's view of summary information for a plurality of open Loops pertaining to one or more users or patients.

FIG. 36 illustrates a table of example graphical icons, color codes, associated loop types, associated meaning, associated indications of progress graphs, and suggested actions that may be used in an embodiment.

FIG. 37 illustrates adding a Trackable or Tracker to a Treatment.

FIG. 38 illustrates a graphical user interface that the application logic may implement to enable creating a custom Numeric Trackable.

FIG. 39 illustrates a graphical user interface that the application logic may generate to enable creating a custom Relative Trackable.

FIG. 40 illustrates an example screen display for a computer graphical user interface for a provider showing entering a new Loop.

FIG. 41 illustrates an example screen display for a computer graphical user interface for a provider showing entering a new Loop. FIG. 42 illustrates an example screen display for a computer graphical user interface for a provider showing entering a new caregiver.

FIG. 43 illustrates an example screen display menu configured to receive a search or selection of a Loop Template.

FIG. 44 illustrates an example partial screen display for a computer graphical user interface for adding a Tracker.

FIG. 45 illustrates an example partial screen display menu configured to receive configuration data for a Reminder component of a particular Loop.

FIG. 46 illustrates an example partial screen display showing a Tracker graph.

FIG. 47 illustrates an example partial screen display showing a set of Confirmations for a particular Loop.

FIG. 48 illustrates an example partial screen display that may be generated for viewing Trackers as an alternative to FIG. 15.

FIG. 49 illustrates an example partial screen display that may be generated for creating new Trackers as an alternative to FIG. 16.

FIG. 50 illustrates an example partial screen display configured to receive data for defining a new Tracker with numeric response values, as an alternative to FIG. 18.

FIG. 51 illustrates an example screen display for displaying Confirmations that have been configured in the system.

FIG. 52 illustrates an example screen display for receiving data to define a new Confirmation.

FIG. 53 illustrates an example screen display for a patient Loop display with Trackers and a Loop feed.

### DESCRIPTION OF EXAMPLE EMBODIMENTS

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### 1.0 Overview

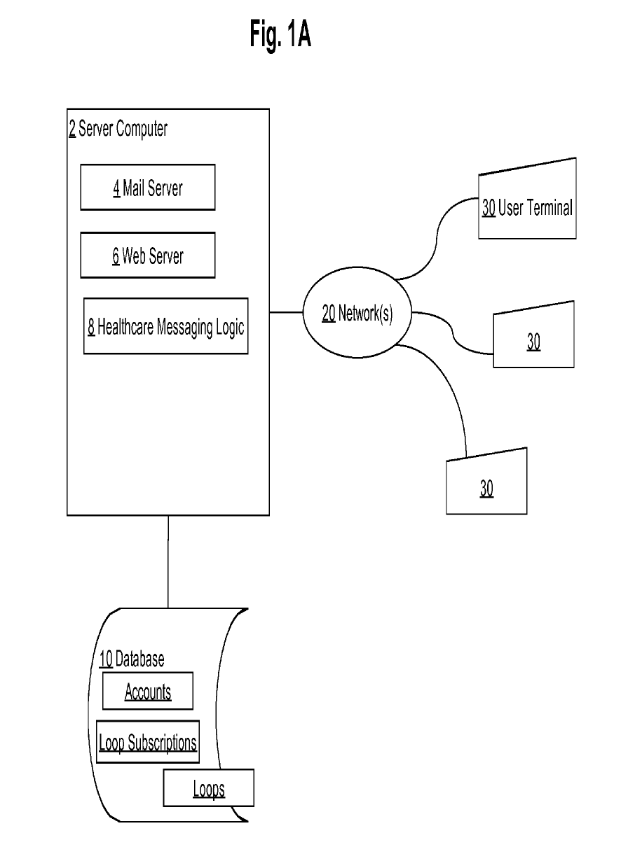

FIG. 1A illustrates an embodiment of a healthcare pre-visit and follow-up system that generally comprises one or more specially programmed server computers 2, coupled to a database 10 or other data repository, and including application logic in the form of healthcare messaging logic 8, a mail server 4, and a web server 6. Healthcare providers, administrators, patients, and other users may use user terminals 30 to interact with the server computers using secure connections over one or more private or public networks 20.

User terminals 30 may comprise personal computers, tablet computers, smartphones, or other computing devices that can host browsers and communicate over networks.

The healthcare messaging logic 8 may comprise, in one embodiment, a downloadable application for a mobile computing device such as a smartphone. Additionally or alternatively, the logic 8 may be implemented as one or more computer programs or other software elements based on a Web application server that deliver pages or screen displays as further described herein for display on a compatible browser at the user terminals 30. The server computers may also implement an analytics engine configured to count, measure and otherwise analyze data stored in the repository and other system elements to yield reports, metrics or data tables relating to patient engagement in follow-up or pre-visit care, provider performance, and other output. As an example, in FIG. 1A, healthcare messaging logic 8 is shown as a single block but in various embodiments, the logic may be implemented as any number of computer programs, methods, objects, components, or other software elements in a framework or other form of organization with or without an application programming interface (API) for use by other systems or components. For example, various components may implement the database operations, graphical user interface rendering, decision logic, and/or state changes that are referenced herein in describing the drawing figures or that are implicit or apparent from an understanding of the process flows and methods that are described herein in connection with the drawing figures.

Networks 20 may comprise any of LAN links, WAN links, intranets, internetworks, or a combination of any of the foregoing. The mail server 4 may comprise a simple mail transport protocol (SMTP) daemon and the web server 6 may comprise an HTTP daemon, both of which may be callable or capable of invocation by the healthcare messaging logic 8 respectively to send and receive emails and get, post, or otherwise communicate data or documents over HTTP or any other TCP/IP-based protocol, including the possible use of security and encryption protocols such as Secure Socket Layer (SSL) or others. While email transport is described herein for certain embodiments as an example, in other embodiments, each message specified herein as an email message may be sent using any other available message transport mechanism, such as short message service (SMS) or other text messaging, instant messaging, dedicated messaging within the GUI that is further described herein, automatic voice response (AVR) or other automatic calling, etc.

In general, embodiments of the application logic implement computer-assisted techniques for one or more of:
An exchange, between healthcare providers and patients or other users, based on open communication protocols and electronic document formats such as HTTP and HTML, of structured and/or codified data consisting of objective health signs and subjective symptoms that are provided by the patient or a caregiver during a follow up period of care;
Creation of standardized data-informed ARC OF RECOVERY profiles and Loop protocols for following acute and chronic health conditions or procedures;
An automated alert system, based on known or discovered recovery data and/or machine learning algorithms, to warn health care providers about impending treatment failures or worsening of conditions.

Embodiments of the application logic may be configured for performing a plurality of healthcare follow-up ARC OF RECOVERY profiles and Loop protocols. Each ARC OF RECOVERY profile is an evidence-based and population-based expected trajectory of a patient's recovery following a diagnosis, treatment, procedure, surgery, or clinical encounter. An ARC OF RECOVERY profile is specific to a diagnosis, disease, and/or procedure, as well as patient demographics and comorbidities. An ARC OF RECOVERY profile consists of the ARC OF RECOVERY profile of associated Trackers as well as one or more composites of those Trackers. The term Trackable is sometimes used in this disclosure to refer to elements that are equivalent to Trackers. In this context, a composite Tracker or calculated Tracker may be derived from a composite of other variables. As an example, tracking body mass index (BMI) values may be implemented as a calculated Tracker in which a result BMI value is derived from weight and height values that are entered by the user; the application logic calculates a BMI value, which may be graphed based on the patient or healthcare provider input. An ARC OF RECOVERY graph displays the trends of Trackers and composites of Trackers over time and may include reference lines for population-based values for reasonably matched individuals including 50^{th} percentile trend lines, 75^{th} percentile trend lines, 95^{th} percentile trend lines, etc.

In an embodiment, a Loop protocol and an associated ARC OF RECOVERY profile may be described in computer-understandable language or syntax, and are capable of improvement or refinement based upon patient interactions. In an embodiment, numerous pre-defined Loop protocols are stored in a protocol library in a data repository, and healthcare providers may define new protocols at any time. In one sense, the protocol library in conjunction with the application logic acts like an expert system to obtain information from patients and provide responses for viewing by physicians or other healthcare providers. Providers may view the status of a particular patient's progress with respect to any particular protocol in a consolidated view that is prioritized so that a provider may consider more rapid or particular action for a patient that is in an urgent situation. Patient responses over time may be used to refine or improve the content or accuracy of the Loop protocols and ARC OF RECOVERY profile; for example, changes in the alerts that are given to healthcare providers may occur, or the number of alerts may be decreased or increased according to weighting algorithms or other data developed as a consequence of patient responses. For example, the application logic may be configured to display “Like,” “Agree,” “Unlike,” “Disagree,” or other response buttons or links in association with a particular alert message; in response to receiving input indicating user selection of one of the response buttons or links, the application logic may update a weight value or set of weight values associated with the alert and use the weight value(s) to determine whether to send future alert messages that may be similar. Similar response buttons and weighting logic may be implemented in connection with messages directed to clinical staff.

In an embodiment, an ARC OF PRECOVERY profile is similar to an ARC OF RECOVERY profile, but applies to situations such as pre-operative planning and tracking. For example, an ARC OF PRECOVERY may represent an expected progression through a set of pre-procedure care instructions. Thus, in an embodiment, Trackers and/or Confirmations may track progress of a user through a pre-operative, pre-procedure, or pre-encounter period of care rather than a follow-up period of care.

In an embodiment, a Loop comprises a set of electronic protocols that inform a patient during follow-up or pre-visit care through automated reminders, emails, and other communications, track a patient's signs, symptoms, objective measures, and/or condition after a diagnosis, treatment, procedure, surgery, or clinical encounter, provide relevant Reminders, and/or distribute patient educational information or care instructions (termed Patient Materials in some embodiments). A Loop is commonly initiated following (but sometimes in advance of) a clinical encounter, and may be closed when the clinician and/or patient feel that the condition no longer needs to be tracked. Loop protocols generate electronic queries to patients, whose responses are transmitted to a data storage system, analyzed, and made visible via a dashboard that is reviewed by clinicians to ensure patients are recovering as expected.

Rules and algorithms inherent in the Loop's protocol set alert physicians or staff when a patient is at risk of treatment failure, complications, or hospital admission or readmission. Examples of algorithms that may be used in an analytics engine to predict treatment failures include rules-based logistical algorithms involving alert thresholds for trends, slopes, or durations of Trackers or composite Trackers, or analytical-based predictive algorithms using mathematical models including but not limited to Kalman filters, Bayesian models, predictive models, regression models, stochastic models, or others for predictive alerts or for alerts based on logistic and retrospective calculations. In an embodiment, machine-based learning may be used to refine the models as Tracker data, ARC OF RECOVERY profiles, and user responses are incorporated. In an embodiment, the application logic may determine colors of icons representing a patient, a Tracker, or a Confirmation in response to evaluation of one or more alert rules. For example, an alert rule may specify a set of conditions which, if satisfied, causes generating and sending an alert message to a healthcare provider and, when the provider views a Loop Feed or Dashboard that includes a particular patient, displays an icon representing the patient in a particular color corresponding to an alert level.

A Loop also contains a system for patients, clinicians, staff, and other individuals involved in the patient's care and follow-up or pre-visit care to communicate about the patient's recovery process or condition management. For convenience, a Loop is typically named according to a broad medical condition or disease, but any appropriate label may be used. In an embodiment, Loops may be identified by industry standard code sets (e.g. ICD, CPT), and language within the Loops and Reminders, Confirmations, Trackers, and Care Instructions may be consistent with and mapped to industry standard terminology and/or taxonomy (e.g. SNOMED CT among others).

In an embodiment, a Tracker comprises a component that can be added to a Loop, allowing a clinician to monitor a specific sign, symptom, biomarker, or condition. Examples include: pain, swelling, weight, shortness of breath, blood pressure, and others. Patients are prompted to enter information regarding Trackers in multiple formats including numeric rating scales, binary responses such as “yes/no,” selections from lists of choices or pull down menus describing symptoms, relative values, and a variety of other response mechanisms. Patient responses to Trackers are stored as part of the Loop, within the system. A weight value may be associated with a Tracker for the purpose of weighting the importance of the Tracker and patient responses to it.

In an embodiment, the automated alert system may be implemented in the application logic in several ways. In one embodiment, a Loop is established with an End Date, and an alert message is generated to the provider when the End Date arrives. This approach enables the provider to check on the patient's responses with respect to signs and symptoms at the specified End Date and compare the patient's progress with an associated ARC OF RECOVERY profile for the Loop. In another embodiment, the application logic may generate an alert message and post the alert message to a Loop Feed of a provider when a patient selects one of several question responses that are associated with urgent conditions. For example, if the question is “How do you feel today?” and the patient selects “I am MUCH WORSE” in response, rather than “I am BETTER”, then the application logic may generate an alert for that particular response.

Additionally or alternatively, in an embodiment, alert messages may be generated based upon rules that relate to the slope or duration of trend represented in a graph line in a Tracker, or based on combinations of one Tracker or Confirmation with another Tracker or Confirmation. Additionally or alternatively, in an embodiment, alert messages may be generated based upon a patient's Tracker or composite Tracker value(s) relative to an appropriately matched population set for similar conditions and/or Trackers.

Each Tracker or Confirmation may be defined with an alert condition that is associated with an absolute value, a slope value, a percentile value, or duration value for a trend represented in the Tracker. The application logic may be configured to generate and post an alert to the provider's Loop Feed when a threshold is detected regarding the slope, absolute value, percentile, or duration of trend in a particular Tracker. Generating and posting alerts may be based on rules, such as Boolean, logistic, or other rules relating to Tracker or Confirmation trends; additionally or alternatively, generating and posting alerts may be based on Kalman filters and other techniques that may replace or enhance rule-based alerts. In an embodiment, a provider may mark a patient response with an importance marker that is used in combination with any of the foregoing data to determine whether to generate an alert.

In some embodiments, patients may add one or more personally defined Trackers to Loops. For example, in an embodiment, a patient may decide that the patient wishes to track the patient's blood pressure even though the patient's doctor has not specifically activated a Tracker for that parameter, and may select a link, button or other GUI widget that adds a blood pressure Tracker to a particular Loop so that the patient and/or the healthcare provider are able to view data associated with the Tracker. In an embodiment, patients or caregivers may access and use links, buttons or other GUI widgets that cause creating or adding new Loops in association with a patient, optionally in exchange for paying a fee. For example, if an individual believes that a patient may be developing pneumonia, then the individual could be able to independently create a Loop for pneumonia in association with a patient record and could associate a particular healthcare provider with that Loop to facilitate review and communications concerning the condition.

Machine learning techniques based on data developed in the database, or from external sources, may be used to vary the alert generating criteria.

Various sections of the disclosure use the term “patient” for convenience to refer to the subject of information processing using the techniques herein. The term “patient” includes patient surrogates such as caregivers, family members, and other persons associated with a patient.

In an embodiment, the application logic implements the foregoing elements in the form of a patient-facing email and web portal system in which patient enters answers to prompts about signs and symptoms, receives reminders regarding treatment and follow-up or pre-visit care, and may send communications to their health care providers. The application logic also implements a healthcare provider facing portal which includes a display of current and prior patient action items termed Loops, monitors for patient responses to prompts, graphical representation of patient progress, automated alerts regarding patient status, and selection of either automated or customizable Loops.

In an embodiment, database 110 fundamentally stores tables or other entities that represent accounts, Loop subscriptions, and Loops. Numerous other elements that may be stored in database 110 are described further herein in connection with particular functions of the application logic.

APPENDIX 1 to the provisional disclosure provides an example database schema that may be used in one embodiment; other embodiments may organize the database 110 in other specific ways. In the example schema, accounts are associated with account types and may represent patients, healthcare practices or practitioners, or other types of users. A single user may have different accounts with different practices with the same login credentials. Loop subscriptions indicate which accounts are associated with which Loops. For example, a Loop Subscription specifies who participates in a Loop and may include any of a patient, physician, nurse, medical assistant, physician assistant, family member, caregiver, etc. Each of the Loops may be associated with one or more Trackers, Reminders, Confirmations, care instructions, medications, or any other similar component, each of which may comprise a combination of multiple choice questions, numeric questions, free text prompts, messages, downloadable materials, or prescribed dosages. Collectively these data may be associated in parameters that facilitate determining how a patient is performing or faring in comparison to one or more desired actions or health states. Each of the Loops may have one or more posts, such as messages from patients or healthcare providers, and one or more notes. The application logic may generate Loop notifications and may track responses to the notifications.

Selected benefits of the approaches herein may include:

1. Reduction in treatment failures, hospital admissions or readmissions, and morbidity/mortality in the follow-up period after clinic visits, same day procedures, and hospitalizations.

2. Reduction in expenditures associated with complications, treatment failures, and admission as well as readmission rates.

3. Improvement in physician, hospital, and health system performance measures.

4. Improvement in cost-effectiveness of pre-visit and follow-up care.

5. Improvement in patient compliance prior to a healthcare encounter and during follow-up care.

6. Identification of key prognostic indicators regarding recovery.

7. Reduction in canceled or rescheduled encounters, treatment failures, hospital admissions or readmissions, and morbidity/mortality arising from patients failing to properly prepare for or follow preparatory instructions relating to clinic visits, procedures, treatments or other encounters.

While certain embodiments are described herein using the specific use case of a healthcare pre-visit and follow-up system as an example, the general techniques described herein may be used in many other contexts. In one embodiment, the application logic, or individual elements of the application logic that implement Loops, Trackers, reminders, alerts, and other processes and techniques described herein, may be implemented together or individually as a component or engine that can be integrated into, called by, referenced or otherwise used in other systems, applications, computer programs, and other computing devices. For example, such a component may drive the analytics and/or data storage behind a mobile-based application. As another example, such a component may provide input into the prioritization of patients in an external software system, such as an electronic medical records (EMR) system; in various embodiments such a component may be integrated into the EMR or may be connected to the EMR using a programmatic interface or messaging interface. As yet another example, such a component may pull data from (or receive pushed data from) external systems such as laboratory software systems or home health tracking systems. In any of the foregoing embodiments, one or more components of the application logic herein may be connected to other systems using programmatic interfaces or calling frameworks such as XML, JSON and/or HL7 APIs.

### 2.0 First Example Embodiment

Certain embodiments are described herein with reference to drawing figures that show examples of graphical user interface screen displays. However, each of the drawing figures merely provides one example, and other embodiments may use other screen displays with different formats, layouts, graphics, text, and/or arrangements of GUI widgets that are functionally similar or functionally different.

Provider Screen Displays and Functions

FIG. 1B illustrates an example screen display for a computer graphical user interface providing a consolidated view, for a healthcare provider, of patients that the provider is tracking.

In one embodiment, the screen display 102 of FIG. 1B and all other drawing views herein is rendered in a browser at the user terminals 30 based on dynamically generated HTML documents. In other embodiments, the screen displays may be on mobile devices and generated using a mobile device application alone or in combination with network communication with the messaging care logic 8. In an embodiment, FIG. 1B comprises a New Patient button which when selected causes the application logic to generate a screen display configured for accepting information about a new patient to be tracked. In an embodiment, FIG. 1B comprises a New Patient Loop button which when selected causes the application logic to generate a screen display configured for accepting information about a new Loop for a particular patient.

In an embodiment, FIG. 1B comprises a table 102 of tracked patients in which each row 106 is associated with a patient and a particular Loop for that patient. In the example of FIG. 1B, each row comprises a status column, patient name column 108, Loop column 110, progress indicator 112, engagement indicator 114, and Tracker display column 116; in other embodiments, different displays may use different columns, indications, displays and other values. In an embodiment, the status column comprises one or more graphical icons or symbols that indicate issues associated with a particular patient. For example, a flag symbol may indicate that posts or graphs associated with the Loop have been marked as urgent. A comment icon may indicate that the patient has posted a comment or response to a prompt, message or other issues that the healthcare provider should review.

In an embodiment, the patient name column displays a patient name and optionally additional patient data such as date of birth. In an embodiment, selecting a patient name causes the application logic to display a popup window that displays detailed information about the patient, for example, telephone, gender, caregiver name, caregiver phone, or others.

In an embodiment, the Loop column displays a name of a Loop. In an embodiment, the progress indicator comprises a graphical bar that illustrates an amount of time that has elapsed from an overall time period associated with a Loop. In an embodiment, the progress indicator 118 may be displayed in a first color when the current date or time is earlier than the anticipated end date of the associated Loop, and the progress indicator is displayed in a second color if the Loop is past its anticipated end date. In the example of FIG. 1B, the first color is blue and the second color is red, but other embodiments may use other colors or different progress categories.

In an embodiment, the engagement indicator 120 indicates, using any of a number, percentage (as in FIG. 1B), icon, symbol, or other graphical item, a relative level of patient participation in the Loop or in one or more Trackers that are associated with the Loop. For example, a patient who has responded to only a few of several notifications generated in the system might have a low value shown in the engagement indicator. In contrast, a patient who has diligently reported medications, signs, symptoms, and otherwise replied to notifications or messages may have a high value shown in the engagement indicator. In an embodiment, item 122 is an icon or graphical representation of engagement; in the specific embodiment of FIG. 1B, a pie chart represents a level of engagement.

In an embodiment, the Tracker display comprises one or more graphical representations 124, 126, termed Trackers, of historic performance of the patient with respect to a tracked metric. Trackers may represent any of several metrics such as pain level, mood (124), appetite (126), blood pressure, weight, shortness of breath, biomarkers, or other indicators, signs, or symptoms associated with an upcoming visit or procedure, or associated with recovery or effectiveness in follow-up or pre-visit care. A Tracker may comprise a line graph, bar graph, or other illustration. The particular graphical format of the Tracker is not critical. What is important is that a view is provided of changes over time for a particular metric of interest in following recovery with respect to the associated Loop. In an embodiment, a default set of Trackers represent the template for a given Loop which may be customized by the user. In an embodiment, for the purpose of providing a compact and clear display, two or more Trackers are selected and displayed and selection may be based on weight of the Trackers or other parameters. For example, the two Trackers 124, 126 having the highest weights are displayed. Other embodiments may display different numbers of Trackers, and thus the particular arrangement of FIG. 1B merely illustrates one example. Further, in an embodiment, selecting a patient Loop within the view of FIG. 1B causes the application logic to generate and provide a display that includes all Trackers that are associated with a particular condition regardless of the number of Trackers. Trackers may be weighted based on a variety of criteria such as the medical importance of the metric that is tracked or the relevance of the metric to a particular Loop protocol.

In an embodiment, each Tracker may be displayed in association with one or more other graphs that represent expected progress according to an ARC OF RECOVERY profile. Alternatively, a graph representing expected progress according to an ARC OF RECOVERY profile may be superimposed on a Tracker. Multiple graph elements may be superimposed or otherwise shown; for example, on a particular Tracker, one ARC OF RECOVERY profile line may represent the average historic progress of individuals in a 75^{th} percentile of a particular population and another line may represent a 25^{th} percentile. Any appropriate percentiles or other bases of comparison may be used to enable the physician to correlate a particular Tracker with a related ARC OF RECOVERY profile.

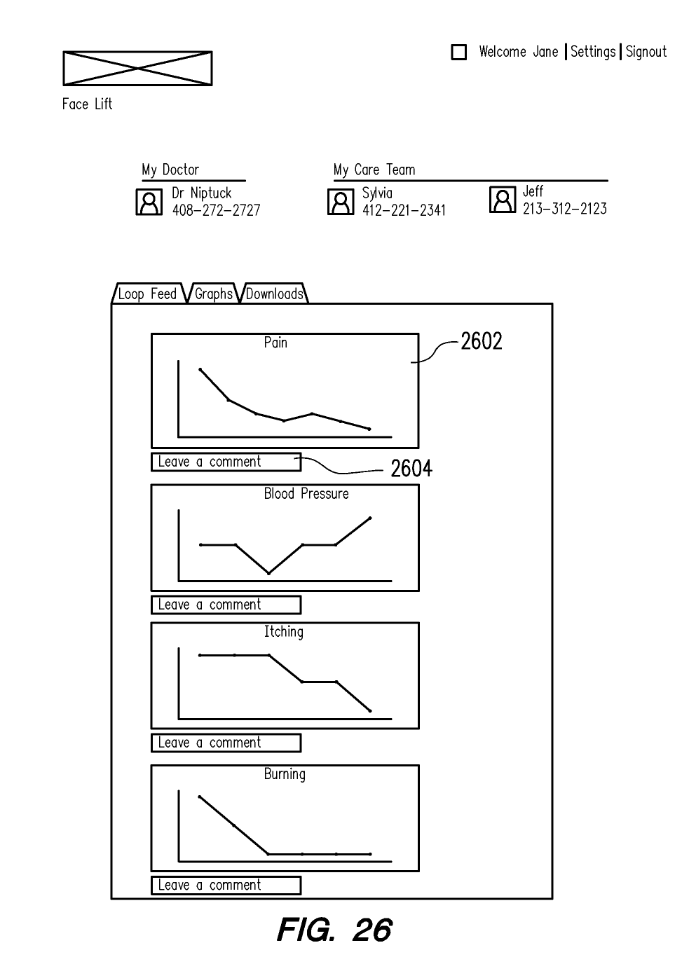

For purposes of illustrating a clear example, FIG. 29 depicts one rendition of normal and abnormal ARC OF RECOVERY profiles.

In this embodiment, the panels 2901, 2902 on the left show, using a green line 2910 with circles in panel 2902, for an example patient, a normal recovery for a composite of recovery Tracker, and for a Tracker depicting edema. The black dotted line 2906 is an example of a population median. The red dotted lines 2904, 2908 are examples of 95th percentiles for the population. The panels on the right show abnormal ARC OF RECOVERY profiles, using a blue line with triangles 2912, for an example patient. The application logic may be configured to compare actual patient recovery metrics to one or more ARC OF RECOVERY profiles of the foregoing general type and to automatically generate and send, by email or other message transport, one or more alerts or other messages to warn health care providers about impending treatment failures or worsening of conditions. The alerts also may report a positive correlation of the patient's actual recovery metrics to an ARC OF RECOVERY profile.

In an embodiment, each row 106 of the table 102 representing a patient and Loop may be displayed in a distinctive color associated with a patient's status, level of urgency, or degree of engagement. The color may be weighted based upon an importance or seriousness of the Loop, and/or the content of a notification or post from the patient, and/or the level of engagement of the patient, and/or the trend represented in one or more of the Trackers for that patient, and/or the trend predicted by the analytics engine. For example, in various embodiments, colors such as red, yellow, and green may indicate descending levels of urgency or importance with respect to any component of the Loop, the content of a notification or post from the patient, level of engagement, or trends or predicted trends of Trackers.

In an embodiment, the application logic may determine colors of icons representing a patient, or a Tracker, in response to evaluation of one or more alert rules of the type described elsewhere herein

In an embodiment, the display of FIG. 1B may include a name, trademark, logo, or other graphical symbol of a service provider that owns or operates the server computers or the application logic. In an embodiment, the display of FIG. 1B may display patient Loops for a default individual healthcare provider associated with a particular user. In the example of FIG. 1B, the provider associated with a particular user terminal 30 is Meg Holland and different individual providers may be selected using a “Show Loops for:” pull-down menu or other GUI widget displayed adjacent to the name of the individual provider. In an embodiment, if the currently logged in user is an individual healthcare provider such as a doctor, then the display of FIG. 1B automatically shows only Loops for patients of that doctor.

In an embodiment, an administrator or other user with appropriate privileges within a clinical setting may see Loops for all patients within that clinical setting. In various embodiments, the application logic may provide one or more of the following functions in addition or as alternatives to the previously described embodiments:

1. A provider may have a library of his/her own Trackers.

2. A provider may see all Trackers belonging to other providers within the practice.

3. A provider may use any Tracker belonging to another provider within the practice.

4. A provider may import a Tracker belonging to another provider within the practice into his/her own Tracker library.

5. A provider may see some subset of HealthLoop Trackers based on their subscription.

6. A provider may use any Tracker within the subset of HealthLoop Trackers that they can see.

7. A provider may import a Tracker from the subset of visible HealthLoop Trackers into his/her own Tracker library.

8. A provider may mark any Tracker which they can see as a favorite.

In an embodiment, each column 108, 110, 112, 114, 116 comprises a selectable column label which when selected causes the table to be sorted and redisplayed using the selected column as a sort key. In an embodiment, selecting on the Trackers column 116 causes sorting and redisplaying the table according to a default sort order by color.

In an embodiment, selecting either the Loop name associated with a particular patient, or a particular progress bar in column 112, causes the application logic to generate and provide a Loop Feed page as further described herein.

FIG. 1C illustrates another embodiment of a healthcare pre-visit and follow-up system. In an embodiment, healthcare messaging logic 8 comprises a patient specifying unit 120 configured to receive data specifying patients, caregivers, providers, and related information to establish basic demographic information for users as well as the accounts in the database 110. Output is provided to a loop specifying unit 122 that is configured to receive patient information and details for Loops relating to communications and metrics for a particular patient. Loop specifying unit 122 may receive input from templating unit 136 based on templates in the database 110 that define characteristics of pre-determined Loops. The templates may be configurable and customizable to enable receiving user data that adapts existing templates or creates new templates. Loop specifying unit 122 also may receive input from component specifying unit 124, which is operable to receive input defining particular components of Loops such as Trackers, Reminders, Confirmations, Medications, Care Instructions and the like. The components may be configurable and customizable using functions of unit 124 to enable receiving user data that adapts existing templates or creates new templates. In an embodiment, a diagnosis/procedure specifying unit is configured to enable a user to specify diagnostic code(s) including co-morbidity codes such as ICD9/10, as well as CPT codes for procedures

Once patients and Loops are defined, a plurality of responses from patients, caregivers and providers may be received at response processing unit 128 which dispatches the responses to component processing unit 126 to use the responses to update particular relevant components. For example, a response may represent input to a Tracker and may be used to update database 110 with Tracker response values; a response may also comprise a post or reply to a post and may be routed to update the Loops stored in the database to maintain a near real time feed of posts, replies, Care Instructions, Reminders, and other messages.

Graphing unit 138 is coupled to component processing unit 126 and is operable to determine graphical data for use in graphically representing trends for Trackers based on response that are received over time. Output graph data may be provided to display forming unit 134 which is operable to form dynamically generated HTML pages, or other computer display output, to provide to web server 6 for communication to user terminals 30 (FIG. 1A).

Component processing unit 126 may also signal a message generating unit 130 to generate and send one or more automated alerts, replies, posts or other messages using e-mail via mail server 4 or using dynamically generated web pages via web server 6. Responses from response processing unit 128 may be fed to engagement processing unit 132 which is configured to compute a level of engagement of a particular patient or other user with the system and to provide display forming unit 134 with a percentage, scalar value, or other data representative of whether the patient or other user has interacted with Trackers, replied to Reminders or Confirmations or taken other action to interact with the system.

Loop feed forming unit 140 is coupled to Loops in database 110 and display forming unit 134 and is configured to form a hierarchical list of posts or other messages, related replies, Reminders, Confirmations, Care Instructions and other components of Loops for communication to a particular patient or end user via dynamic HTML pages and web server 6.

Thus a computer organized and implemented as shown in FIG. 1C is capable of operations not known in prior practice including providing a consolidated, efficient, and comprehensive view of data, trends, and commentary on a patient's care at preparatory or follow-up stages of care, including any of pre-operative, pre-visit, post-operative, post-visit, or other stages of care. Unlike prior systems, input data may relate to objective or subjective signs, symptoms or conditions relating to healthcare, including such objective data as vital signs and also structured, quantitative values for highly subjective conditions such as feelings of malaise, fatigue, pain, wellness and the like. The computer of FIG. 1C enables the patient or caregivers to rapidly understand recent or long-term trends with respect to the patient's care across a variety of metrics and enables posting and reviewing comments, questions, replies and related care information in close association with graphical representations of key care metrics, and to obtain a computer-moderated view of the patient's level of engagement with messages, instructions, reminders and other aspects of the computer, thereby providing a more efficiently operated computer display unit and providing an integrated view of data that has not been possibly previously.

FIG. 1D illustrates an example healthcare pre-visit and follow-up process. At block 160, definitions of patients, caregivers, and managers are received, and records storing data for such users may be stored in the database 10. As a result, the database 10 acquires a representation of patients as well as particular caregivers involved in the patient's care and managers such as healthcare providers.

At block 162, definitions of Loops and components such as Trackers, Confirmations, Procedures, Procedure codes, Diagnostic codes, Reminders, Medications, and Care Instructions are received and stored. One or more of the components may be configured for tracking one or more healthcare metrics relating to objective conditions, or subjective conditions of the type previously described, and associated with follow-up or pre-visit periods of care. Each Loop is associated with a particular patient and the association facilitates sending automatic messages to the patient and/or automated alerts to caregivers or managers of the patient.

At block 164, structured data items representing objective conditions and subjective conditions, including signs or symptoms, are received for a particular patient. As seen in block 174, the structured data items may include answers of the patient to questions about the patient's then-current condition, through prompts issued automatically from Trackers or other components of a Loop in which the patient is involved.

At block 166, the structured data items are stored and an exchange is facilitated of the data items between the patient and the caregivers or managers of the patient. Facilitating exchange of the structured data items may include, for example, generating and displaying a hierarchy of messages from any of the providers, managers, patient and caregivers, and associated replies. The exchange also may reproduce certain components such as Confirmations, Reminders, Care Instructions, or others.

At block 168, the structured data items are displayed in comparison to comparative healthcare information based upon protocols that define communications and tracking changes in specified healthcare conditions or procedures. As examples, block 168 may involve determining one or more graphs of comparisons between trends reflected in actual responses for tracked metrics and expected paths of recovery from or preparation for a healthcare encounter such as a procedure or visit, as seen in block 178; or performing alert thresholding computations that may result in generating automated alert messages or status changes as further described below, as seen in block 180; or performing computations of the level of patient engagement with the system, as seen in block 182.

At block 170, one or more automated alerts about impending failures or worsening of conditions are generated and sent. For example, alerts may inform a provider that a trend for a particular tracked metric, based on patient responses received and evaluated in near real time, has worsened. Non-alert messages also may be sent at block 170 based on components such as Reminders, Confirmations, Care Instructions, or others. Block 170 also encompasses generating and causing displaying one or more status change indications such as changing the appearance of icons or other elements, for example on the display of FIG. 1B, to different colors, without sending alert messages. For example, status changes may be indicated by changing colors from green to yellow to gray or other colors and other functions may cause changing status indicators, without generating an alert, to other colors.

FIG. 1D represents one example process that may be implemented in an embodiment. Other processes will become apparent from the detailed description herein and the graphical user interface diagrams which visually illustrate input to and output from the other processes.

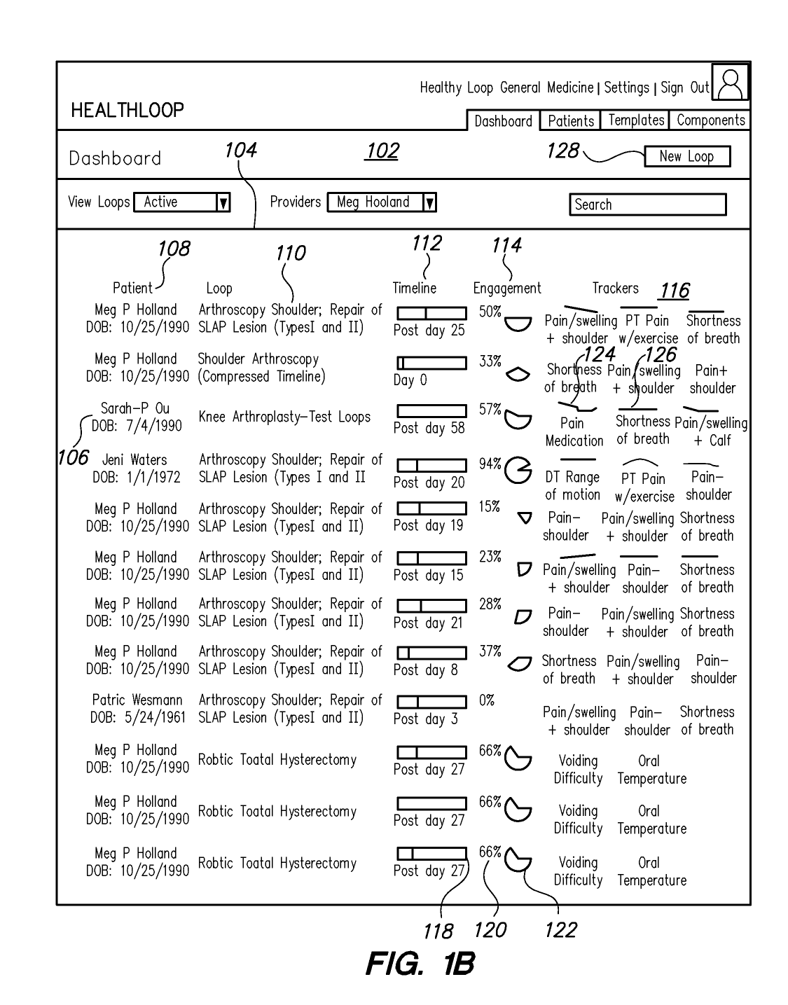

FIG. 2 illustrates an example screen display for a computer graphical user interface for a provider showing entering a new Loop. In an embodiment, the display 202 of FIG. 2 comprises user/manager identifying widgets 204 comprising a doctor selection widget, a patient name search box, and areas 208, 210, 212 for entering or displaying data defining a Loop name, start date, end date, diagnoses and procedures, existing components in the Loop, and defining new components for a Loop. In an embodiment, each Loop may comprise one or more components selected from among Trackers 218, Reminders, Confirmations, Medications, Patient Materials, Care Instructions, and Action Items, as further described.

A user can add a patient to a Loop by searching for an existing patient in the patient name search box of widgets 204. In an embodiment, if the patient is not in the database, the user may enroll a new patient using a pop-up data entry window comprising fields for first name, last name, email address, and phone. In an embodiment, a user can add zero or more caregivers associated with a particular patient. In an embodiment, a pop-up data entry window enables entering the same fields as for a patient, and also a relationship to the patient.

The designation of a user as a patient or caregiver may affect the behavior of the application logic in processing messaging or displays. For example, the format or content of alerts, questions or other messages may vary based on whether they are directed to a patient or caregiver. Additionally or alternatively, in one embodiment a post by a caregiver in response to a provider question, reminder or other Component of a Tracker may be displayed in the provider's Loop Feed and the caregiver's Loop Feed, but not in the patient's Loop Feed.

A button 206 titled Choose a Loop Template optionally enables retrieving a Loop according to a template. In an embodiment, selecting the button 206 causes the application logic to display a search screen. In an embodiment, selecting an existing template causes the application logic to pre-populate values in all fields for a Loop that are shown in FIG. 2. If no template is selected, then the fields shown for Loop Name and below in FIG. 2 are blank and may be completed by the user.

In an embodiment, entering a start date at area 210 is required, and entering an expected end date at area 212 for the Loop is optional. In an embodiment, values for Diagnosis, comorbidities, and procedures are provided in panel 214 and are coupled to auto-completion logic that looks up matching terms as the user types, in order to maintain the use of normalized data values in the fields. In an embodiment, arbitrary values are not allowed and known or existing values are used. Zero or more comorbidities may be entered and zero or more procedures may be added. In an embodiment, the display of FIG. 2 provides a visible cue, such as highlighting or colors, that the primary diagnosis is required whereas the comorbidities and procedures are not. Selecting an +Add Comorbidity or +Add Procedure link causes the application logic to display data entry fields for additional values and accepts additional values into the database record for the Loop. Selecting a [X] icon adjacent to one of the fields signals the application logic to remove the corresponding value from the Loop.

The Components in Loop region 216 of the display of FIG. 2 lists the current Trackers, Medications, Reminders, Confirmations, and Patient Material that are associated with the current Loop. A Loop typically, but not necessarily, has at least one such component. A Loop need not have all such components and there are no limitations or requirements for the number or combinations of components that can be used in a Loop. In other embodiments, other components may be implemented other than the types shown in FIG. 2. For example, in an embodiment, an Action Item component may be added and causes the application logic to send a reminder to the patient with an input field until an acceptable specified response is received, at which point the reminders stop. For example, an Action Item may be a question such as “Have you scheduled your lab test yet?” and the specified acceptable answer may be YES. In general, the data definition of Components, as seen in the attached schema for database 10 for example, may be made extensible so that other kinds of Components may be added to a Loop other than the particular Components that are described herein.

The Add Components to Loop region 217 of the display comprises tab displays or a list of links for Trackers 218, Reminders, Medications, Confirmations, and Patient Materials. Selecting a graphical tab or a link causes the application logic to display data in the area below the tabs that is associated with a particular selected tab or in a pop-up window or other convenient display. In FIG. 2, the Trackers tab 218 or link is selected, and the data within the tab or pop-up window displays values for existing Trackers that were previously entered and provides GUI widgets and data entry fields for adding a new Tracker. In an embodiment, each Tracker is defined by a name, start date, end date, importance or weight value, and frequency, as summarized in a row 220. In an embodiment, adding a new Tracker comprises receiving user input for selecting a Tracker name using an automatically completed data entry field, entering a start date, entering an optional end date on which tracking should end, specifying an importance value, and optionally entering special directions as indicated by GUI widgets 222. The importance value, which may be displayed in the form of text, or a bar 223 of stars or other qualitative rating criteria, may be stored in the database in the form of a weighting value that is used in machine learning algorithms to determine whether to generate an alert message according to a trend or slope of a graph line associated with a Tracker. Notes may be entered in text box 226.

Trackers also are associated with multiple-choice or numeric questions for which the patient will be requested to provide responses, according to the specified frequency, starting on the start date and ending on a particular end date or after a specified duration in time. Requests may comprise e-mail messages, text messages, or any other form of electronic communication that can be configured between the system and a patient or other user. In an embodiment, selecting an Add to Loop button 224 causes the application logic to add a new Tracker to the current Loop using the values that have been entered in the Tracker tab.

In an embodiment, each Loop may have any number of Loop participants, with different roles. For example a particular Loop may be associated with a Primary Provider, Patient, Caregiver, and Backup Provider. In another embodiment, there may be one patient and one manager, such as a provider, associated with a Loop.

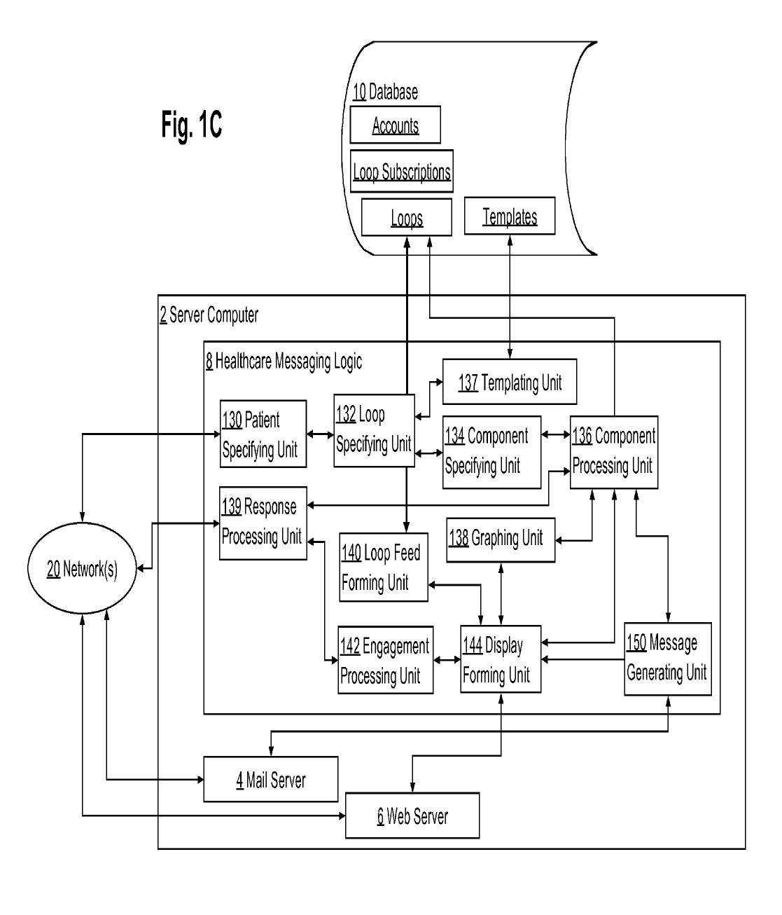

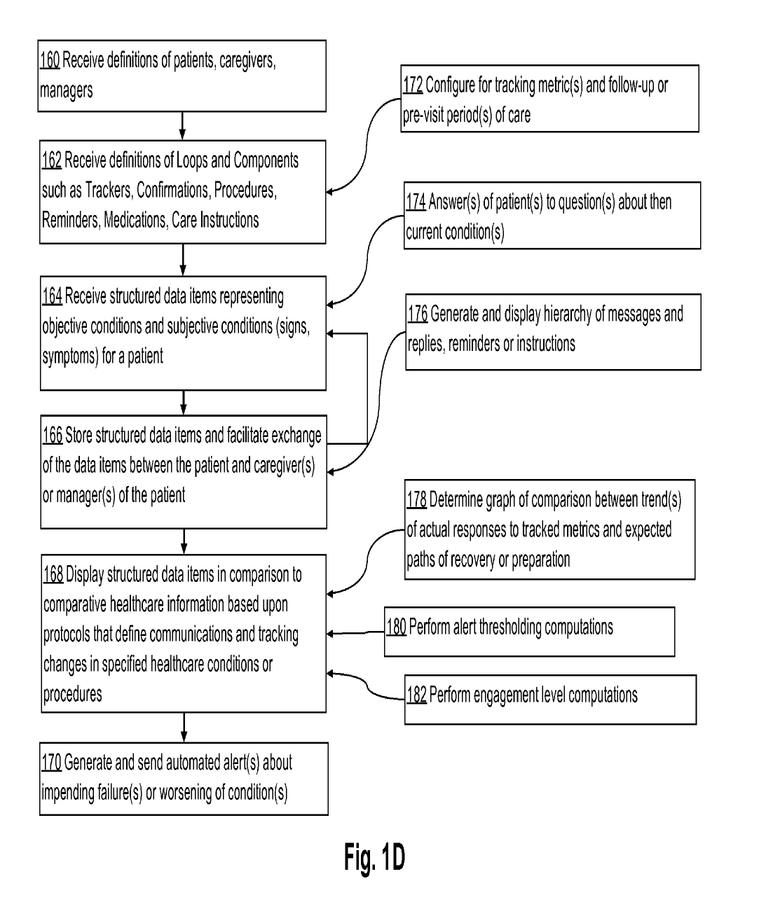

FIG. 3 illustrates an example screen display for a computer graphical user interface for a provider showing selecting an existing patient. In general, FIG. 3 has the elements of FIG. 2 and represents a modified appearance of FIG. 2 in response to a user typing a part of a patient name in the Patient text entry field of screen display 202. FIG. 3 also illustrates an alternate embodiment in which all components of a loop are illustrated in a table 219, as indicated by All Components tab 302. In an embodiment, entering characters causes the application logic to search for matching names in the database and display matches in a display box 204A adjacent to the patient name field. The user may select an existing name or select a New link 304 at the end of the list. In response to selecting the New link 304, the application logic causes displaying a new patient dialog as further described for FIG. 4. In an embodiment, the same process is provided for selecting or adding a caregiver. FIG. 3 also shows the components area of the patient Loop with All Components displayed rather than a particular tab (such as Trackers) selected; in this embodiment, screen display 202 may include a wizard-style dialog in which successive and previous stages of data entry are accessible using hyperlinks such as Next: Add Trackers link 306.

FIG. 4 illustrates an example screen display for a computer graphical user interface for a provider showing entering a new patient. In general, FIG. 4 has the elements of FIG. 3, but further displays a pop-up data entry window 402 entitled New Patient, which is configured for the application logic to receive data entry values 404 including First Name, Last Name, Email address, Phone, Date of Birth, and Gender. In other embodiments, a patient may be associated with fewer or more values 404 than those shown in FIG. 4. Selecting an Add Patient button 406 in the pop-up data entry window 402 causes the application logic to add the specified patient to the database.

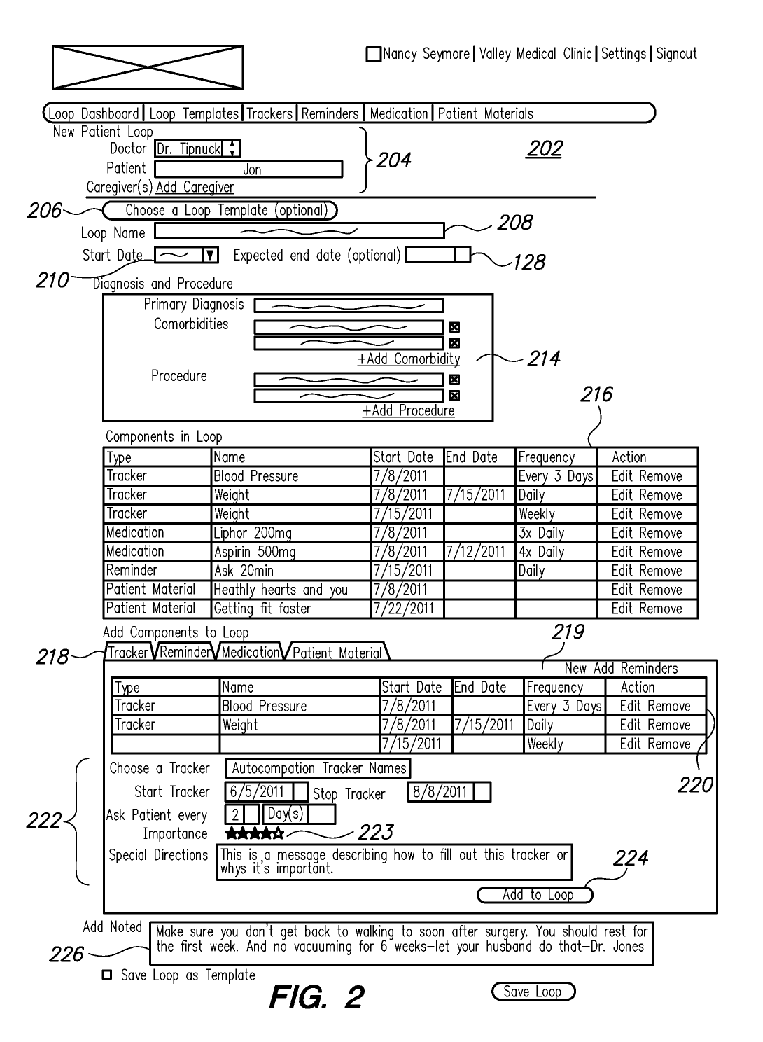

FIG. 5 illustrates an example screen display for a computer graphical user interface for a provider showing entering a new caregiver. The application logic may generate the display of FIG. 5 in response to receiving input selecting an Add Caregiver link or a similar button. In an embodiment, selecting the link causes the application logic to display a pop-up window 502 configured to receive values for fields 504 that define a caregiver. In an embodiment, the values comprise First Name, Last Name, Email, Phone, Date of Birth, Gender, and Relationship to the patient. In other embodiments, more or fewer values may define a caregiver. Selecting an Add Caregiver button 506 causes the application logic to add a record for a new caregiver to the database.

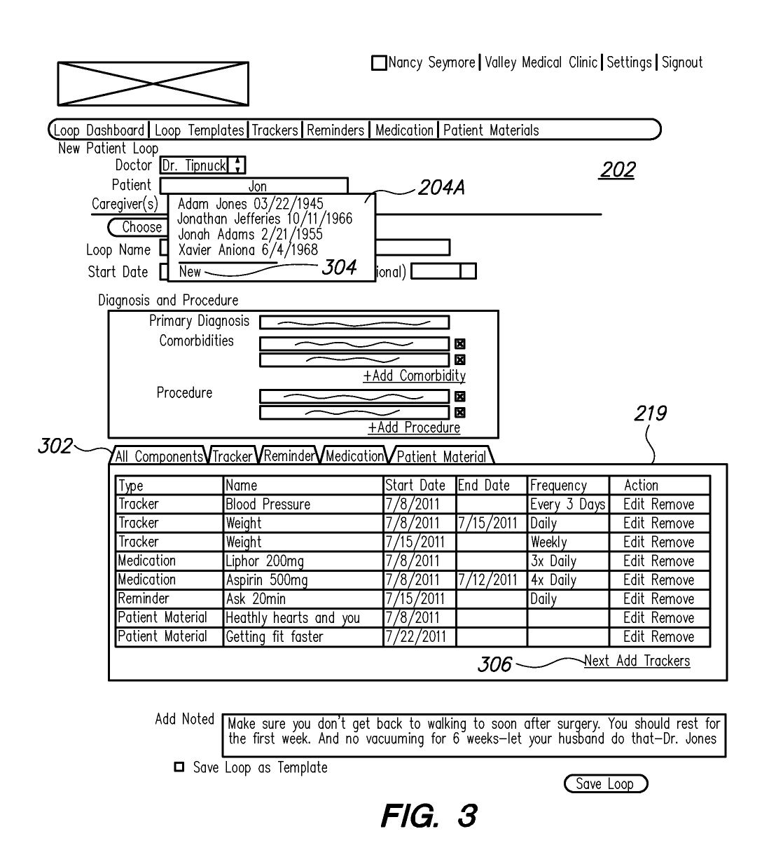

FIG. 6 illustrates an example screen display for a computer graphical user interface for a provider showing selecting a Template for a Loop. In an embodiment, the application logic generates the screen display 601 of FIG. 6 in response to receiving input selecting the Choose a Loop Template button 206 as described above for FIG. 2. In an embodiment, selecting the Choose a Loop Template button 206 causes the application logic to display a pop-up data entry window 602 configured to receive a text entry in box 604 representing a name, or keyword within a name, for an existing Loop template. For example, a user typing characters or a word in the text entry box 604 of the pop-up window 602 causes the application logic to search the database and display a list of existing Loop templates that contain the characters or word, and a user may select one of the specified Loop templates by clicking on its name 608 and selecting a Select Template button 610.

In response, the application logic automatically completes values for a new Loop using values that are stored in association with the template. The particular values that are populated may vary based upon the nature of the template. In an embodiment, a Loop Template comprises a stored association of a set of Trackers, Care Instructions, Confirmations, and Reminders to be sent to the patient for either a recovery period or a pre-operative, pre-procedure, or pre-encounter period. For example, if the template is for Congestive Heart Failure, then the template might include multiple periodic Reminders instructing the patient to check weight or report on specified possible future symptoms. After the automatic population of Components, a provider can modify the Components to delete one or more, add one or more, or modify the terms of a Component.

In an embodiment, each template and/or each Loop protocol may be associated with one or more condition codes and procedure codes according to one or more existing healthcare fee and cost coding systems or standards such as CPT codes, ICD-9, ICD-10, DRG codes, etc. Primary diagnosis codes and secondary diagnosis codes may be used, and zero or more comorbidities may be associated. Past approaches typically have provided no way to associate particular follow-up or pre-visit care with particular codes. Further, a particular template may be associated with a plurality of codes or a code bundle and templates may populate the system with different values depending on the code associations. For example, a diagnosis of diabetes with Chronic Obstructive Pulmonary Disease (COPD) as comorbidity may warrant a template with different Reminders or other Components than a template for diabetes with no comorbidities. Code associations also facilitate integration of Loops, templates, or ARC OF RECOVERY profiles with medical records systems or paper or electronic charting systems.

In an embodiment, the application logic may define and display specified follow-up or pre-visit care codes that are compatible with existing cost coding systems or standards but not previously defined in those systems. Thus, embodiments may implement new ways of coding particular templates, Loops, or ARC OF RECOVERY profiles for the purpose of cost recovery by healthcare providers who provide the associated follow-up or pre-visit care. Codes may reflect the nature of a Loop, Trackers as a whole, and/or duration of Trackers.

Optionally, in an embodiment, a Loop template may be stored in the database in association with citations to supporting evidence, literature, clinical practice guidelines, or PubMed ID values. Typically the content of Loop templates will be developed by teaching or practicing physicians alone or in collaboration with other healthcare or medical experts. Data for Loop templates may be captured in worksheets or database tables that capture the foregoing data and also provide a general plan for Trackers, Reminder, Confirmations, and Care Instructions.

In an embodiment, the list of existing templates is sorted in order of most recently used or favorite templates. In various other embodiments, other sort order may be used; for example, lower priority may be given to listing templates from elsewhere in the current clinic's practice, than templates based on standards in use outside of the given clinic, etc.

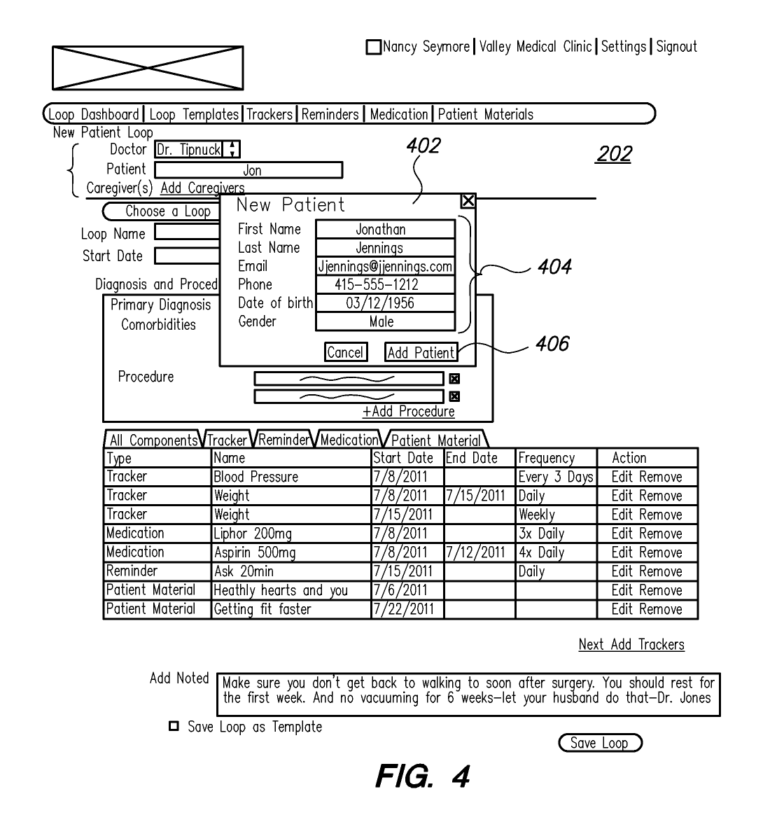

FIG. 7 illustrates an example screen display for a computer graphical user interface for a provider showing elements of a Trackers tab or link. The elements and their functions generally have been previously described above in connection with FIG. 7. In an embodiment, the Choose a Tracker data entry field 702 comprises a New list item which, when selected, causes the application logic to display a pop-up data entry window configured to receive values that define a new Tracker. In an embodiment, user input comprising hovering a cursor over an existing Tracker name causes the application logic to display some or all values for a Tracker in a pop-up window or other screen display. In an embodiment, a user starting the process of adding a new Tracker causes the application logic to display a new row 704 in the table of Trackers 706 in the Trackers tab 708, with known values completed and others filled in after the new Tracker is fully defined. Thereafter, on or after the Start Date when a particular day matches the Start Date plus the number of days indicated in the Frequency field, the application logic is configured to send a query based on the Tracker message by e-mail to the patient associated with the Loop, which prompts the user to enter a response to one or more multiple choice questions or numeric value questions that are defined for the Tracker.

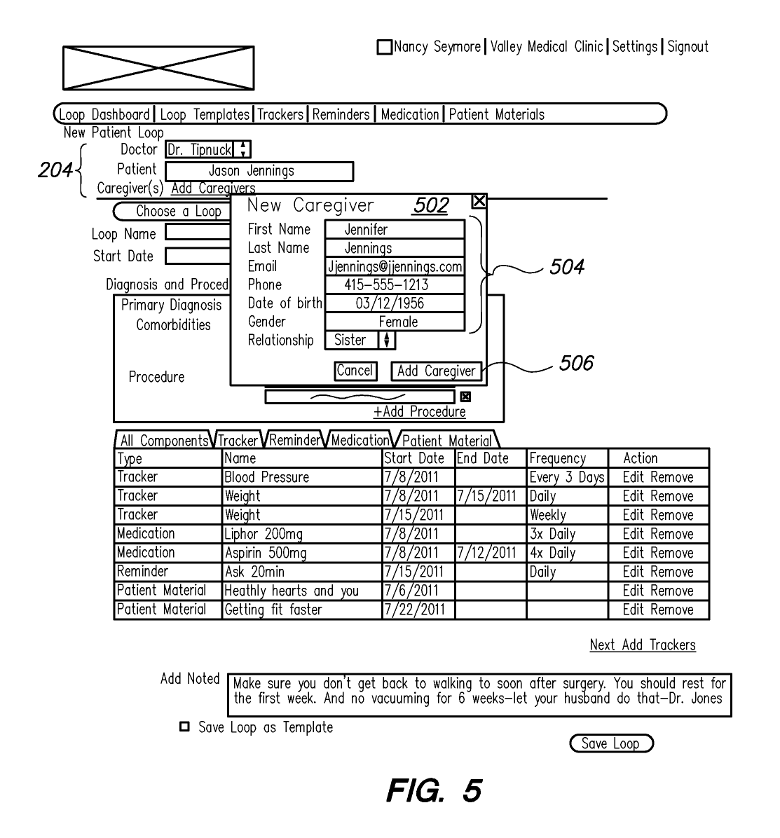

FIG. 8 illustrates an example screen display for a computer graphical user interface for a provider showing elements of a Reminders tab or link 802. In an embodiment, a Reminder is defined by a name 804, a Date to Send value 806, a frequency value 808, and an End Date value 810. In an embodiment, a Choose a Reminder text entry box 812 is configured to receive characters or a word associated with a Reminder name. In response to entry of characters or a word, the application logic searches the database and displays a list of matching existing Reminder names, and a list entry of New. Selecting the New entry in the list causes the application logic to add a new row 814 to the table 816 of Reminders in the Reminders tab 802 and to concurrently display a pop-up data entry window where the user may enter values for a new Reminder. Selecting an Add to Loop button 818 causes the application logic to add a record for the new Reminder to the database. Thereafter, on or after the Date to Send, when a particular day matches the Date to Send plus the number of days indicated in the Frequency field, the application logic is configured to send a reminder message by e-mail to the patient associated with the Loop. In substance, a Reminder may comprise any message of a reminder nature that a provider wishes to convey to a patient. Examples may include checking weight, changing a wound dressing, take a supplement, recommendations to contact the provider if certain symptoms are noticed, etc.

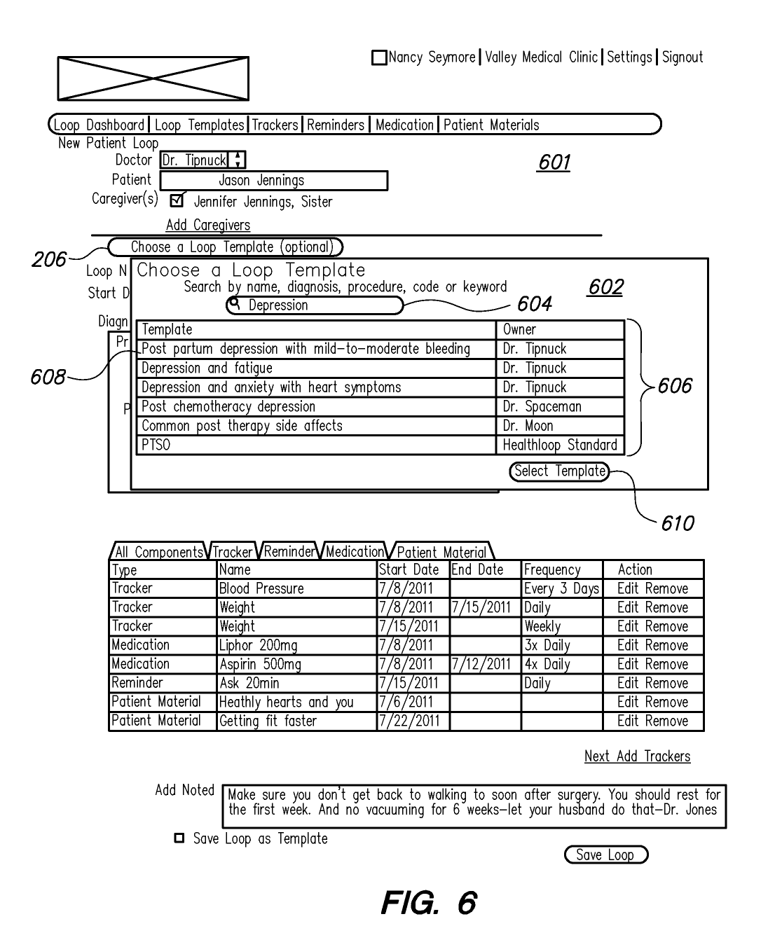

In an embodiment, the system may also incorporate a Confirmations tab that displays information similar to the Reminders tab 802 of FIG. 8, but relates to communications that have been conducted to confirm that a patient or user plans or is expected to carry out a certain action for a particular healthcare encounter. For example, the Confirmations tab may summarize messages that have been communicated between a provider and user (such as a patient or patient's representative) to confirm that a particular action has been or will be taken. FIG. 9 illustrates an example screen display for a computer graphical user interface for a provider showing elements of a Medications tab 902. In an embodiment, as with Trackers and Reminders, the Medications tab 902 is configured in the application logic to cause displaying a table 904 in the tab showing existing Medications reminders or messaging configurations that are associated with the current Loop. In an embodiment, a Medication 906 is defined by a medication name 908, a Start Date 910, End Date 912, Frequency 914, and dosing values 916. For example, dosing values may comprise a number of units, such as tablets, a dosing method such as oral administration, a dosing frequency, and a time limit on dosing. In the example of FIG. 9, a medication is defined as 2 tablets by mouth every 2 days for 20 days. Various other configurations of normalized data entry fields may be configured for medications to comport with appropriate ways of tracking the administration of medications.

In an embodiment, the Medications tab 902 is configured with a Medication Name auto-completion text entry field 918 that may receive characters or words associated with a particular medication. In response to receiving input comprising characters or words for a medication name, the application logic is configured to search the database and display a list of matching medication names, with a New list item. Selecting the New item causes the application logic to add a new row 920 to the medications table in the tab and concurrently to display a pop-up data entry window for receiving values to define a new Medication. The application logic may be configured, based on a Medication that has been fully configured, to send one or more periodic reminder messages by email to the patient associated with the Loop, for example, to remind the patient to take the specified medication or to prompt the patient to respond by indicating whether the medication was taken.

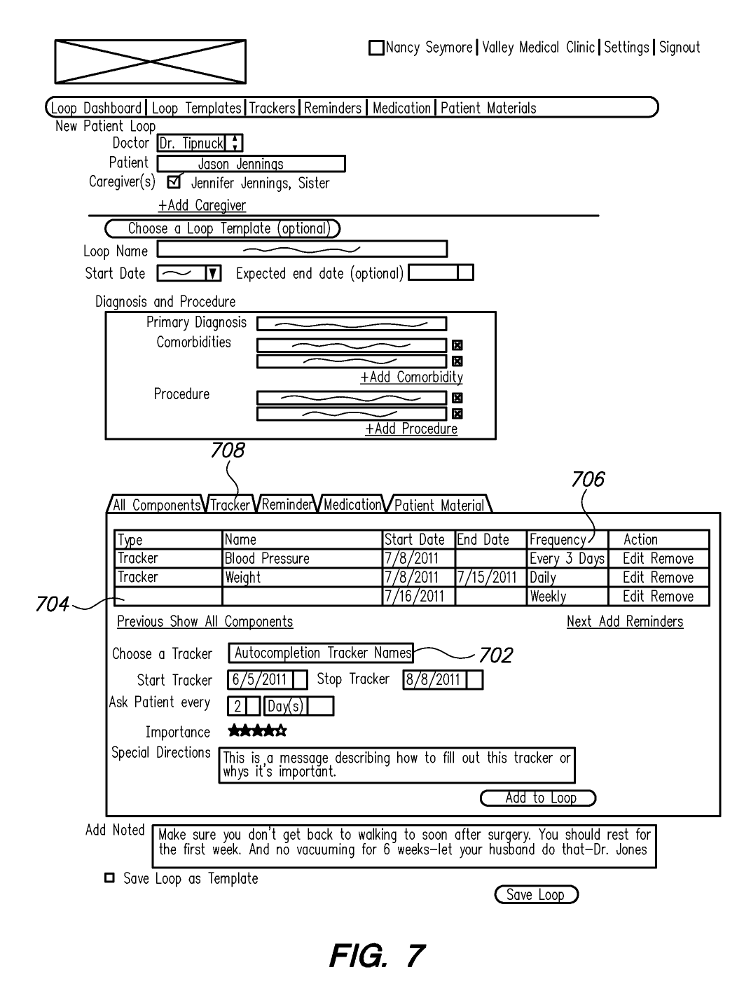

FIG. 10 illustrates an example screen display for a computer graphical user interface for a provider showing a Patient Material tab 1002. In an embodiment, Patient Material is defined by metadata specifying a name 1004, a Date to Send 1006, and a Description for Patient 1008. In various embodiments, Patient Material may comprise electronic documents, audio files, videos, graphics, web pages, or links or other references to any of the foregoing. Thus, Patient Materials may comprise rich multimedia explanations of proper follow-up or pre-visit care or any other relevant topic that may improve care or recovery. The application logic is configured to send the Patient Materials to the associated patient by e-mail on the Date to Send, with the accompanying Description for Patient. In an embodiment, the Patient Material tab 1002 is configured with a Choose a Patient Material text entry field 1010 that is configured with automatic completion. In an embodiment, input representing characters or words associated with Patient Material causes the application logic to display a list of available Patient Material names, with a New list item. Input selecting the New list item causes the application logic to display a pop-up data entry window configured to receive values that define a new item of Patient Material. Selecting the Add to Loop button 1012 then causes the application logic to add the new item of Patient Material to the database. In an embodiment, user input comprising hovering a cursor over an existing row in the Patient Material table in the tab causes the application logic to display a thumbnail image of the associated item of patient material.

The term Patient Material is used in describing FIG. 10 merely as one example for convenience; other embodiments may use other labels or names for similar information or comments, such as Care Instructions.

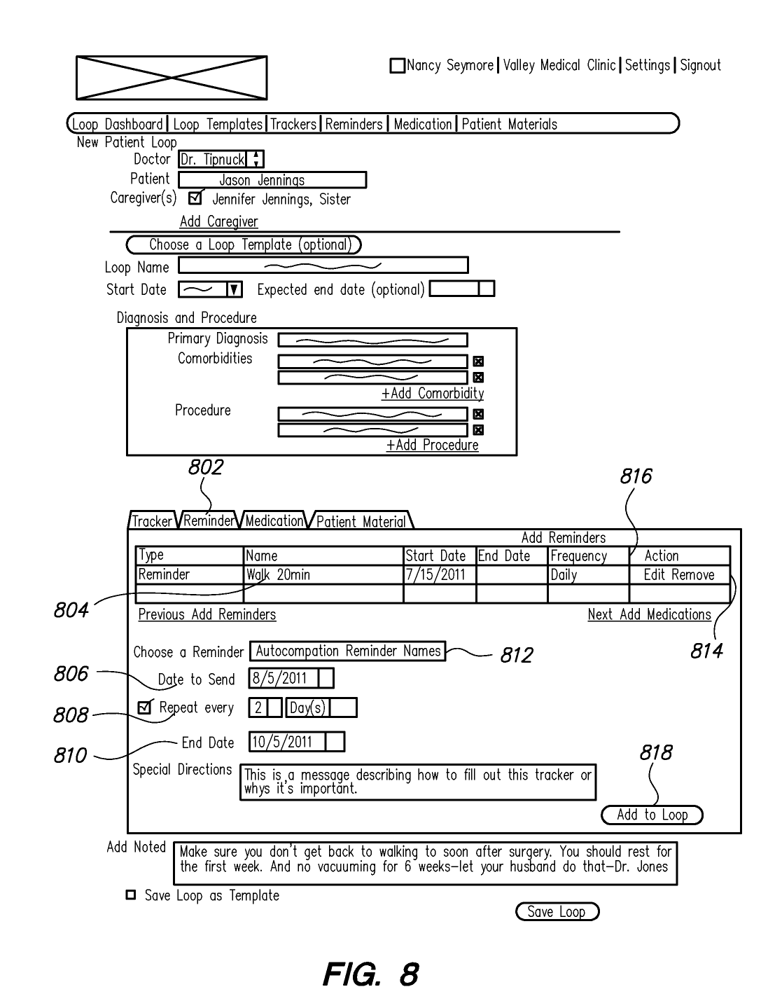

FIG. 11 illustrates an example screen display for a computer graphical user interface for a provider showing a Loop feed. In general, the Loop feed 1102 of FIG. 11 is a display, for a particular user associated with a healthcare provider, of all comments or other responses, such as check-ins, for a particular Loop of a particular patient that is associated with that particular healthcare provider. Unlike prior approaches, the Loop feed 1102 enables an entire healthcare team to receive a consolidated view of objective signs and subjective symptoms or other responses reported by a patient, potentially including digital images or comments contributed by the patient, and the graphical output of Trackers with or without comparisons to ARC OF RECOVERY profiles.

The Loop feed 1102 also provides a way to share the consolidated information between healthcare providers without requiring the patient to make a clinical visit to a particular provider. For example, if the patient has been interacting with a primary care physician (PCP) but needs to see a specialist, the PCP could share the Loop feed 1102 with the specialist after obtaining appropriate patient consent, and the specialist could review the contents of the Loop feed with or without a clinical visit of the patient, using the Loop feed as a basis for recommendations or further care to the PCP or to the patient. Additionally or alternatively, the specialist's comments or action items based on the Loop feed 1102 potentially could be a cost-recoverable event for the specialist. Thus, the Loop feed and other elements of the system herein provide a foundation for cloud-based collaboration among providers.

In the example of FIG. 11, the current healthcare provider is “Meg Holland” as indicated at 1104 and the Loop feed 1102 is for an Arthroscopy of Shoulder Repair of SLAP Lesion (Types I and II) type of Loop as indicated at 1106 for a Patient named Jeni Waters as indicated at 1108. In an embodiment, FIG. 11 comprises, from top to bottom, a toolbar 1110 of function links; a summary region 1114; a set of sub function buttons 1116; and a reverse chronological list 1118 of zero or more comments or check-in posts 1120.

In an embodiment, the toolbar 1110 of function links comprises hyperlinks 1111 which, when selected, cause the application logic to change state to a function associated with the selected hyperlink and then generate and provide an updated screen display or page associated with the selected function. In an embodiment, the functions are Loop Dashboard, Loop Templates, Trackers, Reminders, Confirmations, Medications, and Patient Materials and are associated with the other screen displays that are described herein.

In an embodiment, an alert bar may display a notification describing a date and time at which the application logic recorded receiving a comment from a patient that was marked with an urgency marker. For example, if a patient enters a response to a Tracker and that response is determined by the system to require further attention, then an alert message will appear in the alert bar when the corresponding healthcare provider accesses the Loop feed.

In an embodiment, the summary region 1114 comprises a display of basic information about the current Loop such as the Loop name, patient name and phone number, status of the Loop, Start Date and End Date of the Loop, and optionally one or more graphs 1122 that summarize values for signs or symptoms of the patient over time. In an embodiment, input representing hovering a cursor over a patient name or picture causes the application logic to display a pop-up window that provides all available contact information in the database for that patient. In an embodiment, selecting one of the graphs 1122 causes the application logic to display, in place of the reverse chronological list 1118 at the bottom of the screen, the Tracker details section that has been previously described, in association with an enlarged view of the selected graph. One or more of the graphs 1122 may be highlighted using distinctive title bars, color or other mechanisms; for example, graphs that reflect worsening trends or significant changes of any kind could be highlighted, colored or otherwise presented distinctively.

In an embodiment, the set of sub function buttons 1116 comprises links for selecting Loop Feed, Engagement, and Loop Details functions. Selecting any of the sub function buttons causes the application logic to generate and display an updated screen display corresponding to the selected function and to change state to process the selected function.

In an embodiment, the reverse chronological list 1118 comprises zero or more comments or check-in posts 1120 each comprising a thumbnail image of a provider or patient, comment text, a date and time stamp, and a Reply link which when selected allows the provider to reply to the comment of the patient or provider. In an embodiment, one level of replies is supported, so that replies to replies are not displayed, but in other embodiments multiple levels of replies may be stored and displayed. In an embodiment, date and time values are localized to the time zone of the user who is viewing the Loop feed so that the elapsed time since a comment is apparent. In these embodiments, messaging between a physician and a patient (or patient surrogates such as a family member or caregiver) is built into a Loop Feed and Loop history. Therefore, a user or manager can rapidly review a historical dialog between the manager and the user-providing information that would be unavailable, time-consuming or difficult to obtain from a patient chart, EMR system, etc.

In an embodiment, the reverse chronological list 1118 also comprises a Show All Posts GUI widget comprising a pull-down list of choices including Comments and Check-Ins. Selecting an item in the list causes the application logic to re-display the reverse chronological list to show only Comments, or only Check-Ins.

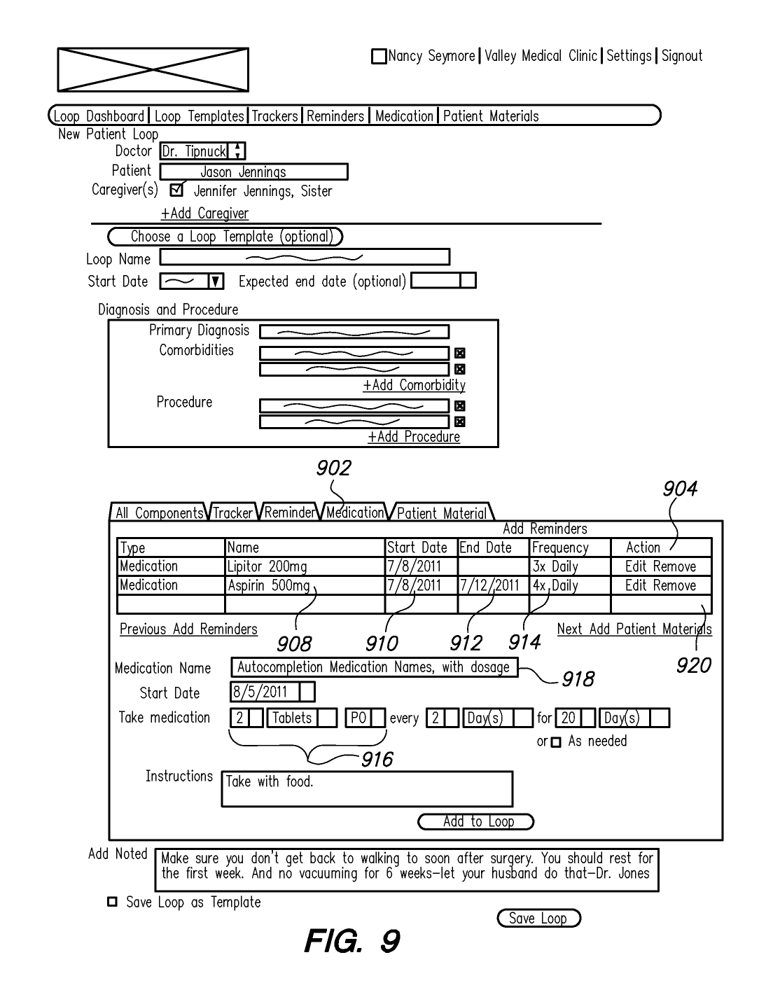

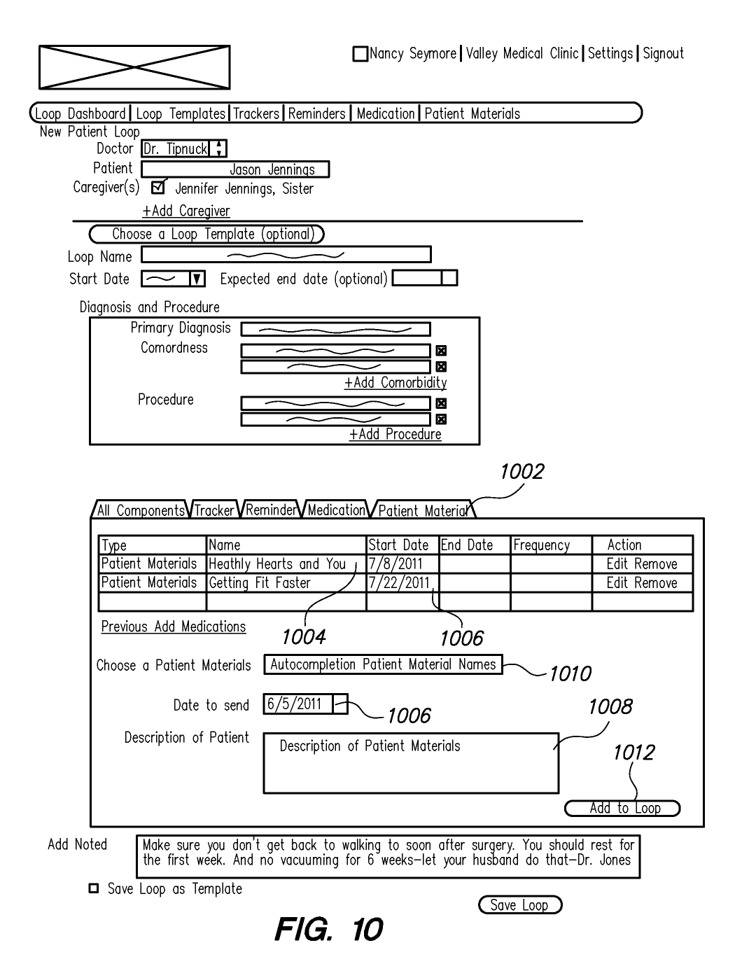

FIG. 12 illustrates an example screen display for a computer graphical user interface for a provider showing a Loop feed with graphs. In an embodiment, the application logic generates and provides the display of FIG. 12 to a user in response to receiving input indicating selecting or clicking anywhere in a relevant patient Loop, for example, within a particular row of the tabular display shown in FIG. 1B. In an embodiment, the display of FIG. 12 has the elements of the upper half of FIG. 11 and provides one or more enlarged graphs 1204 in a lower portion 1202. Each graph is associated with a Leave a Comment button 1206 which when selected causes the application logic to open a text entry box in which the provider may enter comments about the associated graph 1204. Comments about graphs 1204 may be entered into the Loop Feed 1102 (FIG. 11) along with a snapshot of the graph at the time of comment. Comments may be marked with urgency markers by selecting an icon. In an embodiment, the display of FIG. 12 further comprises the set of sub function selection buttons 1116 titled Loop Feed, Graphs, Engagement and Loop Details. In an embodiment, selecting the Loop Feed button causes the application logic to change state and display the Loop Feed 1102 as seen in FIG. 11. In an embodiment, selecting the Engagement button causes the application logic to change state and display the engagement information screen as further described for FIG. 13. In an embodiment, selecting the Loop Details button causes the application logic to change state and display details for the current Loop as previously described for FIG. 6 and related views.

FIG. 13 illustrates an example screen display for a computer graphical user interface for a provider showing a Loop Feed with engagement information. In this context, patient engagement refers to a level of responsiveness of the patient to questions or other requests that are generated in the system. In an embodiment, the display of FIG. 13 has the format of FIG. 10, FIG. 11 and in the lower half 1302 of the display provides detailed information supporting the basis of a particular engagement value, such as a percentage. In an embodiment, the detailed information specifies the date and time of the patient's last response at 1306, the engagement percentage and basis in terms of numbers of notifications that received responses as seen at 1308, and a table 1304 summarizing, for each notification sent to the patient, the date and time at which the notification was sent, the date and time at which the patient responded, and whether the patient provided or requested additional information. In an embodiment, the table comprises selectable column headings which when selected cause reordering the table using the selected column as a sort key. In an embodiment, rows that represent notifications to which the patient did not respond may be highlighted in a distinctive manner such as using a distinctive color.

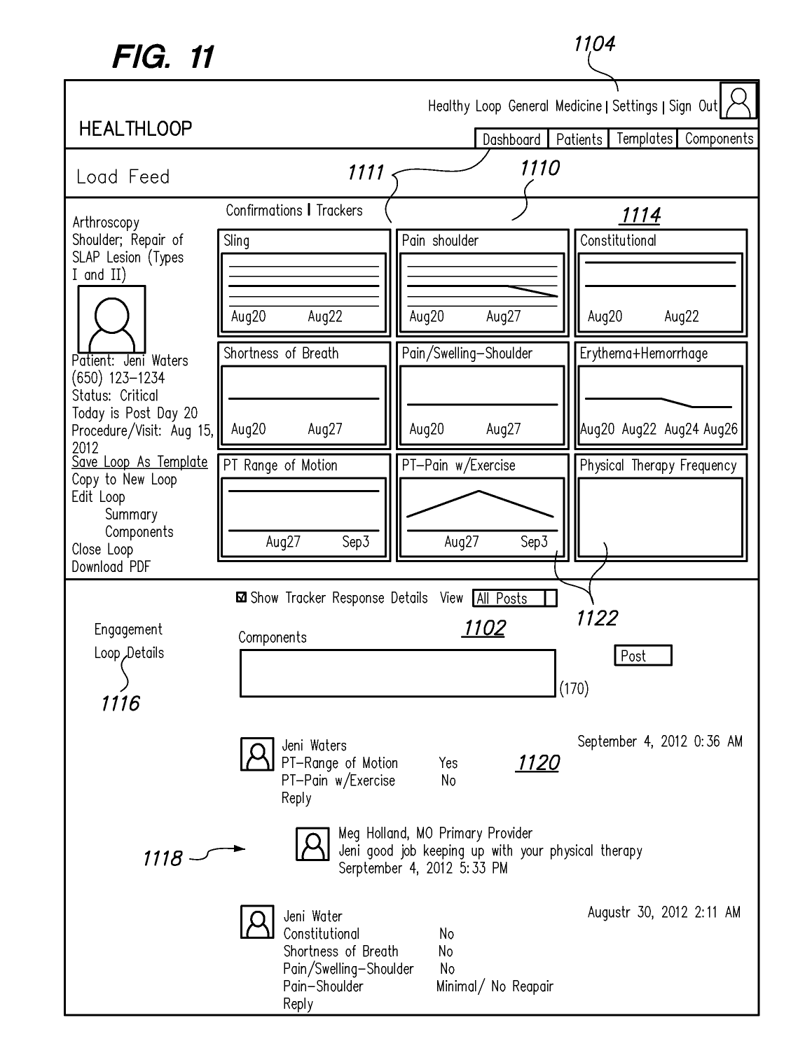

FIG. 14 illustrates an example screen display for a computer graphical user interface for a provider showing Loop details. In an embodiment, the display of FIG. 14 shares aspects of the format of FIG. 10, FIG. 11 and a Loop Details display 1402 in the lower half of the display provides detailed information about the current Loop. In an embodiment, the Loop Details comprise values for a Primary Diagnosis, Comorbidities, and Procedures as seen at 1404, and a table 1406 of the Components of the Loop. In an embodiment, the table 1406 comprises rows associated with individual Components such as Trackers, Medications, Reminders and Patient Material. For each such Component, the table 1406 comprises values for a Name, Start Date, End Date, and Frequency. Consequently, a provider can rapidly review current values for the current Loop that is associated with the current patient. In an embodiment, the table comprises selectable column headings which when selected cause reordering the table using the selected column as a sort key. A summary area 1408 may display a name of the current Loop, a date of an associated procedure or visit, and a timeline bar indicating the relative amount of time elapsed since the procedure or visit. In an embodiment, selecting an Edit Summary button 1410 causes the application logic to enable editing the Loop summary information in the manner previously described for creating a new Loop.

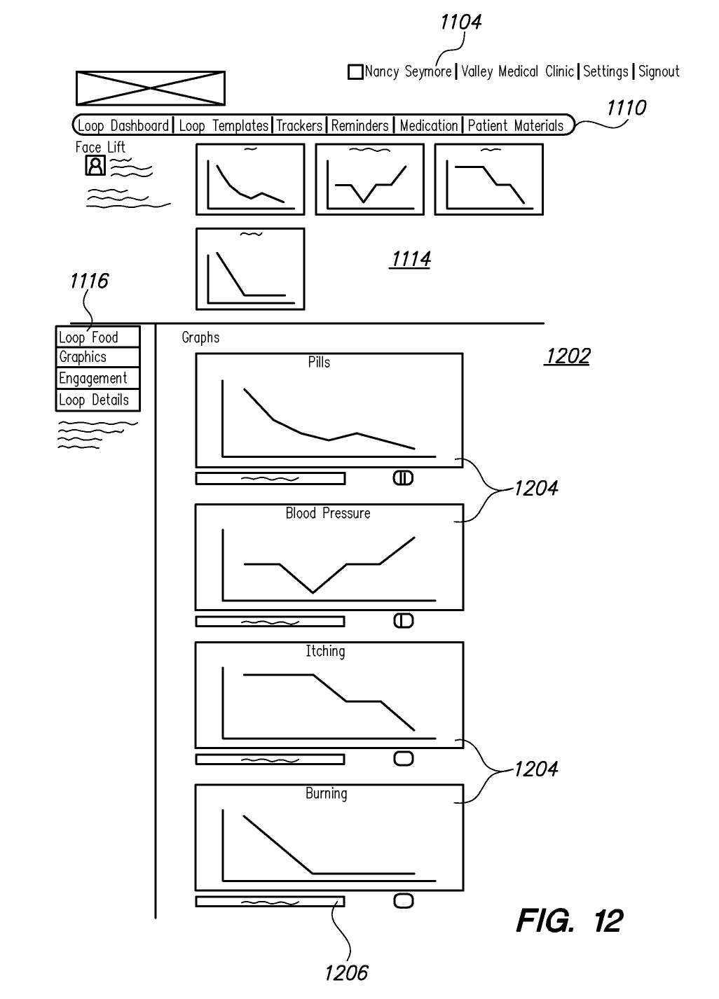

FIG. 15 illustrates an example screen display for a computer graphical user interface for a provider showing displaying Trackers. In an embodiment, the application logic displays the screen display of FIG. 15 in response to input selecting the Tracker link in the toolbar of function links of FIG. 11 or other views as described herein. In an embodiment, a Trackers display 1502 comprises a pull-down GUI widget 1504 titled HealthLoop Trackers in FIG. 15 and also including options for displaying different types of Trackers such as Practice Trackers. In an embodiment, a region 1510 of the display of FIG. 15 displays summary information for available Trackers that match the item then currently displayed in the pull-down GUI widget 1504. A search box 1506 is configured to accept characters or words relating to Trackers and the application logic is configured to display matching Trackers 1512 in the region below the search box.

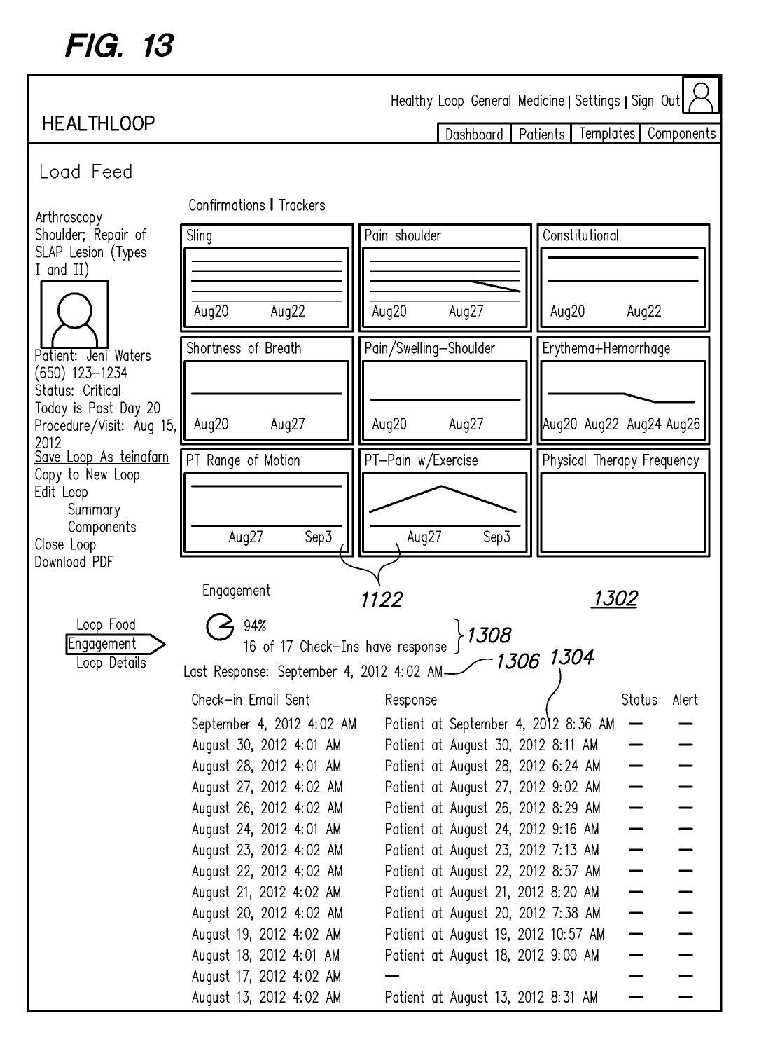

In an embodiment, a region 1508 of the display of FIG. 15 is titled My Trackers and has an associated button shown as Add New Tracker button 1514 which when selected causes the application logic to change state and display a screen configured to receive information about a new Tracker, as further described herein for FIG. 16, after which the new Tracker is added to a list in the My Trackers region 1508. For example, in FIG. 15 the list in My Trackers region 1508 comprises icons representing Trackers for Blood Pressure, Weight, Mood, and Mole Size, and others may be added using Add New Tracker button 1514. In this manner, a particular healthcare provider can develop a list of frequently used or referenced Trackers that can be associated with particular patient Loops using other functions.

FIG. 16 illustrates an example screen display for a computer graphical user interface for a provider showing creating a new Tracker. In an embodiment, a Tracker is defined by values specifying a Name of Tracker as seen at 1602, Description as seen at 1604, and one or more questions with associated choices as seen at 1606. In an embodiment, questions may be multiple choice questions or numeric questions. Further, questions may relate to objective medical signs or subjective patient symptoms and there is no limitation to providing answers solely to objective medical data. The ability for a provider to collect and evaluate information about subjective symptoms or perceptions of the patient provides a distinct benefit to the disclosed system, for example, by allowing a physician to weight or otherwise evaluate the objective medical data known about the patient based on the subjective reports that the patient personally provides.

At the same time, subjective responses are received in the form of structured data that are captured in the database in combination with structured data about objective signs. Both the objective sign data and subjective symptom data may be viewed in combination with personal images that the patient prepares and uploads, and free-form comments of the patient with respect to the patient's condition. All such values may be captured together and evaluated in a single Loop Feed by a provider.

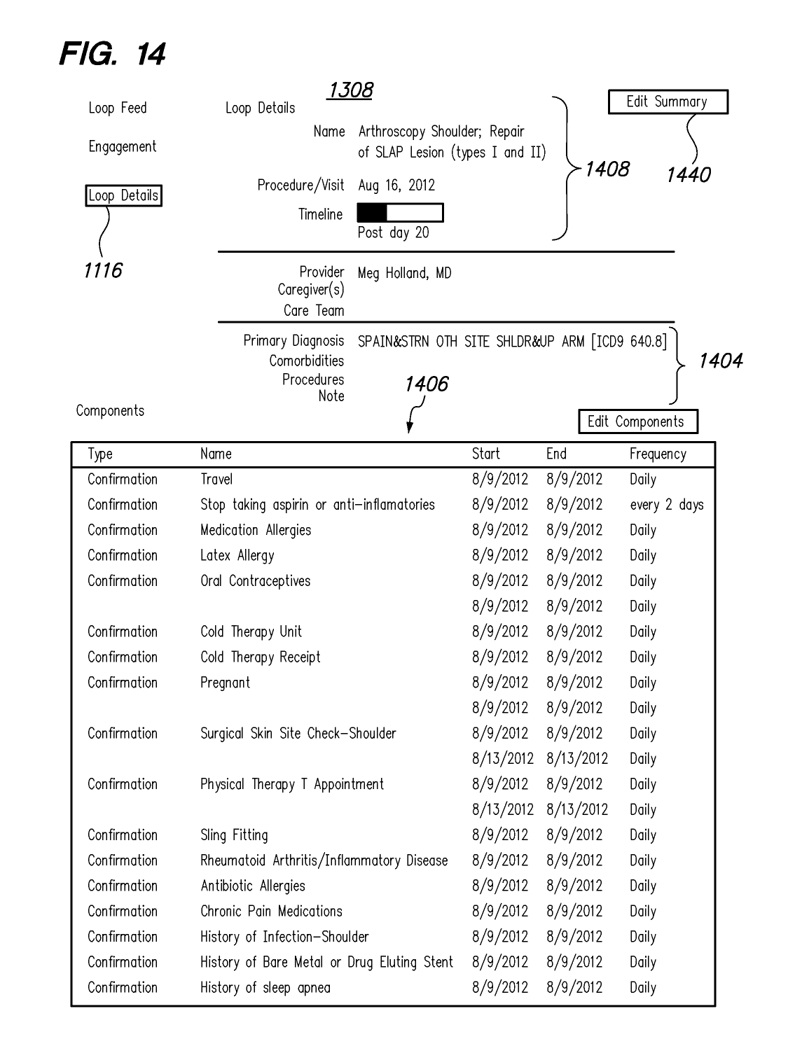

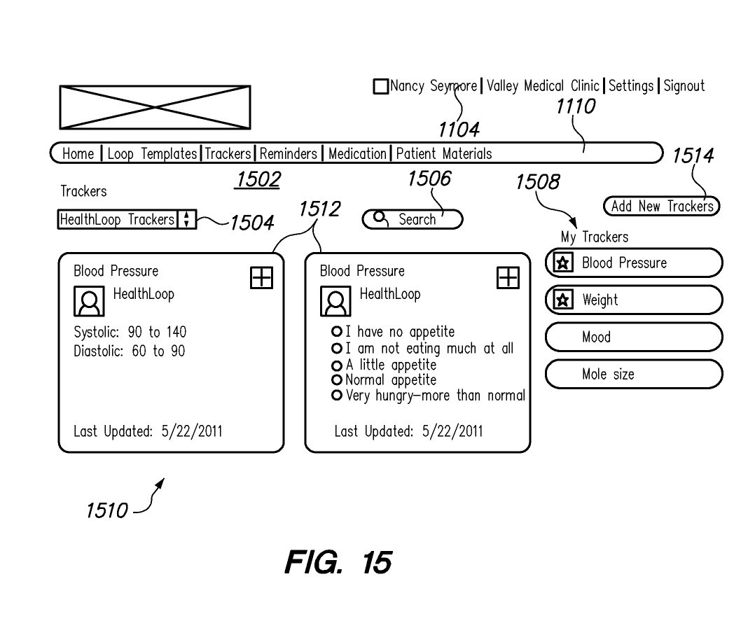

In an embodiment, Trackers may be complex, with multiple questions of different types. In the example of FIG. 16, the Tracker indicated at 1602 has a single multiple-choice question 1608 in the lower half of the display having three (3) choices 1609. Any number of choices may accompany a question 1608. An Add Choice link 1616 is associated with each question and when selected causes the application logic to display an additional Choice entry field for the associated question. In an embodiment, the display of FIG. 16 further comprises function links 1610, 1612 titled Add a Multiple Choice Question and Add a Numeric Question which when selected cause the application logic to change state and generate the displays of FIG. 17, FIG. 18 respectively and process the selected functions. Typically the Name of a Tracker at 1602 is a short word or other description that identifies the Tracker and the Description field at 1604 comprises a brief description about how the patient should reply or why the provider is using the Tracker. A Save Tracker button 1614 may be provided which when selected causes the application logic to save the Tracker information in the database and return to a prior state.

While certain embodiments provide for multiple-choice questions and numeric questions, other embodiments may implement other kinds of questions in the application logic. For example, in an embodiment, a Discrete Trackable or Discrete Tracker element may comprise one question with exactly five (5) choices, and a Continuous Trackable or Continuous Tracker may comprise one question with a numerical range.

FIG. 17 illustrates an example screen display for a computer graphical user interface for a provider showing adding a multiple choice question to a Tracker. In an embodiment, the display of FIG. 17 has the elements of FIG. 16 and also includes an additional multiple choice question 1700 in the lower part of the display. Each question 1700 of this type comprises a Question text box 1702 and at least two Choice text boxes 1704, each of which is configured to receive text data entry from the provider defining the question and responsive choices. An Add Choice link 1616 is associated with each question and when selected causes the application logic to display an additional Choice entry field for the associated question. A Save Tracker button 1614 may be provided which when selected causes the application logic to save the Tracker information in the database and return to a prior state.

FIG. 18 illustrates an example screen display for a computer graphical user interface for a provider showing adding a numeric question to a Tracker. In an embodiment, the display of FIG. 17 has the elements of FIG. 16 and also includes an additional numeric question 1802 in the lower part of the display. Each numeric question 1802 comprises a Question text box 1804, a Minimum Healthy Value numeric entry box 1806, a Maximum Healthy Value numeric entry box 1808, a Minimum Possible Value numeric entry box 1810, a Maximum Possible Value numeric entry box 1812, and a Units numeric entry box 1814, each of which is configured to receive data entry from the provider defining the question and allowed responsive choices. The application logic is configured to enforce the limits specified as the minimum values, maximum values, and units when the patient enters responses to the Tracker. A Save Tracker button 1614 may be provided which when selected causes the application logic to save the Tracker information in the database and return to a prior state.

FIG. 15, FIG. 16, FIG. 17, FIG. 18 show examples of particular Trackers with particular questions solely for purposes of illustrating clear examples. In other embodiments, Trackers may address any of a variety of objective signs, subjective symptoms, or a combination thereof. For example, embodiments may implement and offer the ability to track any one or more of the tracking metrics shown in TABLE 1, first column, in association with the questions and answers shown in TABLE 1, second column. The tracking metrics, questions and answers of TABLE 1 illustrate further examples and are not intended as exhaustive; other embodiments may use other tracking metrics, labels for equivalent tracking metrics, questions or answers, and the present disclosure is intended to broadly encompass any tracking metric and associated questions and answers that is useful or relevant to the processes that are described herein. In an embodiment, questions are structured to enable configuring the healthcare messaging logic or application logic to process and evaluate quantifiable values as they change over time and exhibits trends

TABLE 1
EXAMPLE TRACKERS

| TRACKING | |
|---|---|
| METRIC | QUESTION, ANSWERS |
| Dysuria or | When you urinate how would you compare the pain you |
| bladder spasm | have now to the past? |
| | Mild or none |
| | Moderate |
| | Severe |
| Dysuria or | How would you describe the pain when you urinate |
| Bladder | compared to usual pain for you (if any)? |
| Spasm | Mild or none |
| | Moderate |
| | Severe |
| Pain Control | How well controlled is your pain? |
| | 0 (no pain) |
| | . . . |
| | 5 (moderate pain with or without pain medication) |
| | . . . |
| | 10 (the pain cannot get any worse) |
| Hematuria | What color is your urine? |
| | Clear |
| | Yellow |
| | Pink |
| | Red |
| | Dark Red |
| Burning with | Are you having difficulties passing urine, or less urine |
| Urination | than usual? |
| | No difficulty |
| | Mild |
| | Moderate |
| | Severe |
| | I am unable to urinate at all |
| Constitutional | Are you having any other symptoms such as muscle |
| | aches, chills, or sweats? |
| | No |
| | Unsure |
| | Yes |
| Temperature | Please check your temperature with an oral thermometer |
| | and enter it here in degrees F. |
| | >101.5 F. |
| | Between 100.4-101.4 F. |
| | Between 96.0-96.5 |
| | <95.9 |
| Abdominal | Please describe the level of swelling on your abdomen: |
| Swelling | I have no swelling |
| | I have a little swelling |
| | I have moderate swelling |
| | I have a lot of swelling and it appears to be getting |
| | worse |
| Pain | Please rate your pain. Use the comment box for details, if |
| | relevant: |
| | No pain |
| | Slight pain |
| | Moderate pain |
| | A lot of pain that is getting worse |
| Drain Output | What is the total, 24-hour amount of fluid coming out of |
| Quantity | the drain Please enter the amount in cc′s: |
| | __cc |
| Drain Output | What is the color of the fluid coming out of the drain? |
| Color | Bright red |
| | Dark red |
| | Reddish yellow |
| | Yellow to clear |
| Post-Drain | How would you describe your swelling since we |
| Removal Fluid | removed the drain? |
| Wound | The swelling is less since drain removal |
| Evaluation | The swelling is unchanged since drain removal |
| | The swelling is increasing since drain removal |
| Flap | How does the skin on your abdomen look? |
| Evaluation | My abdomen skin looks pink and normal |
| | My abdomen skin looks somewhat bruised |
| | My abdomen skin looks pale and significantly bruised |
| | My abdomen skin looks black and stiff |
| Calf Pain/ | Do you have pain or swelling in the calf that is new for |
| Swelling | you, or do you notice that one calf is larger than the |
| | other (new for you)? |
| | No |
| | Unsure |
| | Yes |
| Shortness of | Do you have any shortness of breath or chest pain that |
| Breath | is new for you (If yes, please call 911 or go to the |
| | nearest emergency room)? |
| | No |
| | Unsure |
| | Yes |
| Pain | Have you been able to stop or reduce your use of |
| Medication | prescription pain medications? |
| | Yes, stopped |
| | Yes, reduced |
| | No |
| Pain Meds | Do you have constipation (hard, dry, or difficult to pass |
| Constipation | bowel movements) that is worse than usual for you? |
| | No |
| | Unsure |
| | Yes |
| Temperature | Is your temperature greater than 100.5 degrees when |
| | taken by a thermometer? |
| | No |
| | Yes |
| Wound Care | Are you keeping the incision area clean and dry? |
| | Yes |
| | No |
| Erythema | How much redness, if any, do you have around your |
| | incision? |
| | None |
| | A little that extends out less than 1 inch |
| | A lot that extends more than 1 inch or is getting worse |
| Temperature | Please take your temperature with an oral thermometer |
| | and enter the temperature. |
| | Default values: |
| | T > = 102.0 F. |
| | T > = 100.4 F. (38 C.) |
| | T between 96.8 and 100.4 |
| | T < = 96.8 F. (36 C.) |
| | T < = 96.0 F. |
| Rigors | Are you experiencing night sweats, shaking chills, or |
| | feeling feverish (that is new for you)? |
| | “No” |
| | “Yes, occasional or mild” |
| | “Yes, severe” |
| Nausea | Are you experiencing nausea that impairs your ability |
| | to eat or function (that is new for you)? |
| | “None” |
| | “Yes, mild” |
| | “Yes, moderate” |
| | “Yes, severe” |
| Jaundice | Do you have jaundice (yellow discoloration of the skin |
| | or eyes) that is new for you? |
| | “No” |
| | “Yes, but it is improving” |
| | “Yes, more or less unchanged” |
| | “Yes, and it is worsening” |
| Abdominal | Do you have abdominal pain that is new or different |
| pain | and impairs your ability to eat or function? |
| | “No” |
| | “Yes, but it is improving” |
| | “Yes, more or less unchanged” |
| | “Yes, and it is worsening” |
| Gl bleeding | Are you experiencing blood in your stool, or stool that |
| | is dark black (like tar), that is new for you? |
| | “No” |
| | “Yes or unsure” |
| Voiding | Are you having difficulty emptying your bladder |
| difficulty | compared to usual? |
| | No |
| | Yes. If so, please call the office |
| | Unsure |
| Nausea | Do you have nausea that affects your eating or limits |
| | your ability to do the things that you usually do? |
| | None |
| | Yes, mild |
| | Yes, moderate |
| | Yes, severe |
| Pain | How much of the prescribed pain medication are you |
| Medication | taking to keep your pain controlled? |
| Needs | Less than prescribed |
| | The same as prescribed |
| | More than prescribed |
| Drainage | How much drainage, if any, do you have coming from |
| | our incision? |
| | None |
| | Small: clear/slightly yellow |
| | Moderate: clear/slightly yellow and 2-3 dressing |
| | changes daily |
| | A lot that requires frequent dressing changes |
| Incision site | Do you have redness around the incision site? |
| erythema | No |
| | Yes - getting better |
| | Yes - staying the same |
| | Yes - getting worse |
| Vaginal | Has your vaginal bleeding stopped by now? |
| Bleeding | Yes |
| | Unsure |
| | No |
| Burning with | Are you having any difficulties passing urine or do you |
| Urination | have less urine output than usual? |
| | No difficulty |
| | Mild |
| | Moderate |
| | Severe |
| | I am unable to urinate at all |
| Scrotal | How would you describe your bruising (Remember that |
| ecchymoses | a painless black and blue color around the scrotum and |
| | the base of the penis is to be expected after the |
| | procedure and is normal)? |
| | Mild |
| | Moderate |
| | Severe |
| Scrotal edema/ | Describe the size of your swelling: |
| hematoma | Walnut-sized |
| | Between the size of a walnut and a peach |
| | Peach-sized or larger |
| Scrotal Pain | How would you describe the pain at your incisions |
| | compared to usual pain for you (if any)? |
| | Mild or None |
| | Moderate |
| | Severe |
| Incision site | Are you having any colored discharge from your |
| drainage | incisions other than a small amount of bleeding? |
| | No |
| | Yes, a small amount |
| | Yes, a moderate amount |
| | Yes a lot |
| Back pain | How would you describe the pain in your back? (0 = |
| | no pain. 10 = The worst pain possible. The pain cannot |
| | get any worse) |
| | 0-10 |
| Radicular | Do you have pain that shoots down one or both legs? |
| pain | No or minimal |
| | Yes, but getting better |
| | Yes, and Increasing |
| | Yes, severe |
| Allodynia | Do you have a sensation of pain to things that normally |
| | should not cause pain (for example, a light touch, or a |
| | brush against the skin on one of your legs)? |
| | No |
| | Unsure |
| | Yes |
| Headache | Are you having a headache that is new for you (since |
| | surgery)? |
| | No |
| | Unsure |
| | Yes |
| Drainage #2 | Are you having drainage from the incision that is clear |
| | in color? |
| | No |
| | Unsure |
| | Yes |
| Numbness | Are you having any numbness or tingling in your legs, |
| and Tingling | feet, or toes that is new for you? |
| | No |
| | Yes |
| Leg Weakness | Are you having any weakness in your legs that is new |
| | for you? |
| | No |
| | Not sure |
| | Yes |
| Home | How many times a day are you doing your home |
| Exercises | exercises? |
| | 3 times per day or more |
| | 2 times per day |
| | 1 time per day |
| | I am not doing them at all |
| PT frequency | Are you getting physical therapy at least twice weekly? |
| | Yes |
| | No |
| Erythema | How much redness, if any, do you have around your |
| | incision? |
| | None |
| | A little, it extends out less than 1 inch |
| | A moderate amount that extends 1-2 inches from |
| | the incision |
| | A lot, it extends more than 2 inches, and/or the |
| | redness is expanding or getting worse |
| Drainage | How often are you changing your gauze dressing each |
| | day due to drainage? |
| | There is no drainage, so I don't need to change it |
| | One time a day |
| | Two times a day |
| | Three or more times a day |
| Urine output | Have you had any period of 3 or more hours when there |
| | is no urine in the foley bag AND when you feel your |
| | bladder is full or painful? |
| | No |
| | Unsure |
| | Yes |
| Hematuria | What color is your urine? |
| | Clear or with occasional blood clots |
| | Pink or with moderate blood clots |
| | Red or with a lot of blood clots |
| | Dark |
| Ecchymoses - | It is normal after the procedure to have some bruising |
| Scrotum/Penis | at the incision sites, between the legs, at the scrotum, |
| | and at the base of the penis. Is your bruising getting |
| | better, staying the same, or getting larger? |
| | Better |
| | The same |
| | Larger |
| Edema - | After the procedure, it is normal to have some swelling |
| Scrotal/Penis | in the scrotum and at the base of the penis for a week |
| | or so. Describe the size of your swelling: |
| | Walnut-sized |
| | Between the size of a walnut and a peach |
| | Peach-sized or larger |
| Bladder | Can you control emptying your bladder? |
| incontinence | I have normal control |
| | I occasionally leak, but don't use pads |
| | I occasionally leak and require a pad a day |
| | I leak frequently or use more than one pad/day |
| | I have limited or no control over my urination |
| Erection | Describe your quality of erection now |
| | (Note: recovery can take up to 24 months) |
| | Does not apply |
| | I am able to have sex with an orgasm over 50% of |
| | the time |
| | I am able to have sex with an orgasm less than 50% |
| | of the time |
| | I am unable to have sex with an orgasm at all |
| Continuous | If prescribed by your surgeon, how many times a day |
| Passive | are you using your continuous passive motion (CPM) |
| Motion | Machine? (Remember that it should be used for 1-2 |
| (CPM) | hours at a time.) |
| | 3 times a day or more |
| | 2 times a day |
| | Unsure or does not apply (was not prescribed to me) |
| | 1 time a day |
| | Not at all |
| Crutches or | Are you able to use your crutches or walker without |
| Walkers | problems (stumbling or tripping)? |
| | Not applicable |
| | I no longer need crutches or a walker |
| | I am using the crutches or walker without difficulty |
| | I am having problems with the crutches or walker |
| Swelling | How much swelling do you have in and around your |
| | knee compared to your last check-in? |
| | No noticeable swelling |
| | The swelling is getting better |
| | The swelling hasn't changed |
| | The swelling is getting worse |
| | The swelling is much worse |
| Knee Pain | How would you describe the pain in your knee? |
| | Minimal/No pain |
| | Getting better |
| | No change |
| | Getting worse |
| | Severe |
| DVT | Have you finished your prescription blood thinner |
| prophylaxis | from your surgeon to prevent blood clots? |
| completion | Yes |
| | No |
| | Not applicable, I am on a long-term blood thinner |
| Hemorrhage | How much bleeding, if any, do you have coming |
| | from your incision? |
| | None |
| | A little |
| | Moderate: requires 2-3 dressing changes daily |
| | A lot: soaks through dressings and is difficult to stop |
| Paresthesia | Do you have any new numbness or tingling sensations |
| | in your leg since your surgery? |
| | No |
| | Yes |
| Ability to | Is your pain making it difficult for you to sleep at night? |
| Sleep | No |
| | Yes |
| Ability to Use | Are you able to walk without problems (stumbling or |
| Crutches | tripping) when using your crutches or cane? |
| | Not applicable |
| | I no longer need the crutches/cane |
| | I am using the crutches/cane without difficulty |
| | I am having problems with the crutches or cane |
| PT - pain | When in physical therapy, do you have significant pain |
| | with exercise? |
| | Yes |
| | No |
| PT - swelling | Do you still have swelling in and around your knee? |
| | [If yes, please also discuss with your physical therapist]. |
| | Yes |
| | No |
| PT - range of | Are you having difficulty fully straightening and |
| motion | bending your knee? |
| | Yes |
| | No |
| PT - muscle | Are you having difficulty moving/contracting your |
| activation | thigh (quadriceps) muscle? |
| (knee) | Yes or unsure |
| | No |
| Weight | How much weight can you put on your foot? |
| Bearing | I can support all (100%) of my weight |
| | I can support most of my weight |
| | I can barely support my weight |
| | I am unable to support any of my weight |
| Weight | How much weight have you been instructed to put on |
| Bearing - | your foot (in percentage)? |
| Wks 1-6 | 51-100% of my weight |
| | 1-50% of my weight |
| | Non-weight bearing |
| | Not sure |
| CPM Machine | If you are using a continuous passive motion (CPM) |
| | machine, are you having any problems with it? |
| | No |
| | Yes |
| Shoulder Pain/ | Do you have any new shoulder pain or swelling? |
| Swelling | No |
| | Unsure |
| | Yes |
| Shoulder Pain | How would you describe the pain in your shoulder? |
| | Minimal/No pain |
| | Getting better |
| | No change |
| | Getting worse |
| | Severe |
| Paresthesia | Do you have any new numbness or tingling sensations |
| (Arm) | in your arm since your surgery? |
| | No |
| | Yes |
| PT - pain | When in physical therapy, do you have significant |
| | pain with exercise? |
| | Yes |
| | No |
| PT - swelling | Do you still have swelling in and around your shoulder? |
| (shoulder) | [If yes, please also discuss with your physical therapist]. |
| | Yes |
| | No |
| PT - range of | Are you having difficulty fully straightening and |
| motion | bending your arm at the shoulder? |
| (shoulder) | Yes |
| | No |
| PT - muscle | Are you having difficulty moving/contracting the |
| activation | muscles around your shoulder? |
| (shoulder) | No |
| | Yes or unsure |
| Sling | How often are you wearing your sling? |
| | All the time |
| | Most of the time |
| | Some of the time |
| | I am not wearing it at all |
| Erythema | The area of redness is smaller |
| | The area of redness is unchanged |
| | The area of redness is larger |
| Edema | Size of a dime |
| | Size of a golf ball |
| | Size of a tennis ball |
| | Larger |
| Dyspnea | Short of breath only with exercise |
| | Short of breath walking inside of home |
| | Short of breath during conversations |
| | Short of breath at rest |
| Incision site | How much bleeding is there from the incision site? |
| bleeding | None |
| (hemorrhage) | Slight oozing |
| | Enough to soak a cotton ball daily |
| | Enough to soak more than one cotton ball daily |
| Incision site | How large is the bruise (area of discoloration) at the |
| bruising | incision site? |
| (ecchymosis) | None |
| | Size of a quarter or smaller |
| | Size of a ping-pong ball or smaller |
| | Size of a deck of cards or smaller |
| | Larger than a deck of cards |
| Incision site | How swollen (raised and/or firm) is the area at the |
| swelling | incision? |
| (edema) | Not swollen at all |
| | Size of a marble or smaller |
| | Size of a ping-pong ball or smaller |
| | Size of a golf ball or smaller |
| | Larger than a golf ball |
| Chest pain | Do you have chest pain that is new for you, or is worse |
| | than before the procedure? |
| | No, none at all |
| | No, it is the same as what I had before the procedure |
| | Yes, and it mostly occurs with exertion. (Nitroglycerin, |
| | if I take this medicine, seems to help it) |
| | Yes, and it mostly occurs with exertion. (Nitroglycerin, |
| | if I take this medicine, does not help it) |
| | Yes, and it even occurs at rest. (Nitroglycerin, if I take |
| | this medicine, seems to help it.) |
| | Yes, and it even occurs at rest. (Nitroglycerin, if I take |
| | this medicine, does not help it.) |
| Taking | Did you pick up and start taking your Plavix or Prasugrel? |
| medications | Yes |
| | No or unsure |
| Melena | Do you have bowel movements (stool) that are colored |
| | dark black like the color of tar? |
| | No |
| | Yes or unsure |
| Hematochezia | Do you have bowel movements (stool) that appear to |
| | have blood mixed in with them (not just a drop or two |
| | on the outside of the stool)? |
| | No |
| | Yes or unsure |
| Myalgias | Do you have general muscle aches that are new for you |
| related to | and do not seem to be related to exertion or exercise? |
| statin | No |
| | Yes |
| | Unsure |
| Cardiac | If you registered for cardiac rehabilitation, are you |
| rehabilitation | participating? |
| participation | Yes, I am participating regularly |
| | I am participating sometimes |
| | I am rarely participating |
| | I recently finished cardiac rehabilitation |
| | I am not participating |
| | I did not register |
| Abdominal | Do you have abdominal pain that is new or different |
| Pain | and impairs your ability to eat or function? |
| | Default values: |
| | “No” |
| | “Yes, but it is improving” |
| | “Yes, more or less unchanged” |
| | “Yes, and it is worsening” |
| Gl bleeding | Are you experiencing blood in your stool, or stool that |
| | is dark black (like tar), that is new or different for you? |
| | “No” |
| | “Yes, very mild” |
| | “Yes, moderate to severe, or unsure” |

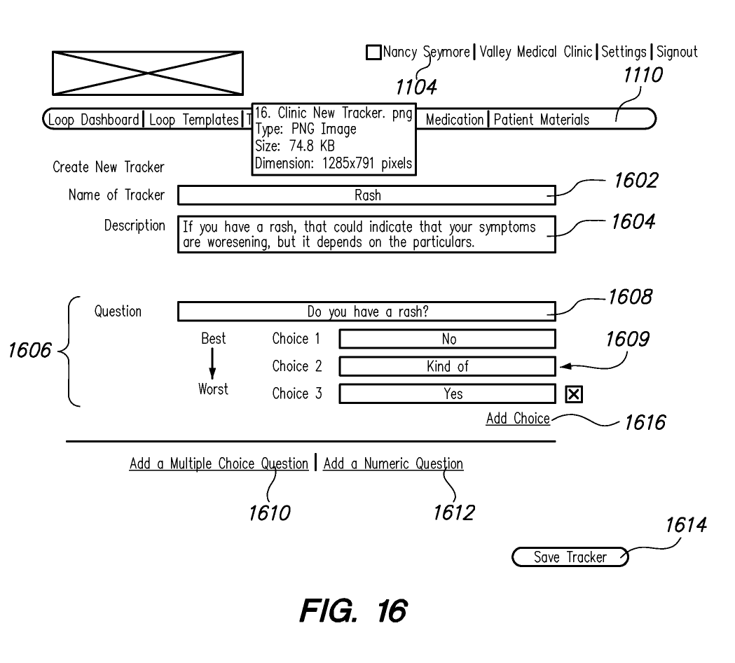

FIG. 19 illustrates an example screen display for a computer graphical user interface for a provider showing entering Reminders. In an embodiment, the application logic displays the screen display of FIG. 19 in response to input selecting the Reminders link in the toolbar of function links of FIG. 11 or other views as described herein. In an embodiment, the Reminders display comprises a pull-down GUI widget 1902 titled HealthLoop Reminders in FIG. 19 and also including options for displaying different types of Reminders such as Practice Reminders. In an embodiment, a region of the display of FIG. 19 displays summary information for available Reminders 1904 that match the item then currently displayed in the pull-down GUI widget. A search box 1906 is configured to accept characters or words relating to Reminders and the application logic is configured to display matching Reminders 1904 in the region below the search box.

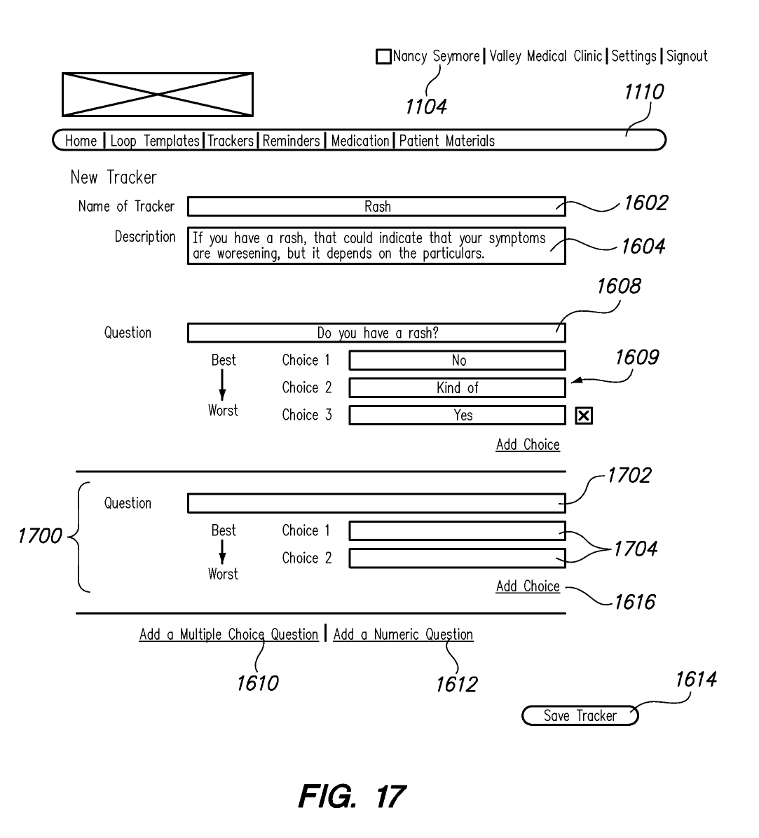

In an embodiment, a region of the display of FIG. 19 may have an associated button titled Create New Reminder 1910 which when selected causes the application logic to change state and display a screen configured to receive information about a new Reminder, as further described herein for FIG. 20A. In an embodiment, the new Reminder is added to a My Reminders list of reminders for the current provider 1104. In this manner, a particular healthcare provider 1104 can develop a list of frequently used or referenced Reminders that can be associated with particular patient Loops using other functions.

FIG. 20A illustrates an example screen display for a computer graphical user for a provider interface showing entering a new reminder. In an embodiment, the display of FIG. 20A comprises Name of Reminder and Reminder Message text data entry boxes 2002, 2004 that are configured to receive text data representing a name of a reminder and a particular reminder message. A Save Reminder button 2006 may be provided which when selected causes the application logic to save the Reminder information in the database and return to a prior state.

FIG. 20B illustrates an example screen display for a computer graphical user interface for a provider showing entering a new medication. In an embodiment, the application logic displays the screen display of FIG. 20B in response to input selecting the Medications link in the toolbar of function links of FIG. 11 or other views as described herein. In an embodiment, the display of FIG. 20B comprises Name of Medication text data entry box 2008, a Form text entry field 2009 to indicate the format of the medication, a Dosage numeric entry box 2010, a units box 2012, optionally a route of administration box, and optionally a scheduled frequency of administration GUI widget that are configured to receive data values representing a name of a medication, a dosage, particular units for a medication, route of administration, and dosing frequency. A Save Medication button 2016 may be provided which when selected causes the application logic to save the Medication information in the database and return to a prior state.

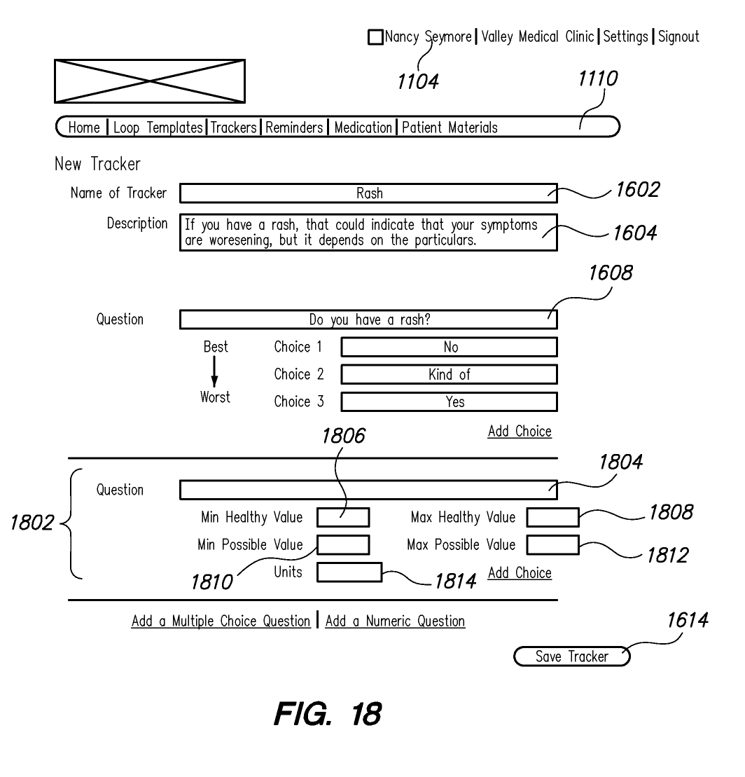

FIG. 21 illustrates an example screen display for a computer graphical user interface for a provider showing entering patient material. In an embodiment, the application logic displays the screen display of FIG. 21 in response to input selecting the Tracker link in the toolbar of function links of FIG. 11 or other views as described herein. In an embodiment, the display of FIG. 21 comprises Name of Patient Material and Description text data entry boxes 2102, 2104 that are configured to receive text data representing a name and description of a particular item of patient material. In an embodiment, an Upload File data entry element 2106 is provided in association with a Browse button 2108, and the application logic is configured to implement file locating and uploading functions based on function calls to an operating system on which the application logic is running. For example, a file open dialog may be requested and the user may be prompted to enter or select a file name of a file representing or containing the Patient Material. A Save Patient Material button 2110 may be provided which when selected causes the application logic to save the Patient Material information in the database and return to a prior state. In another embodiment, the term Care Instructions may be used rather than Patient Material.

Patient Screen Displays and Functions

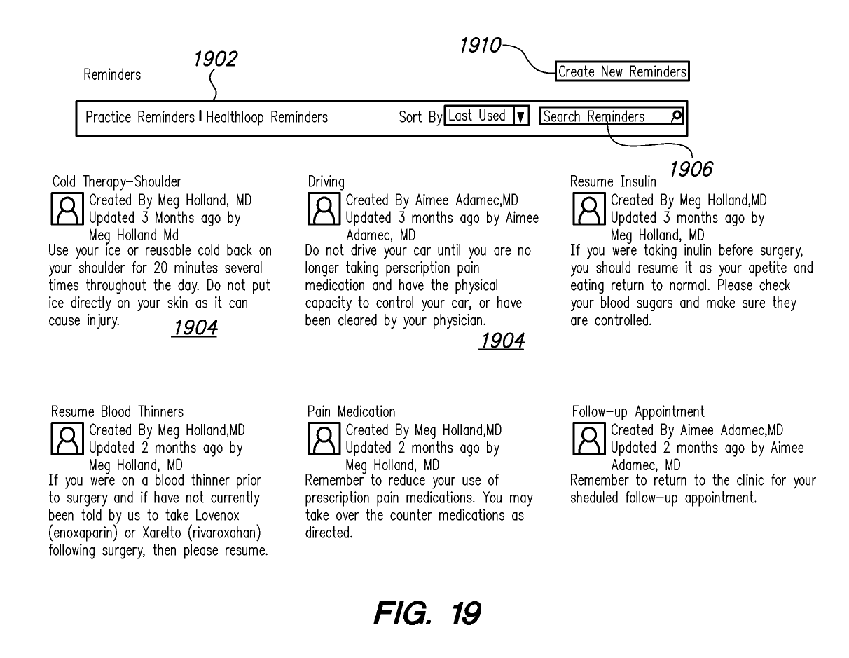

FIG. 22 illustrates an example screen display for a computer graphical user interface for a patient and showing a check in page. In an embodiment, the application logic is configured to generate and provide, to end users who are patients or care givers, a display 2200 of the form of FIG. 22 as the first screen display in response to a patient logging in to the system. For example, secure login procedures may be implemented based on a patient user name, password, PIN or other credentials for the purpose of protecting patient privacy and compliance with legal requirements. A patient or other user may elect to log in to the system in response to receiving an email message or other alert that was automatically generated as a result of the operation of a Tracker, Reminder, or other element of a Loop as previously described. Alternatively the patient may elect to log in for other reasons, such as to check status of a Loop, read a Loop Feed, to create and send a comment to a provider, or various other reasons.

In an embodiment, the check in page 2200 comprises a name of a current Loop at 2202, a physician name and thumbnail image as seen at 2204, and one or more questions, data entry boxes, and file uploading regions (collectively indicated as 2206) that are generated based on a stored definition of the current Loop for the current patient. The particular questions, data entry boxes, and file uploading regions at 2206 are dynamically generated and are variable for each patient; thus, FIG. 22 represents an example but not requirements for any particular page or display. In one embodiment, a data entry box 2208 for receiving free-form comments, and a file uploading region 2210, are always present in the patient check-in page whereas the other elements are dynamically generated based on the current Loop. Consequently, the patient is able to enter information about subjective symptoms of the patient and there is no limitation to providing answers solely to objective medical data. Further, the particular questions may reflect subjective symptoms such as pain or other issues.

In the example of FIG. 22, the current patient is “Jane” as denoted by a “Welcome Jane” link 2212 in the display, which also functions as a link for logging out of the system. The current Loop is a Face Lift Loop as seen at 2202 and physician Nip Tuck is administering the Loop as seen at 2204. As seen at 2206, the Loop comprises two multiple-choice questions, a numeric question, a free-form text entry box 2208, and a file uploading region 2210 that enables the patient optionally to upload a digital image of the patient's condition, such as a photo of a body part. In an embodiment, questions list response choices from best to worst. The file uploading region may comprise prompt text such as “Send the doctor a photo that shows your condition.” Typically a check-in page of the type in FIG. 22 is configured to prompt the user to provide at least some generalized or basic symptom or condition information early in the viewing process, so that the system can obtain at least a generalized response about how the patient is currently feeling. For example, questions at 2206 in FIG. 22 may be preceded by a general prompt stating, “Tell us about your condition today:” or a similar phrase.

In an embodiment, the information shown in FIG. 22 is delivered to the patient in the form of HTML code in a web page that the patient displays using a browser. In operation, a patient user enters values in response to the questions and other fields and selects a Send button 2214. The HTML code is configured to transmit to the application logic, in response to the patient selecting the Send button 2214, the data values that have been entered using an HTTP POST or similar data transmission protocol operation. The label Send on the Send button 2214 cues the patient to understand that selecting the button causes sending data to the healthcare provider rather than storing the data locally. Further, in an embodiment, selecting the Send button 2214 causes the application logic to change state and to cause generating and providing the Loop Feed page for the current Loop.

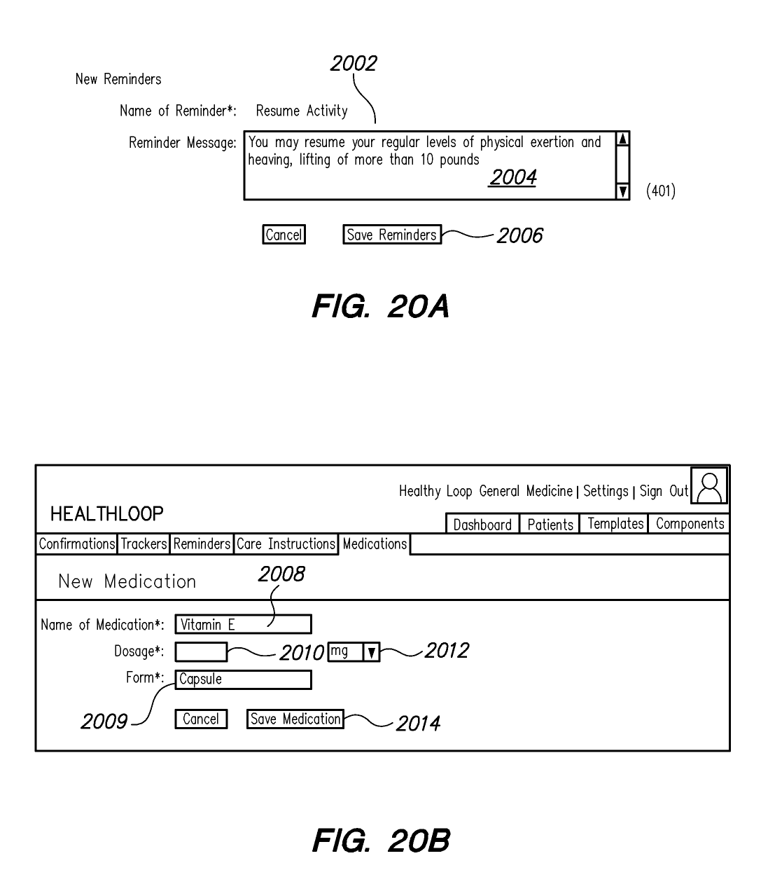

FIG. 23 illustrates an example screen display for a computer graphical user interface for a patient and showing a patient Loop Feed. In an embodiment, a patient Loop Feed 2302 generally comprises a first region 2304, shown on the left side of FIG. 23, for information associated with a particular Loop, and a second region 2306, shown on the right side of FIG. 23, titled My Loops and identifying all Loops that are associated with the current patient. The first region 2308 for a particular Loop comprises summary information such as a Loop name, physician name, status, graphs, and general user input tools such as an Update Status button, filter pull-down, and Search box. The summary information may include one or more graphs 2310 from Trackers associated with the Loop that inform the patient about historic progress for a particular Tracker. The first region 2308 may also include a chronological or reverse chronological list 2312 of posts from the provider and the patient. Provider posts such as 2314 may implement multiple-choice questions or numeric questions based on Trackers. Patient posts such as 2316 may comprise responses to the questions, or questions or comments of the patient in association with one or more replies in the manner described above for the provider Loop Feed.

In an embodiment, a button 2318 titled Update Status or Ask A Question button is configured to cause the application logic to change state and generate a page that prompts the patient to enter a question or comment which when saved will appear in the patient's Loop Feed 2302 and the provider's Loop Feed 1102 (FIG. 11). In an embodiment, a filter pull-down widget 2320 initially is titled Show All Posts and also may include items which when selected cause filtering the items in the reverse chronological list according to other criteria, such as Only My Posts, Only Doctor's Posts, or others.

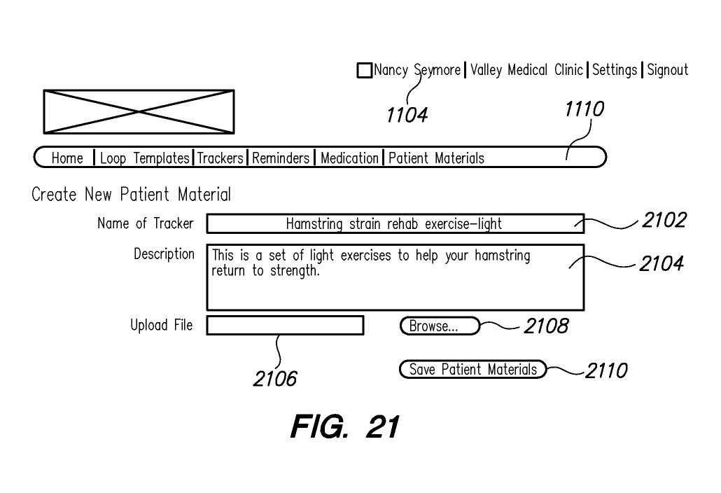

In an embodiment, the second region 2306 titled My Loops comprises one or more summary boxes 2330 that display basic information for a particular Loop. The basic information may comprise Loop name 2332, physician name, status, graphs of Trackers, and function links such as New Messages and Unanswered Questions. In an embodiment, each Loop name 2332 is a function link which when selected causes the application logic to change state and display detailed information for the selected Loop as further shown in FIG. 24. In an embodiment, selecting a New Messages link 2334 causes the application logic to generate a page in the same form as FIG. 23 but including only messages in the Loop Feed that have not been previously displayed to the current user. In an embodiment, selecting a Unanswered Questions link 2336 causes the application logic to generate a page in the same form as FIG. 23 but including only questions in the Loop Feed that have not been previously answered by the current user.

FIG. 24 illustrates an example screen display for a computer graphical user interface for a patient and showing a patient Loop Feed. In an embodiment, a patient Loop Feed display comprises an upper region 2402 providing summary information and a lower region 2404 comprising a tabbed display of a Loop Feed, Graphs or Downloads. In an embodiment, the summary information in region 2402 identifies the patient's doctor and other members of the care team such as physician assistants, clinic administrative assistants, or other personnel associated with a provider, clinic or other healthcare institution. In an embodiment, the tabbed display of region 2404 initially displays a Loop Feed tab 2406 comprising a summary bar 2408, user function tools 2410, and a reverse chronological list 2412 of posts by a provider or the patient. In an embodiment, the summary bar 2408 comprises a Start Date, End Date, and Status value, which depict current or most recent values associated with the Loop, and a function link 2414 titled Close Loop. In an embodiment, selecting the Close Loop function link 2414 causes the application logic to change state to end the Loop and generate a new page in the form of FIG. 23. The remaining elements of the tabbed display for the Loop Feed are structured and function in the same manner described above for FIG. 23.

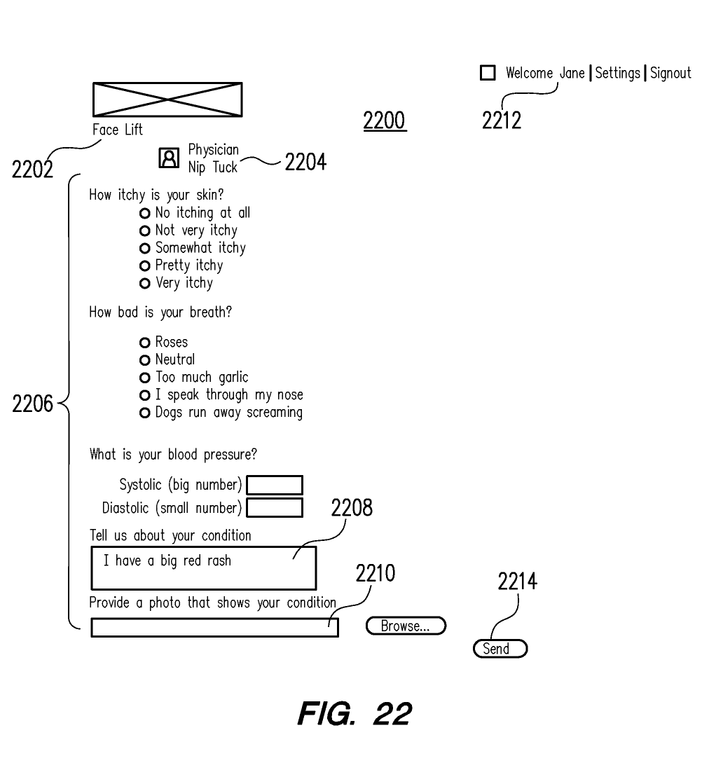

FIG. 25 illustrates an example screen display for a computer graphical user interface for a patient and showing a patient Loop Feed with downloads. In this context, “downloads” is equivalent to Patient Material in the provider displays. The Downloads tab 2502 identifies Patient Material 2504 that can be downloaded from the application logic to a local computing device of the patient. In an embodiment, each item 2506 in the Downloads tab 2502 is identified using an icon and a name that is configured as a hyperlink to a resource location on the server computer 2 or in the database. In an embodiment, in response to input selecting a name of an item in the Downloads tab 2502, the application logic delivers a copy of the associated Patient Material 2504 to the patient's computer.

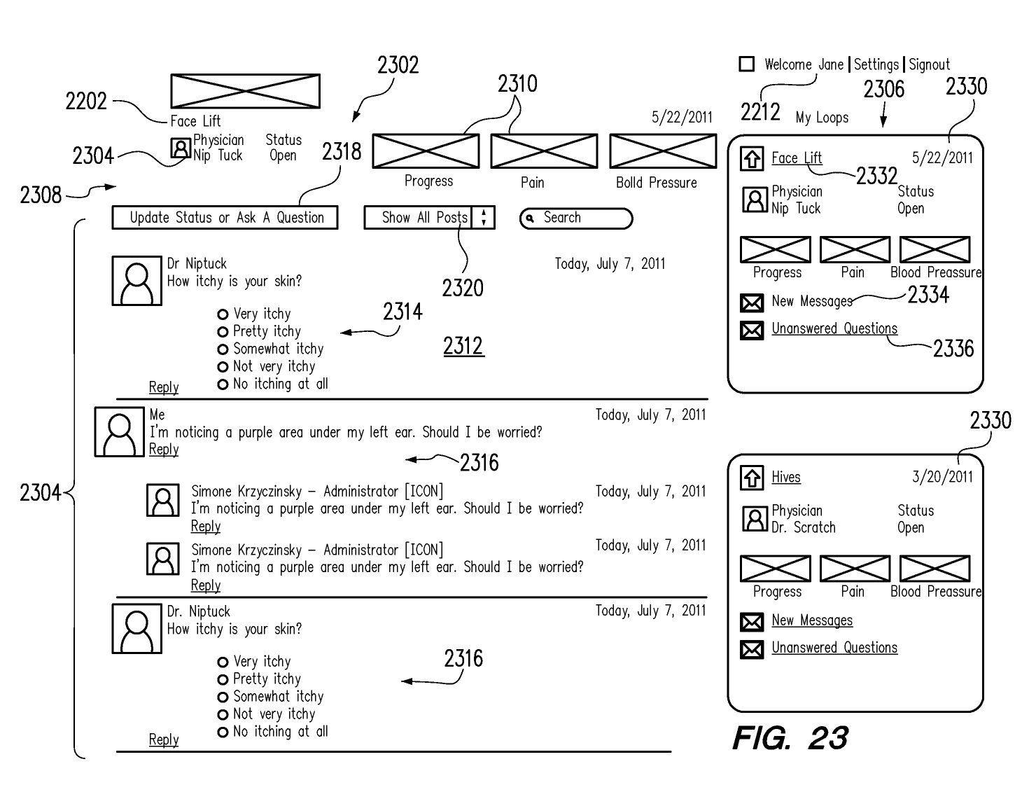

FIG. 26 illustrates an example screen display for a computer graphical user interface for a patient and showing a patient Loop Feed with graphs. In an embodiment, the display of FIG. 26 comprises one or more enlarged graph views 2602, each having an associated text entry box 2604 that may be titled “Leave a comment” to prompt the patient to enter a comment about an associated graph. In an embodiment, the page of FIG. 26 comprises HTML code that is configured to cause the browser, in response to input providing a comment in a text entry box 2604 and a data entry action such as selecting the carriage return key, to send the comment text to the application logic. In response, the application logic stores a copy of the comment in the database to be displayed in the provider Loop Feed in the manner previously described. Comments may reflect subjective symptoms of the patient.

Clinic Screen Displays and Functions

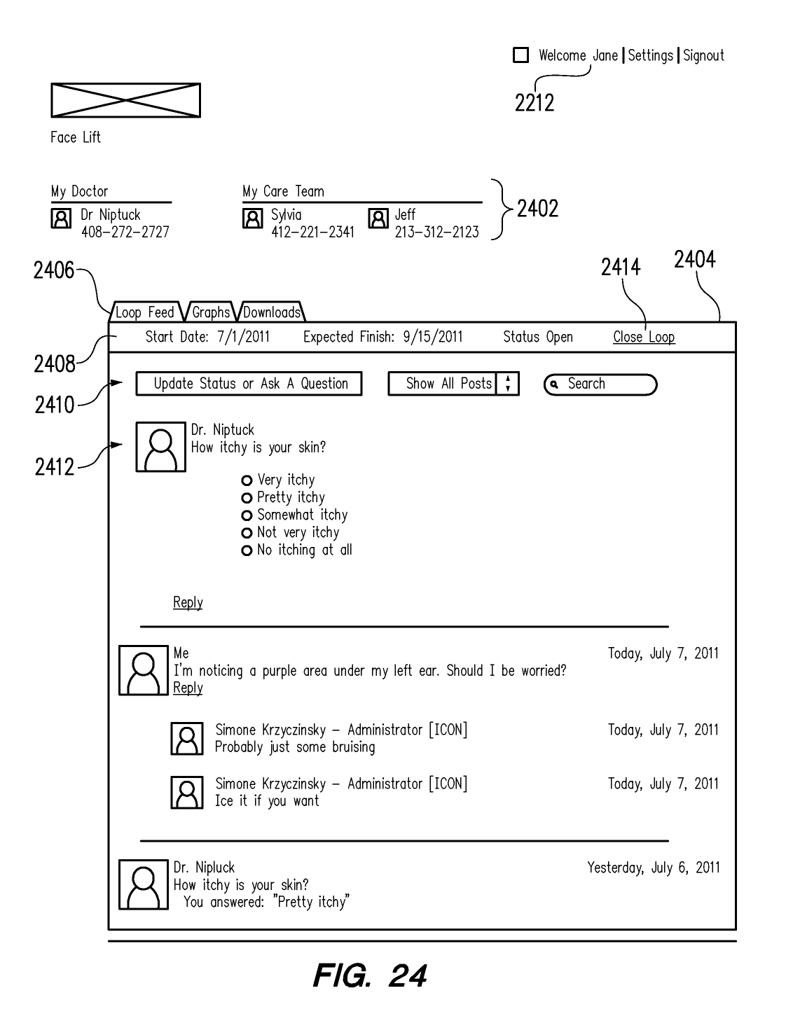

FIG. 27 illustrates an example screen display for a computer graphical user interface for a provider and showing a clinic practice management page. In an embodiment, the screen display of FIG. 27 enables provider users associated with a particular healthcare institution such as a clinic to interact with the application logic to define contact information, employees such as physicians, other care providers, and administrators or other staff. In an embodiment, the screen display of FIG. 27 comprises a display of database information for each individual then currently associated with the healthcare institution and provides links for accessing adding, deleting or editing functions for individuals.

Extensions

Various embodiments may implement alternatives, improvements, and extensions as follows. Electronic medical records (EMR) integration may be accomplished by linking Trackers to diagnostic codes (e.g. SNOMED CT, ICD-9 or ICD-10), billing, service and procedure codes (e.g. CPT, DRG) or providing links between systems. For example, the messaging logic 8 may obtain basic patient data or provider data using calls to an EMR, or by exposing an Application Programming Interface (API) to which an EMR may issue calls. Additionally or alternatively, the logic may be configured to subscribe to specified event messages that are generated in the EMR and to parse the event messages and determine whether to add Components to particular Trackers or generate alerts. For example, an event message may represent an abnormal laboratory report metric that could trigger a new Tracker Component directed to following up on the abnormal metric. In one embodiment, EMR integration may enable the transmission of Patient Materials, Medication prescription information, and Reminders between the systems.

In an embodiment, the messaging logic 8 may be configured with one or more alerts that automatically generate appointments in an EMR system. For example, trends reflected in Trackers may generate alerts that instruct the patient to visit an emergency room or Primary Care Physician (PCP) clinic. Trackers may generate alerts that instruct the provider to call the patient or take other actions.

The application logic may be configured with electronic prescription capability.

In an embodiment, patients may search for and connect to other patients who are involved in the same or similar Loop protocol(s) so that a community of persons who are recovering from the same or similar condition(s) may communicate or share messages. Connections of patients may be facilitated by the association of patients to the same Loop. In other words, if five (5) different patients with different providers all are using the same Loop, then the system may suggest internal social networking opportunities for the patients based on pseudonyms, screen names, and the like.

In an embodiment, Loops may be used to drive coupon offers or other commercial offers or advertisements, coupons, or points to patients within the patient Loop Feed. For example, the system could request from a coupon server or otherwise present offers for coupons that are relevant to a particular Loop or Tracker. Additionally or alternatively, advertisements may be selected and presented, or requested from an advertising server, based on the name, nature, or keywords associated with a particular Loop or Tracker. In these approaches, commercial offers may be presented to patients or other users, for example, within a Loop Feed, without communicating personally identifying information to the commercial source of the offer, such as a vendor, manufacturer or service provider.

Data developed in the system may be used to develop best practice recommendations or definitions for use in the larger healthcare community. For example, over time using analytics logic the system may develop data indicating that patients who observed a 10-day antibiotic cycle recovered more completely in a given Loop protocol than patients who used a 7-day cycle. Loop templates may be optimized or modified based on analytics of data developed in the system. Further, in present practice follow-up or pre-visit care guidelines are limited or nonexistent and new guidelines may be specified based on the evidence obtained from the system through use over time for particular Loop protocols or ARC OF RECOVERY profiles. Thus, embodiments provide new ways to develop standards or guidelines that are evidence-based, in a data-driven sense such that the evidence is obtained from actual patient tracking and recovery data rather than a formal clinical study; the templates, Loop protocols or ARC OF RECOVERY profiles may be denoted as PHASE FOUR Loops or ARC OF RECOVERY profiles because they are evidence-based in the sense of data-driven from the system.

In an embodiment, performance measures of providers may be improved based on the data developed in the system. Since a continuous stream of data is developed in the database, analytics logic may be used to determine whether providers in follow-up or pre-visit care are meeting expectations for performance measures or to create and store new performance measures that reflect levels of participation or effectiveness of follow-up or pre-visit care. For example, relevant Health Effectiveness Data and Information Set (HEDIS) guidelines may be updated or modified, or new measures may be created, based on the data developed in the system with respect to objective signs. New measures may reflect whether, for example, a physician has implemented specified aspects of follow-up or pre-visit care.

In an embodiment, the application logic implements one or more game functions that enable one or more patients to play games against the application logic and/or against one or more other patients. For example, games may implement comparisons of performance under various Loop protocols.

### 3.0 Second Example Embodiment

A second example embodiment is described herein through other materials labeled as Specification in the online documents submitted as part of the priority provisional disclosure. This embodiment generally provides an automated patient pre-visit and follow-up solution that is intended to improve healthcare outcomes by connecting providers and patient to track preparation, recovery, compliance, and wellness.

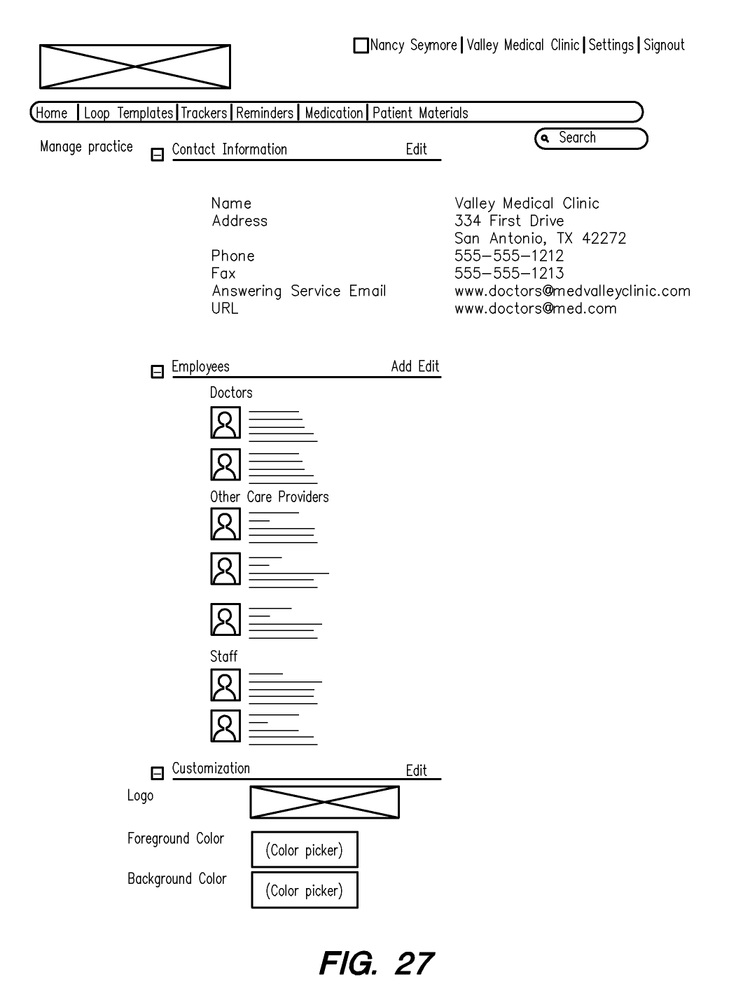

FIG. 30 illustrates a functional overview of an embodiment. In one step, a user such as a patient checks email regularly to review periodic messages that optimize follow-up in a healthcare environment. In another step, the user enters information; for example, messages as the user to provide data about a condition, such as pain, mood, temperature. In another step, an automated system monitors the responses; the information that the user sends is transmitted and reviewed by a doctor to ensure that patients are progressing appropriately. In another step, the user communicates with the system about the user's treatment; in particular, the user can use the system to send messages about the follow-up tracking system in which the user is involved.

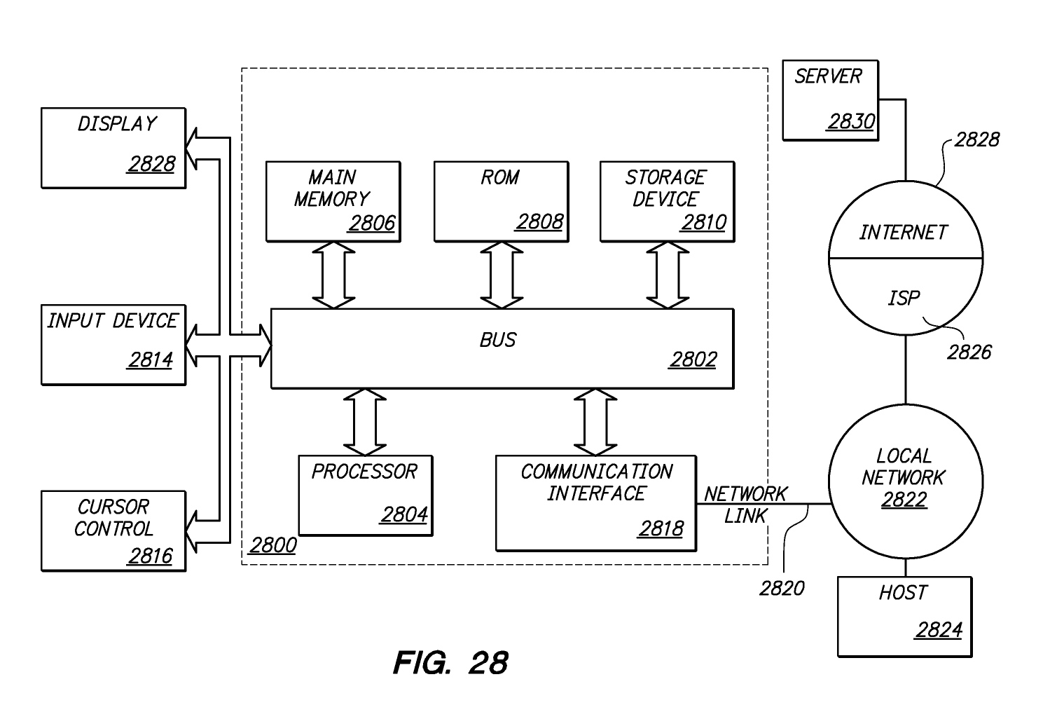

FIG. 31 illustrates an example graphical user interface of an embodiment that is generated by application logic for creating a new treatment Loop. As seen in FIG. 31, a treatment Loop is associated with a particular Patient and Condition. Optionally, the Loop may specify a related procedure, and one or more Medicines. Each Medicine associated with the Loop is identified by name, quantity, method of administration, periodicity, and duration. Each Loop is further associated with a start date, an expected reversal time, an expected completion time, and a reminder frequency value. Optionally, the healthcare provider may enable a checkbox titled “Track pain,” to cause the application logic to send inquiries about a level of user pain.

In some embodiments, a practitioner may create a new treatment Loop by selecting a template from among a library of templates. An example library of Loops might specify acute templates or chronic templates. Examples include templates for total knee arthroplasty, total hip arthroplasty, joint arthroscopy, lumbar laminectomy, rotator cuff repair, cystoscopy, prostatectomy, colonoscopy, endouroscopic procedure, nephrectomy, percutaneous coronary intervention with stent, acute hypertension, gastroenteritis, abdominal pain, urinary tract infection, pharyngitis, sinusitis, etc. Each Loop defines the content and timing for one or more Notifier messages or Notification Emails, which are automatically generated messages that are sent via email to users or patients. The frequency and content of Notifier messages are dependent on the type of Loop that a manager has set up for the patient.

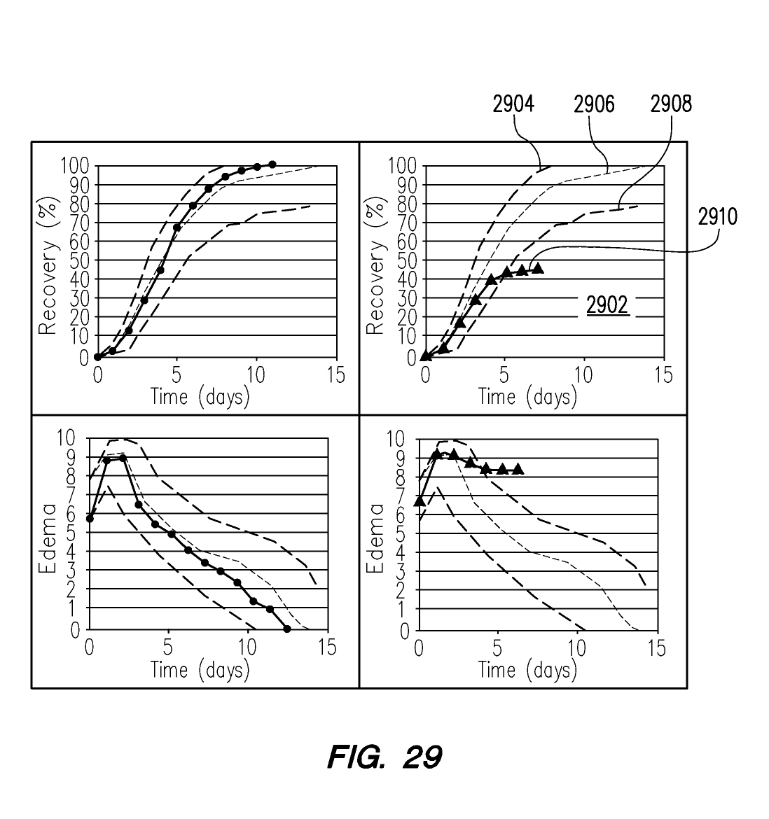

FIG. 32 illustrates an example acute Loop message that may be automatically communicated from or on behalf of a manager to a user. In the embodiment of FIG. 32, an e-mail message presents a question from the manager to the user and comprises a plurality of hyperlinks that the user may select to trigger responses. In an embodiment, selecting a hyperlink from within the body of a message causes a browser library of the user's computer to send a network request to the application logic; the network request encodes identifying information for the user and specifies the user's response, to enable the application logic to update the user's condition as reflected in the database.

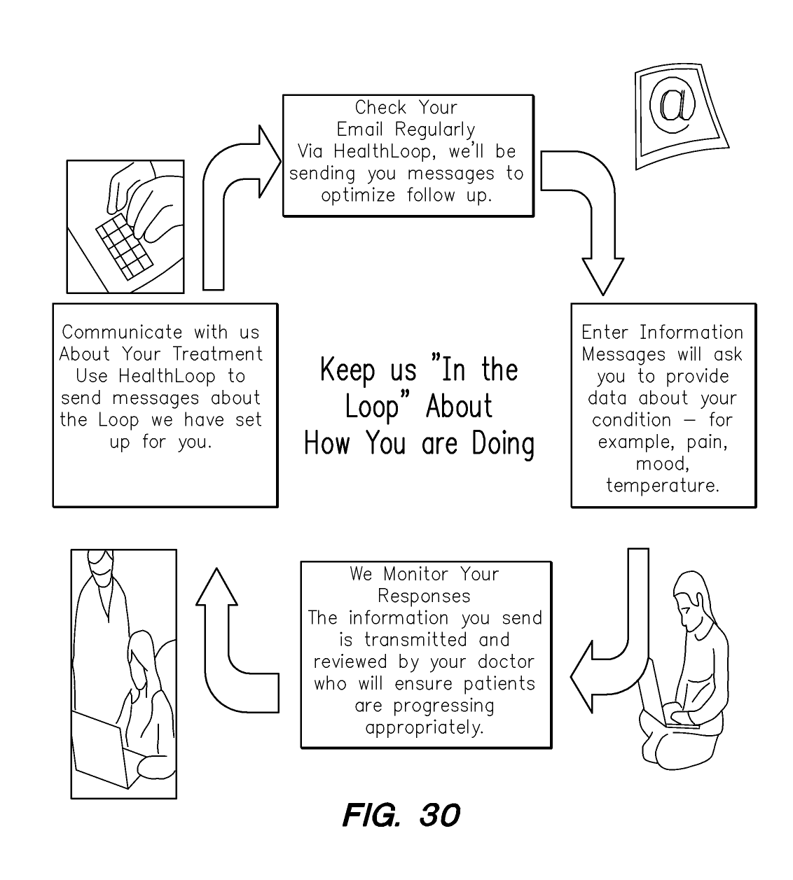

FIG. 33 illustrates an example chronic Loop message that may be automatically communicated from or on behalf of a manager to a user. In the embodiment of FIG. 33, an e-mail message presents a request for the user to provide a numeric value for a particular tracked metric. The e-mail message may comprise a GUI widget with which the value may be entered, and may further comprise a hyperlink to cause sending a response message to the initiating healthcare provider. In some embodiments, the e-mail message may include logic or encoding that enables a third-party, conventional e-mail client to initiate a response message that contains the requested numeric value. Alternatively, the message of FIG. 33 may be presented in a GUI generated and provided by a server computer, which the user accesses using a browser.

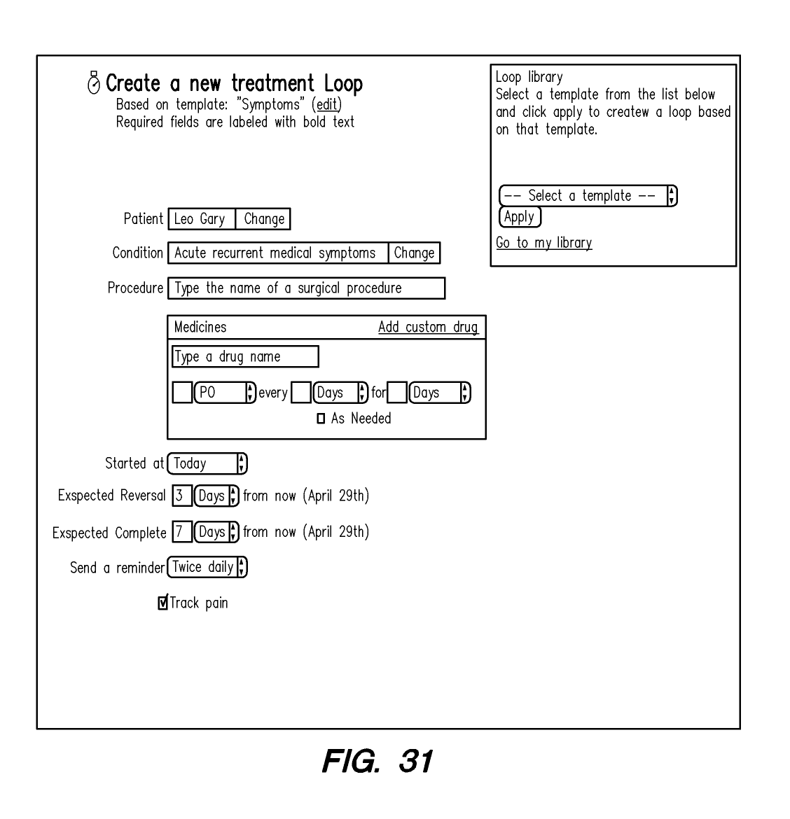

If a Trackable item (further described below) has been added to an acute Loop, then the content of an acute Loop message contains text that prompts the patient to select a hyperlink to enter a response to another questions or to provide a numeric value for a tracked metric. FIG. 34 illustrates an example online update request page that may be generated in response to a user selecting a hyperlink prompting a response to a trackable item. The online update request may be viewed or presented in a browser and obtained from a server computer that is hosting the application logic. In an embodiment, the update request prompts the user to select a description that most closely matches the user's condition(s) or symptom(s) at the time of reading the page. In an embodiment, the update request encapsulates a GUI widget, or contains a link to cause a browser to display an inquiry page that contains the GUI widget. In an embodiment, the GUI widget comprises a pull-down menu of selection options that indicate symptoms that are tracked. In an embodiment, the page includes a text entry box that can receive user input indicating other information about a condition or symptom. In an embodiment, the text entry box accepts up to 140 characters and Short Message System (SMS) text messaging techniques may be used to communicate messages. In an embodiment, the page further comprises a file uploading link which, when selected, causes executing a file open or browse dialog with which the user may select a file to transfer to a server computer that hosts the application logic.

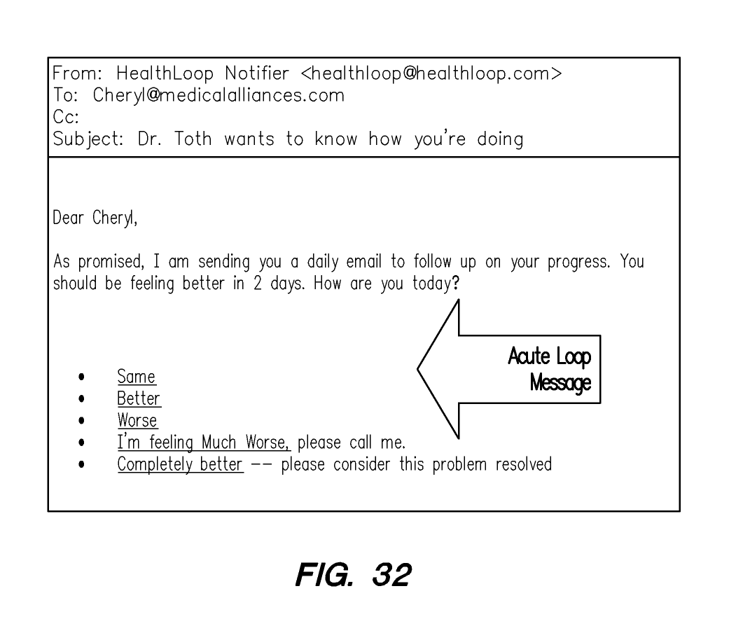

FIG. 35 illustrates an example healthcare provider's view of summary information for a plurality of open Loops pertaining to one or more users or patients. In an embodiment, the view of FIG. 35 is generated by the application logic and provided to a browser of a healthcare provider or other manager and shows data and displays for patients or users managed by that manager. In an embodiment, the view of FIG. 35 comprises function links titled All, Expired, None, which when selected cause generating and displaying an updated display of data and displays only for all managed users, or for expired Loops, or for which no responses have been received, or based on other filtering criteria.

In an embodiment, the view of FIG. 35 is organized generally as a table of rows having columns titled Status, Patient, Messages, Responses, Progress, Complete, Trackables, and Loop Type. In an embodiment, the Status column comprises a graphical icon that represents a particular status level; in some embodiments, the graphical icon may be displayed using a different form or color depending on a particular status level of a particular associated patient. For example, a status icon may be formed as a stylized human face having a smile, frown, or other expression associated with a status level. Different colors may indicate different status levels; for example, green, yellow, red may indicate successively worse status.

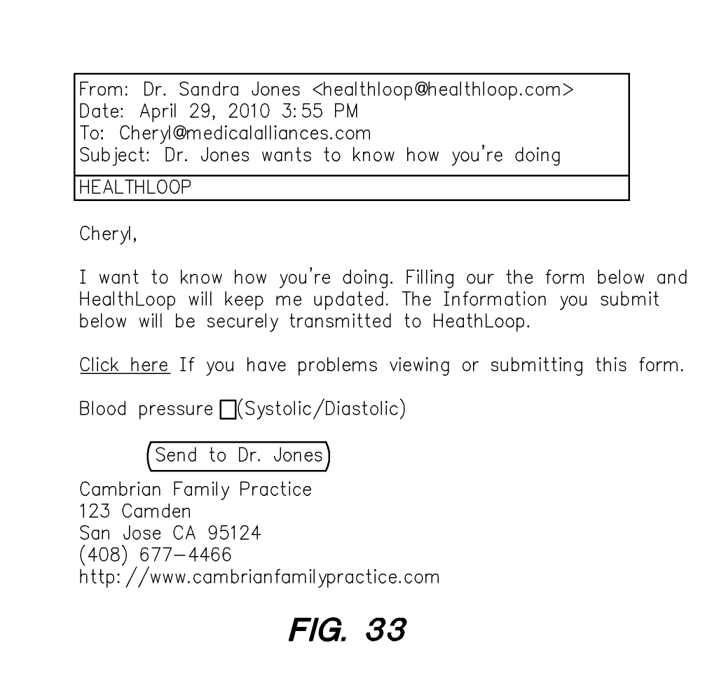

For example, FIG. 36 illustrates a table of example graphical icons, color codes, associated loop types, associated meaning, associated indications of progress graphs, and suggested actions that may be used in an embodiment. In an embodiment, red, yellow, and green faces can appear for Acute Loops only, and provide visual cues that indicate whether the patient is doing “Better,” “Worse,” “Same,” “Much Worse,” or “Completely Better” based on his responses to the Notification Emails. Red, yellow, and green faces do not indicate IF a patient is responding to Notification Emails—they indicate HOW a patient is responding (“Better,” “Worse,” etc.). In an embodiment, Grey indicates Non-Compliance/Lack of Engagement. Grey faces can appear for both Acute and Chronic Loops, and provide a visual cue for non-compliance. A grey face indicates a lack of patient engagement with the system. These patients may need additional instruction or motivation for using the system, may not be receiving the Notification Emails (they could be going into spam), or may be too busy to respond.

In an embodiment, the Patient column identifies a patient by name and also indicates the name of a Loop that is open for that patient. If a patient has multiple associated Loops, then the display of FIG. 35 may include a separate, different row for each patient-Loop association. In an embodiment, the Patient name and Loop name each may comprise a hyperlink which, when selected, causes the application logic to display detailed information about the selected patient or Loop.

In an embodiment, the Messages column indicates a number of messages that the manager has sent to the user indicated in a corresponding row, and may also comprises a pull-down menu widget by which the manager may select one of a plurality of pre-defined messages to send to the corresponding user. A benefit of this arrangement is that a busy manager may select and send messages to patients directly from within the summary display or dashboard, without exiting to a separate screen or using a complex messaging interface. In an embodiment, message text for each outbound message and received response may be stored in association with a Loop for a particular user, creating comprehensive documentation.

In an embodiment, the Responses column indicates the number of responses that have been received from the corresponding user in response to messages from the manager. For example, a value of “0/9” for Responses indicates that the user has sent no responses in response to nine outbound messages from the manager.

In an embodiment, the Progress column comprises a graph, line, or icon that indicates a relative trend of the user's progress based on qualitative information in prior responses. For example, a Progress graph may indicate a downward trend in patient condition, a flat condition for relatively little change in patient condition over time, or an upward trend. In an embodiment, the Complete column indicates, for an associated user, a percentage representing the amount of time for a particular Loop that has expired or has been completed. For example, if a particular Loop has a duration of ten (10) days and started four (4) days ago, then the Complete value would be 40%.

In an embodiment, the Loop Type column indicates, through a graphical icon, whether the particular Loop is for an acute condition or a chronic condition.

In an embodiment, the Trackables column comprises one or more graphs that indicate values of tracked metrics for the corresponding user such as temperature, pain, mood, shortness of breath, blood pressure, etc. A tracked metric typically is a clinical data point, which can be added to a Loop and tracked. Each graph in the Trackables column may reflect data stored in the database based on values received in patient responses.

In an embodiment, Trackables are clinical data elements that can be optionally added to a New Treatment loop. Adding Trackables to a New Treatment allows a Doctor to monitor symptoms and overall clinical improvement by asking a patient to self-report specific data about their condition. Examples of common Trackables are: pain, temperature, blood pressure, weight, appetite, mood, and swelling.

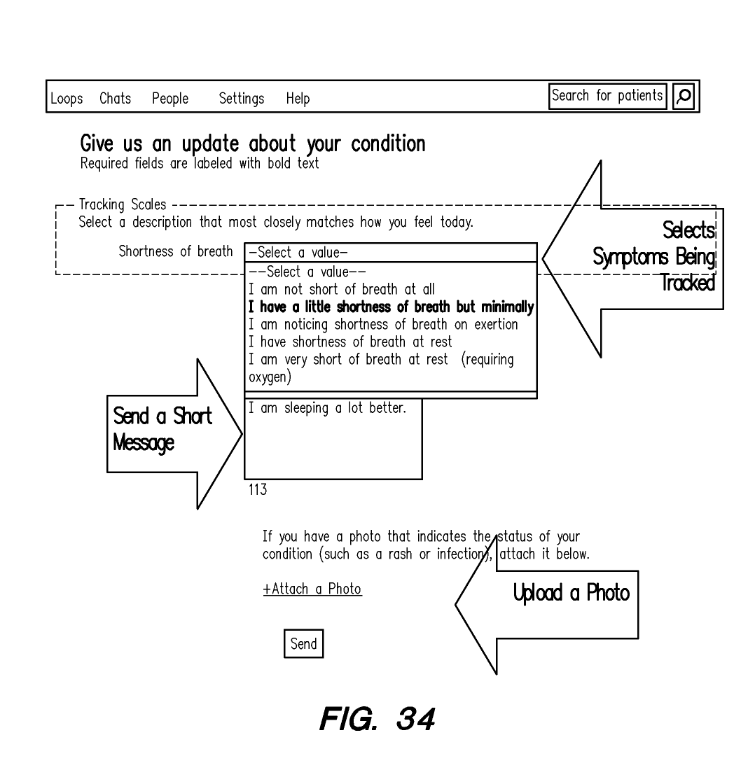

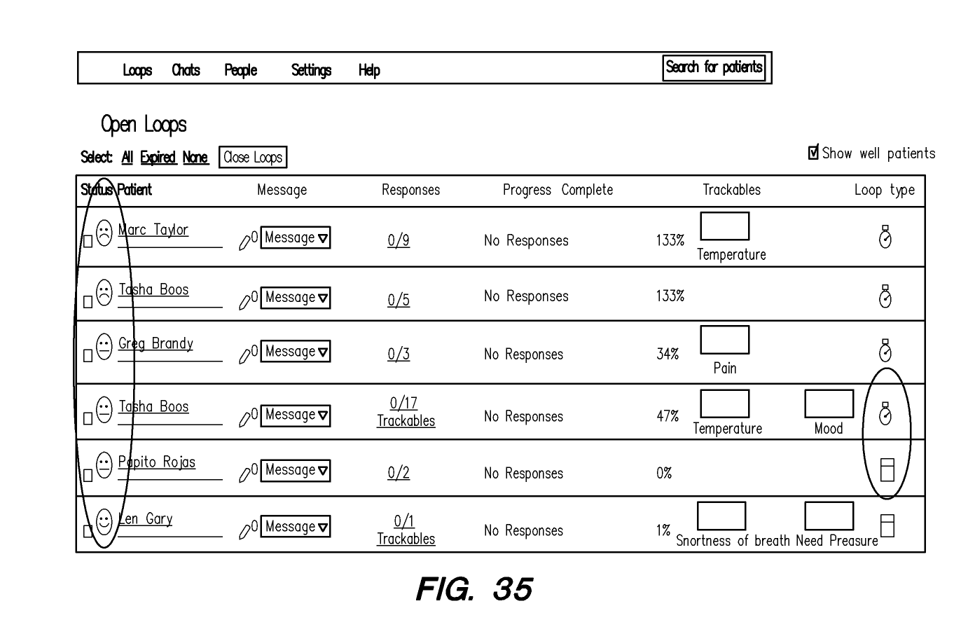

FIG. 37 illustrates adding a Trackable to a Treatment. In general, FIG. 37 has the form of FIG. 31 and operates as previously described for FIG. 31. As indicated at 3701, the Treatment of FIG. 37 is for a particular Patient and Condition. FIG. 38 comprises a pull-down menu 3702 that is accessible from a GUI widget titled Track. The menu 3702 lists a plurality of predefined Trackables. Selecting an item from the menu 3702 and selecting an Add button 3704 causes storing an instance of the selected Trackable with the current Treatment. Additional Trackables can be added to the same Treatment by selecting a link 3706 titled Create a new trackable. A particular Treatment may have any number of Trackables.

In an embodiment, Trackables are specific to a Doctor. Doctors (and the Staff who create Treatments on behalf of Doctors) have the option of selecting Trackables from a list of preset Global Trackables that are included in each Doctor's account. Doctors can also define Custom Trackables to monitor symptoms and clinical indicators relevant to their specialty and patients.

In an embodiment, Trackables are optional additions to a Treatment loop. They are also optional for patients to respond to. In an embodiment, there are two types of Trackables—Numeric and Relative. Numeric Trackables allow tracking something with a numeric value. For example, patients with flu can be requested to enter their temperature each day, or patients with hypertension can be prompted to enter daily systolic and diastolic readings. Relative Trackables allow tracking something on a multi-point scale. For example, patients undergoing chemotherapy can rate their appetite, anxiety level, or sleep patterns.

FIG. 38 illustrates a graphical user interface that the application logic may implement to enable creating a custom Numeric Trackable. In an embodiment, creating a custom Numeric Trackable using the interface of FIG. 38 comprises: entering a name for the Trackable; selecting the radio button next to “Create a numeric Trackable”; entering an absolute range; entering a healthy range; entering the type of units that will be tracked—for example beats per minute, pounds, percent, or selecting “Define a new Unit” to create a new unit type; selecting the Create button.

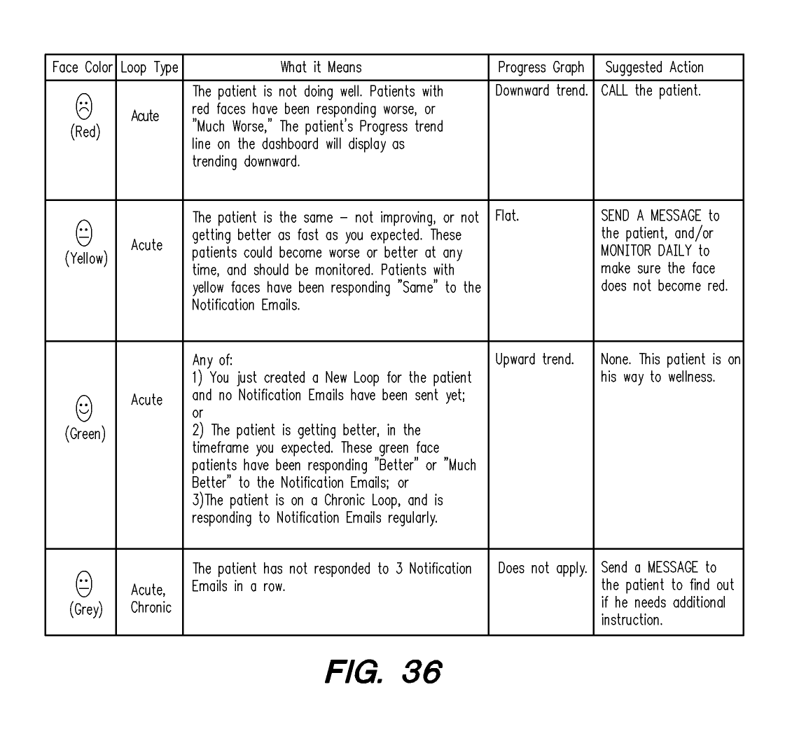

FIG. 39 illustrates a graphical user interface that the application logic may generate to enable creating a custom Relative Trackable. In an embodiment, creating a custom Relative Trackable using the interface of FIG. 39 comprises: entering a name for the Trackable; selecting the radio button next to “Create a relative Trackable”; entering the descriptive options, from worst to best; selecting a Create button. In an embodiment, Patients provide their responses to Relative Trackables by moving a Response Lever displaying a descriptive response to each of the points. The Response Lever also provides a visual cue that indicates “worst” and “best.”

Trackables store valuable, self-reported patient feedback that few physicians have access to in today's healthcare environment. HealthLoop then uses this data to create graphs that track clinical data over time, for physicians to use in clinical decision-making and care management. This data is maintained within HealthLoop as part of the patient's Treatment loop, even after the loop has been closed. The graphs can be printed at any time during the Treatment loop timeline, as well as after the Treatment loop has expired or been closed.

In an embodiment, when a patient clicks on a link in a Notifier email, the patient is redirected to a response page and prompted to enter the Numeric and/or Relative Trackables that the physician has associated with the Loop or treatment. Based on patient responses, the application logic creates a line graph of the Trackables data; the graph is accessible from within the Loop with which the Trackable is associated, and is stored and printable after the Loop has expired or has closed.

The embodiment described in this section provides numerous benefits over prior practice. It may improve compliance and success with pre-procedure preparation. It may improve follow up efficiency through automated, post-procedure monitoring and symptom management. It may optimize patient healing by connecting health care providers with patients in real-time to monitor progress and improve patient compliance. It may reduce potentially adverse outcomes through early notification, enabling early intervention. It may decrease unnecessary post-procedure, emergency room, and hospital admissions, which could lead to thousands of dollars in savings to patients and the healthcare system. It may build patient loyalty and retention by offering automated follow up and secure messaging.

Embodiments also enable connections of managers and users, such as physicians and patients, to compile patient-provided data in between appointments or in post-operative, post-treatment phases during which follow up is typically difficult. Data may be delivered to a manager in nearly real time, through an online dashboard or summary display that can be used to organize or sort patients by condition, graph progress, and engage patients in self-care. Thus, embodiments can improve the effectiveness of patient follow up with patients who have acute illness, chronic conditions, or who are in post-op care; embodiments also can increase access by connecting patients with a medical practice electronically without regard to office hours. Embodiments may also increase compliance with treatment plans. Practitioners can use embodiments, to monitor acute conditions to know whether patients are improving or worsening, track patients with chronic conditions to verify management of disease, manage symptoms and side effects, and help with pre- and post-operative care.

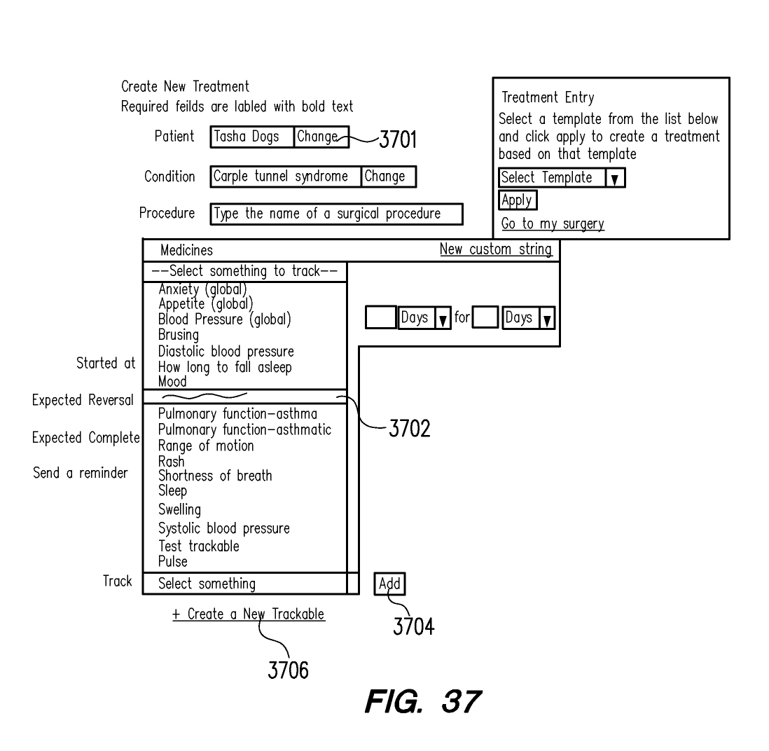

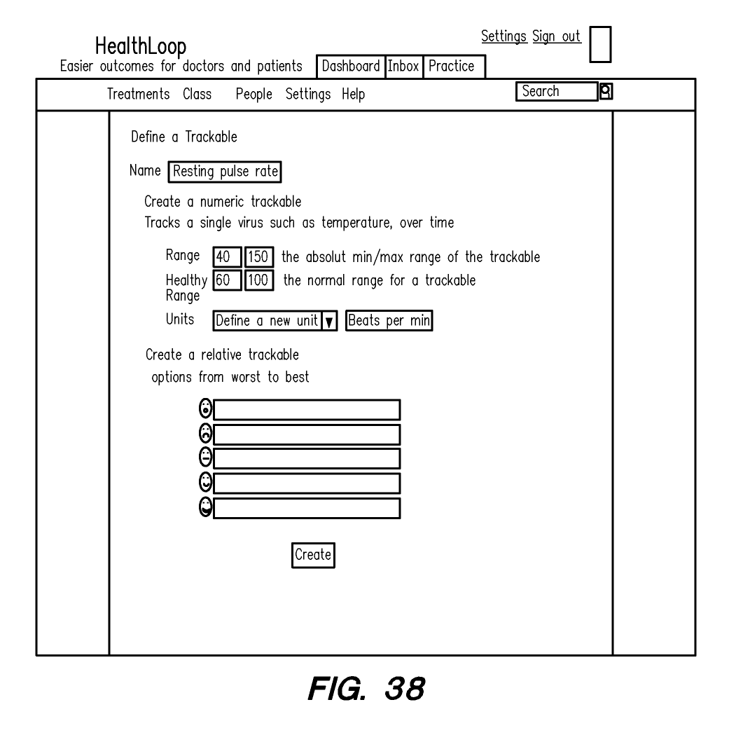

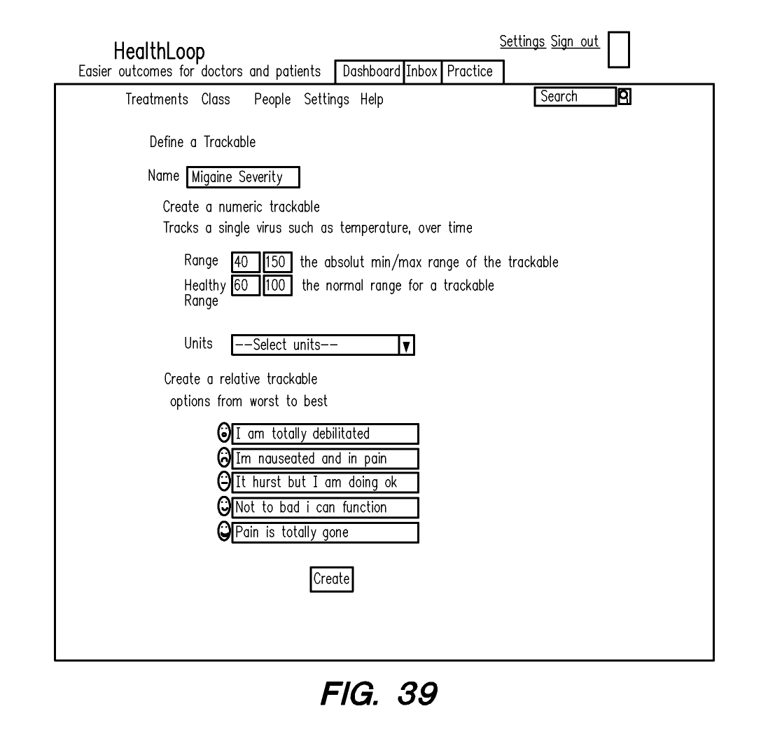

FIG. 40 illustrates an example screen display for a computer graphical user interface for a provider showing entering a new Loop. In an embodiment, checkboxes 4002 enable a user to specify one or more pre-defined or specified users as members of a caregiving team for a patient with whom the Loop is associated. In an embodiment, the same kind of checkboxes may be used when a new patient is added to the system, as in FIG. 4, for specifying care team members for a particular patient. In response to selecting a Choose Loop Template button 206, a pop-up menu may be displayed (FIG. 43) from which the user may select a particular Loop Template. In response, a primary diagnosis 4004, comorbidities, procedures, and loop name are automatically loaded from the loop repository and populated into associated fields. Alternatively, values for primary diagnosis 4004, comorbidities, procedures, and loop name may be entered manually. With either alternative, selecting a Save & Schedule Components button 4006 enables setting scheduling information and related data for particular components of a Loop, as further seen in FIG. 41.

FIG. 41 illustrates an example screen display for a computer graphical user interface for a provider showing entering a new Loop. View (1) illustrates a pop-up menu configured to accept procedure settings for the Loop such as date of procedure, type of procedure, and expected duration. View (2) illustrates a summary of a Loop using the values received through the interface of FIG. 40 and FIG. 41 view (1). A summary area 4104 displays name, patient and date information. A Components table 4106 illustrates each component of the Loop, such as zero or more of each of Reminders, Confirmations, Procedures, Medications, Trackers, Care Instructions.

In an embodiment Confirmations comprise Loop components associated with automatically sending messages to patients or caregivers to confirm that certain actions will be taken or that persons will appear for associated procedures. A confirmation area 4108 is configured to receive data for confirmation messages to be sent to a patient or care team prior to an associated procedure and indicating a type of confirmation and values for frequency, end date and/or duration. Consequently, the interface of FIG. 41, view (2) and corresponding functional logic provides complete flexibility in specifying when to send confirmation messages for any of the components in the Loop.

FIG. 42 illustrates an example screen display for a computer graphical user interface for a provider showing entering a new caregiver. View (1) illustrates an example patient information view 4202 that includes patient information 4204, a table 4206 of caregivers, and a table 4208 of Loops associated with the patient. In response to selecting a New Caregiver button 4210, the application logic causes displaying view (2), which is configured to accept data in a plurality of structured fields defining a particular caregiver including relationship to the patient, name, and contact information. Selecting a Save button 4212 causes storing the specified values in the data repository and updating table 4206 of view (1).

FIG. 43 illustrates an example screen display menu configured to receive a search or selection of a Loop Template. In an embodiment, menu 4302 comprises a search box 4304 that is configured to execute a search for a stored Loop Template based upon a name, diagnosis, procedure, code or keyword. Matching stored Loop Templates from the data repository are displayed in a list 4306 and include a template name, author, and Use Template button 4308. In response to selecting the Use Template button 4308, control returns to the loop entry view (FIG. 40) and values from the Loop Template are populated into the view for a current Loop.

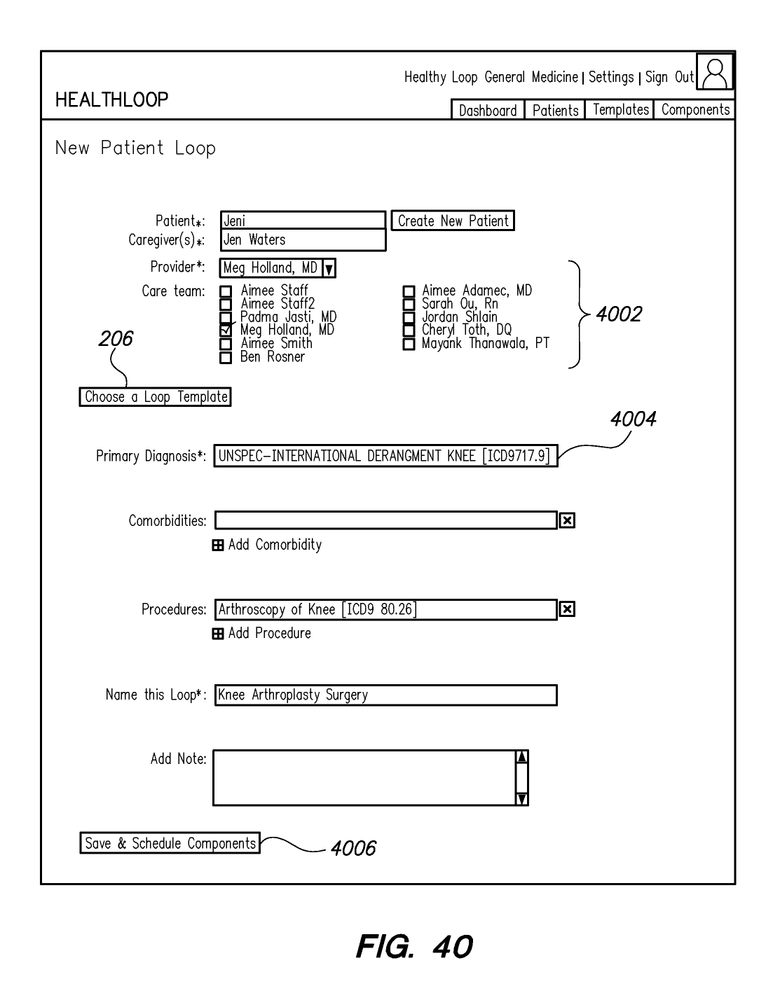

FIG. 44 illustrates an example partial screen display for a computer graphical user interface for adding a Tracker. As with FIG. 7, FIG. 44 is configured to receive a choice of a Tracker at 702 and a start date with a specified frequency. A duration widget 4402 is configured to accept a value and period to indicate a duration in days, weeks or other periods during which tracking should occur. An importance value at widget 4404 may be received via a pull-down menu.

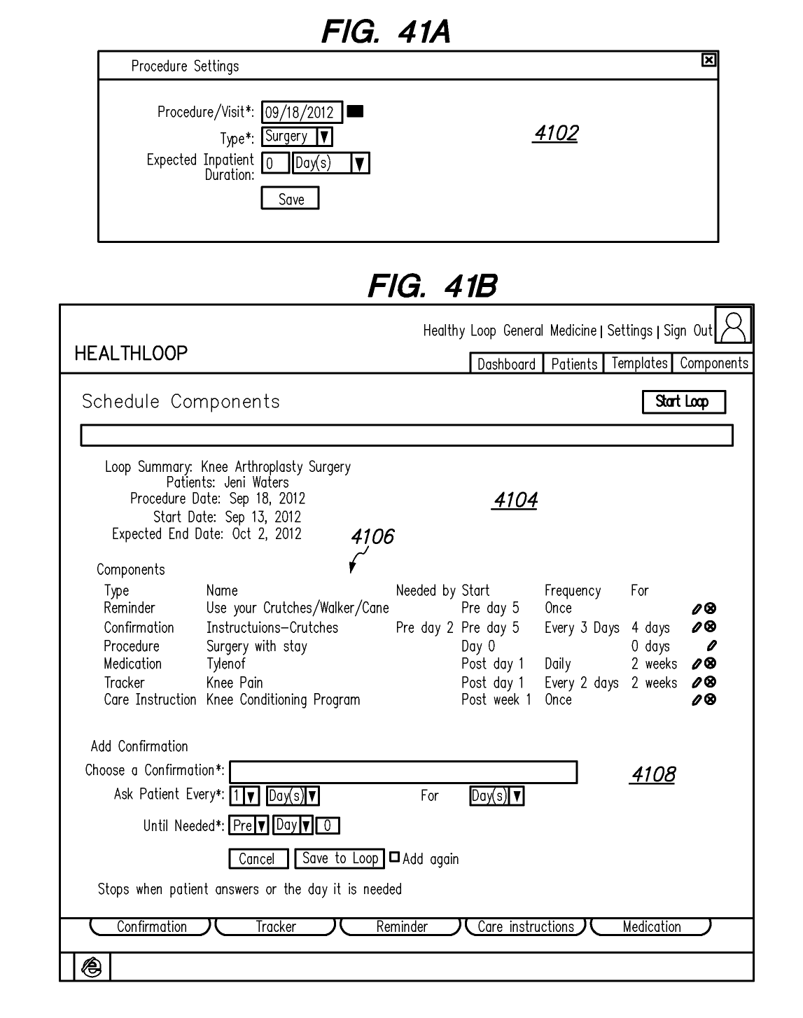

FIG. 45 illustrates an example partial screen display menu configured to receive configuration data for a Reminder component of a particular Loop. In an embodiment, similar to FIG. 8, a Reminder area 4502 is configured to receive a selection of a Reminder from a pull-down menu 4504. GUI widgets 4506 are configured to receive a day to send the specified reminder either after (Post) or before (Pre) a particular ordinal day with respect to an associated component in the Loop. In response to selecting the Save to Loop button 4508 the values are stored in the repository and the application logic automatically sends reminder messages to the patient and/or caregiver team at the time indicated by the day-to-send information. In various embodiments, FIG. 9, FIG. 10 may be configured with similar day-to-send GUI widgets and related application logic to associate the start date of a medication and the day to send Care Instructions (or Patient Material) relative to the day of a specified component of a Loop.

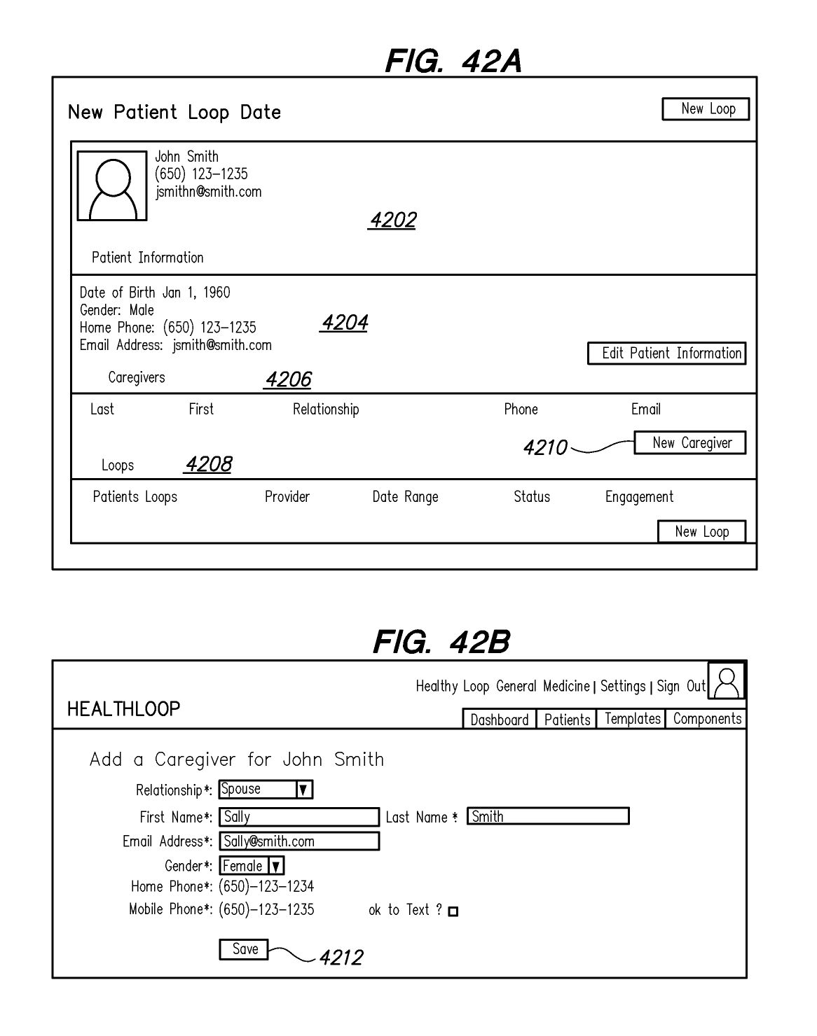

FIG. 46 illustrates an example partial screen display showing a Tracker graph. FIG. 46 may be considered an alternative of a portion of FIG. 12. A Tracker graph 4602 comprises a line 4604 graphed against axes 4606, 4608 that are associated with allowed responses to a question for a tracked metric, and time, respectively. A comment field 1206 is configured to receive and cause storing a comment about the graph; in response to selecting a Post button 4610, the application logic causes adding a post to the Loop feed based on the comment field.

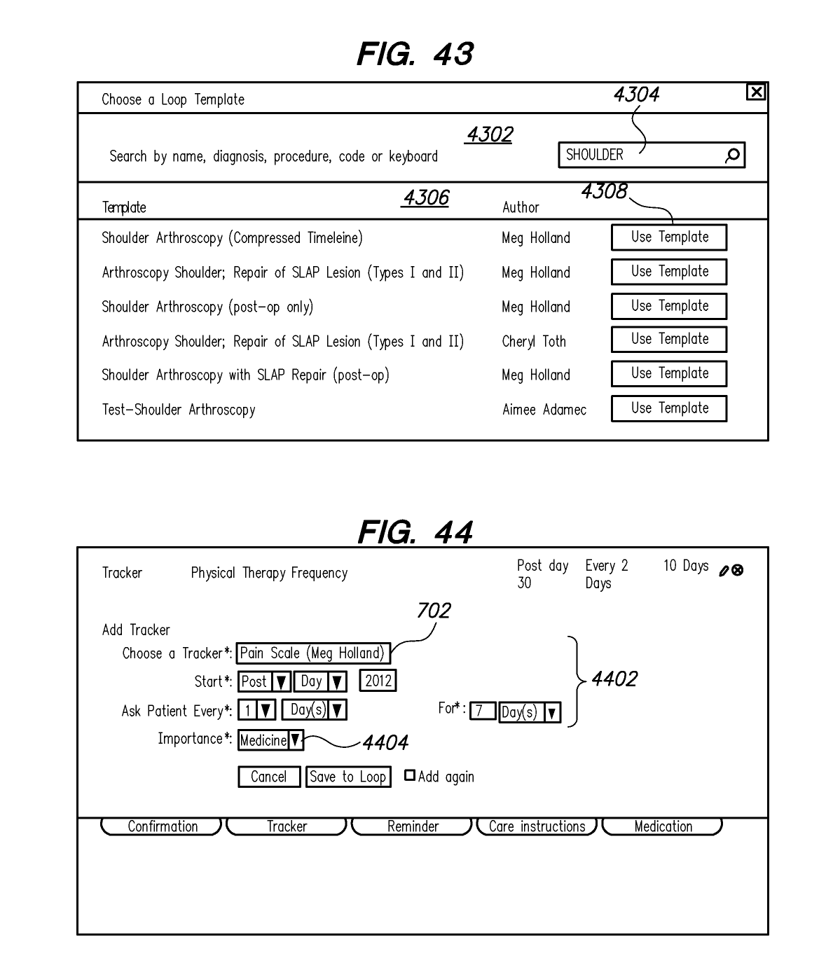

FIG. 47 illustrates an example partial screen display showing a set of Confirmations for a particular Loop. In an embodiment, Confirmations configured for the Loop are listed in date order according to a Need By date column 4702; each Confirmation specifies a question 4704, response 4706 as received in the system, person who provided the response at 4708, and note. Editing links 4710 are configured to enable editing the Confirmations if selected. In this manner a manager or caregiver can rapidly review all Confirmations that have been configured for a Loop to determine if they are complete or correct and to see the status of the responses of a patient or caregiver.

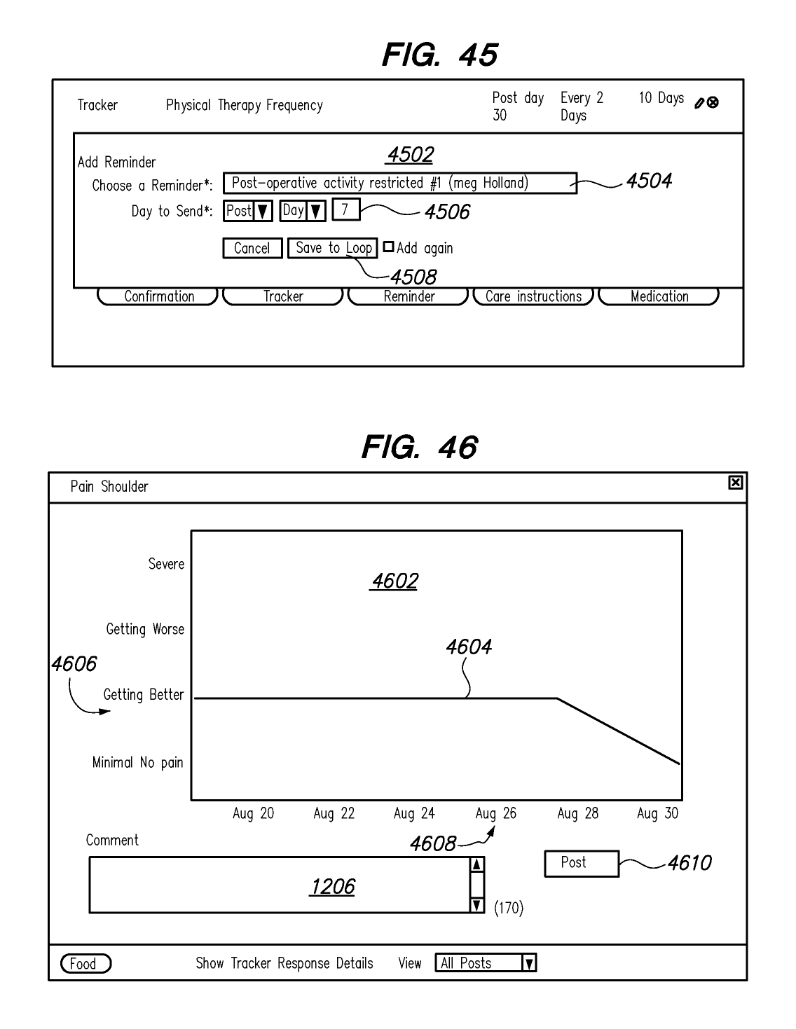

FIG. 48 illustrates an example partial screen display that may be generated for viewing Trackers as an alternative to FIG. 15. Each of the Trackers 1512 includes an indication of the time at which the Tracker was last updated. A sort widget 4802 is configured to cause sorting a display of the Trackers 1512 according to the selected value indicated in the widget.

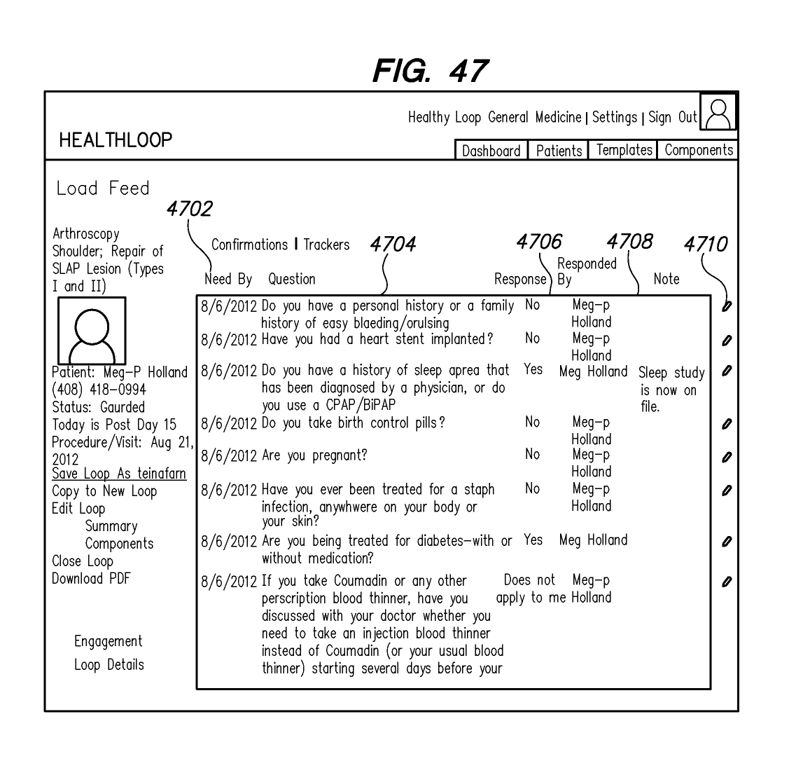

FIG. 49 illustrates an example partial screen display that may be generated for creating new Trackers as an alternative to FIG. 16. The elements shown in FIG. 49 may be configured for display and functional operation in the same manner described above for like numbered elements of FIG. 16.

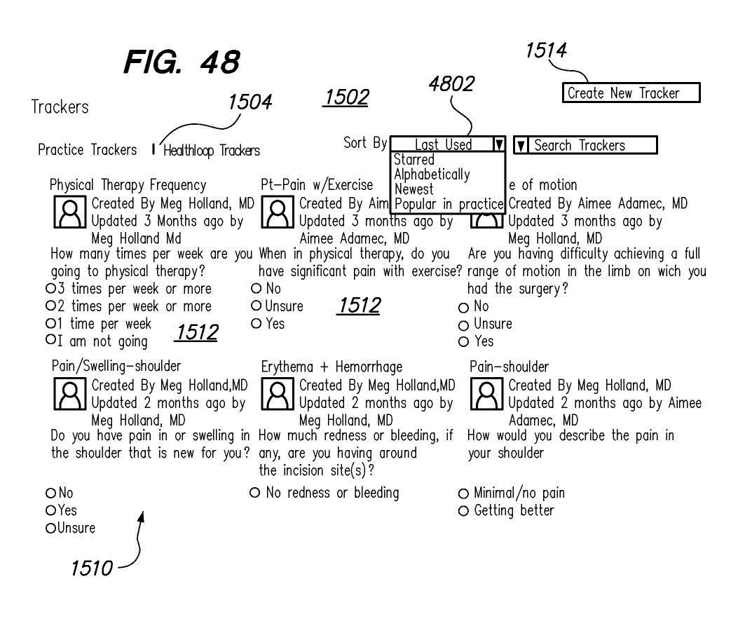

FIG. 50 illustrates an example partial screen display configured to receive data for defining a new Tracker with numeric response values, as an alternative to FIG. 18. In an embodiment, numeric response values 5002 are denoted as High Critical, High Guarded, Low Guarded, and Low Critical. Each value may be associated with alert thresholds for the purpose of automatically generating alert messages.

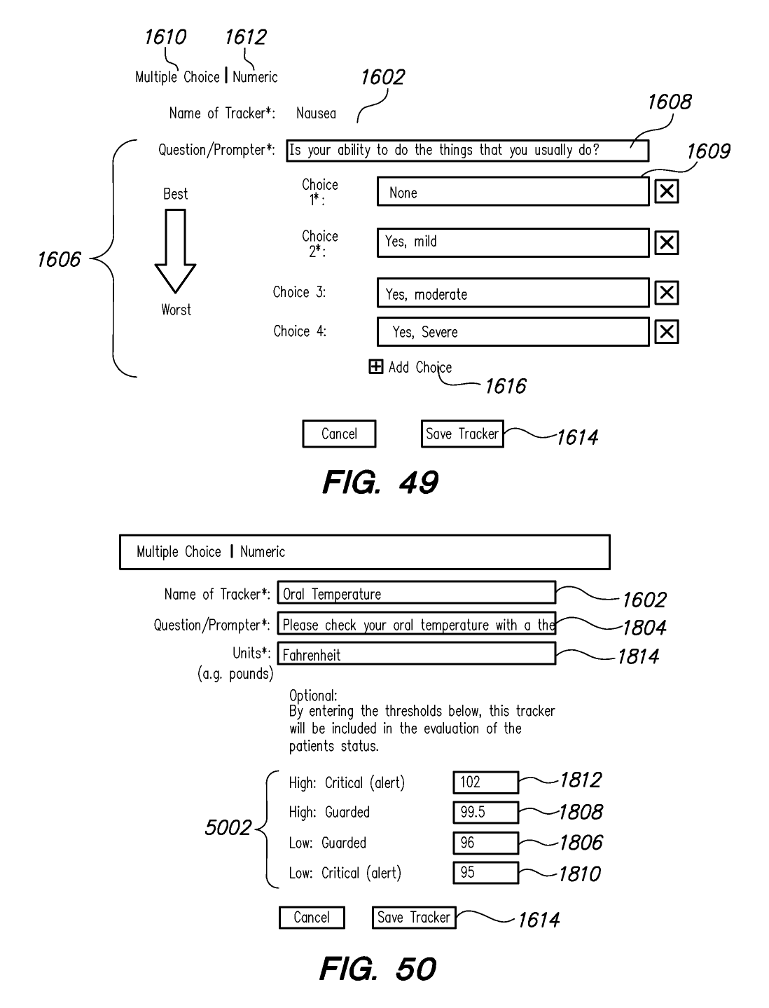

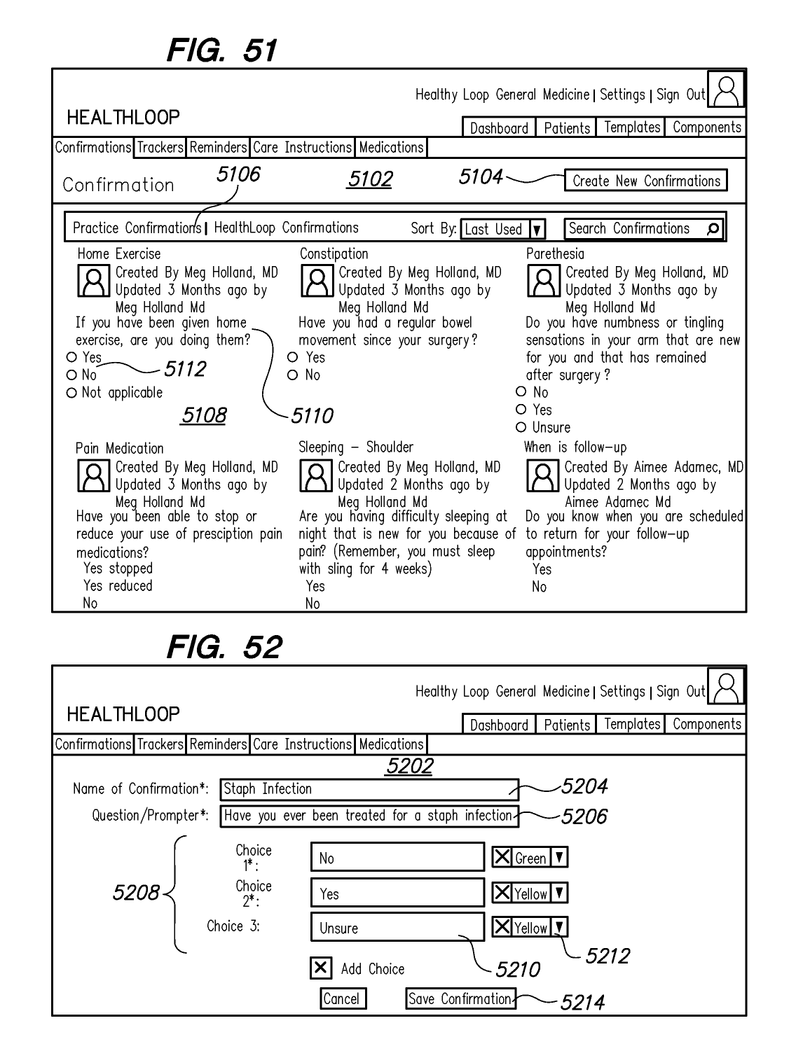

FIG. 51 illustrates an example screen display for displaying Confirmations that have been configured in the system. In an embodiment, display 5102 comprises a Create New Confirmation button 5104 which when selected causes displaying the display of FIG. 52 for creating or editing a Confirmation. Existing Confirmations 5108 are shown in display 5102 and may be organized by selecting one of links 5106 to filter by practice-specific Confirmations or system-wide Confirmations. Each of the Confirmations 5108 has a question 5110 and two or more associated answers 5112 which may be displayed using different colored shading.

FIG. 52 illustrates an example screen display for receiving data to define a new Confirmation. In an embodiment, display 5202 comprises data entry fields and GUI widgets for a particular Confirmation. A name field 5204 is configured to receive a text name of a Confirmation. A question field 5206 is configured to receive a question. Two or more question widgets 5208 are configured to receive choices for responding to the question 5206; each choice 5210 may be associated with a particular color shading or other emphasis by selecting a pull-down widget 5212. A Save Confirmation button 5214 causes the application logic to save the Confirmation data in the data repository use in configuring particular Confirmations in particular Loops at other times.

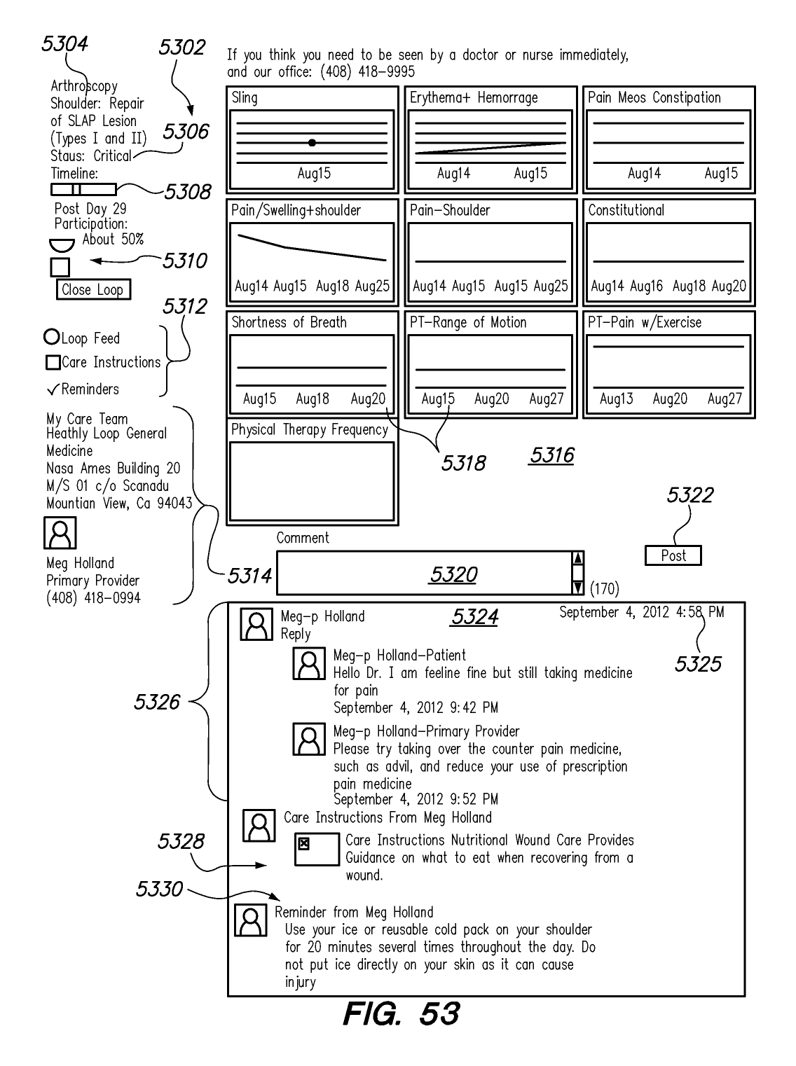

FIG. 53 illustrates an example screen display for a patient Loop display with Trackers and a Loop feed. In an embodiment, patient display 5302 comprises a Loop name or title 5304 and indicates a status value 5306. A timeline graphic 5308 indicates a relative time elapsed since a particular procedure or visit associated with the patient. A participation graphic 5310 indicates a level of participation of the patient in interacting with the system in response to Trackers or posts in the Loop feed.

In an embodiment, graphical links 5312 are configured to enable selecting a Loop Feed display, Care Instructions display, or Reminders display. In the example of FIG. 53, one of the links 5312 for the Loop Feed has been selected and the display 5302 reflects that selection; selecting others of the links causes generating displays of different forms as described elsewhere herein (for example, FIG. 47, FIG. 48). A care team summary area 5314 displays contact information for caregivers of the patient, such as a primary care provider.

In an embodiment, a graph region 5316 displays one or more Trackers 5318 in graph form so that the patient can obtain a snapshot of progress against various tracked metrics that have been configured in the Loop by a manager such as the provider. A Comment area 5320 is configured to receive text comments. In response to selecting a Post link 5322, the contents of the Comment area 5320 is stored in the data repository and added to the Loop Feed 5324.

In an embodiment, Loop Feed 5324 comprises a reverse chronological list of near real time postings from parties involved with the patient, such as care providers, caregivers, and the patient. Posts are marked with a date-time value 5325. In an embodiment, a plurality of posts may be organized hierarchically, with replies associated with a particular post shown using indentation below the related post, as seen for a group 5326 of related posts. Posts also may comprise Care Instructions 5328 that the provider has created or saved, Reminders such as post 5330, or other messages that result from other kinds of components of a Loop. Consequently, the display of FIG. 53 provides a consolidated, efficient, and comprehensive view of data, trends, and commentary on a patient's care at preparatory or follow-up stages of care, including any of pre-operative, pre-visit, post-operative, post-visit, or other stages of care. The display of FIG. 53 enables the patient or caregivers to rapidly understand recent or long-term trends with respect to the patient's care across a variety of metrics and enables posting and reviewing comments, questions, replies and related care information in close association with graphical representations of key care metrics.

### 4.0 Implementations Independent of Providers, in Health Fields Other than Human Care, and in Fields Other than Healthcare

For purposes of illustrating clear examples, certain embodiments have been described herein in the context of healthcare, but the particular healthcare embodiments described herein comprise particular implementations of a more generalized follow-up or pre-visit system that is applicable to many other fields or contexts. Thus, in various embodiments, aspects of the messaging, alerting, tracking, and other functions described herein, and aspects of the screen displays that have been specifically described in the context of healthcare, may be implemented in fields or contexts other than healthcare.

For example, one alternative embodiment is in the field of travel and enables a user to create Loops, Trackers and Reminders relating to travel plans.

In an embodiment, Loops, Trackers and Reminders are implemented for purposes of financial planning.

In an embodiment, Loops, Trackers and Reminders are implemented in the field of customer relationship management for products or services in retail, wholesale or other businesses that have customers or clients.

The embodiments described herein in the context of human healthcare provide the benefit of a browser-based, online application with network storage that is connected to a healthcare provider such as a doctor. In an embodiment, Loops and Trackers may be implemented for healthcare conditions without the involvement of a physician or healthcare provider. For example, an individual may be aware that he or she is susceptible to depression or other conditions and may wish to set up a Loop for the purpose of tracking signs and symptoms on a personal basis without the involvement of a healthcare provider. The implementation of a Loop may enable the individual to examine current signs, symptoms or other conditions in a historical comparison of past signs, symptoms, and other conditions.

In an embodiment, Loops and Trackers are implemented in the context of healthcare for animal subjects. For example, Loops may be defined for various kinds of veterinary procedures that are appropriate for follow-up or pre-visit including surgeries, diseases, and other conditions. Loops in the veterinary field may involve a veterinarian or may be implemented by animal owners without the involvement of the veterinarian.

### 5.0 Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

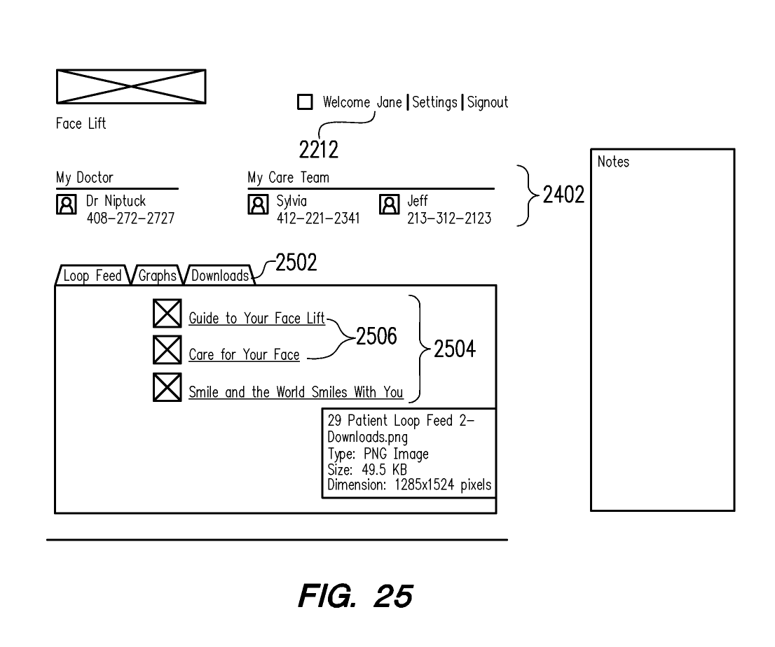

For example, FIG. 28 is a block diagram that illustrates a computer system 2800 upon which an embodiment of the invention may be implemented. Computer system 2800 includes a bus 2802 or other communication mechanism for communicating information, and a hardware processor 2804 coupled with bus 2802 for processing information. Hardware processor 2804 may be, for example, a general purpose microprocessor.

Computer system 2800 also includes a main memory 2806, such as a random access memory (RAM) or other dynamic storage device, coupled to bus 2802 for storing information and instructions to be executed by processor 2804. Main memory 2806 also may be used for storing temporary variables or other intermediate information during execution of instructions to be executed by processor 2804. Such instructions, when stored in non-transitory storage media accessible to processor 2804, render computer system 2800 into a special-purpose machine that is customized to perform the operations specified in the instructions.

Computer system 2800 further includes a read only memory (ROM) 2808 or other static storage device coupled to bus 2802 for storing static information and instructions for processor 2804. A storage device 2810, such as a magnetic disk or optical disk, is provided and coupled to bus 2802 for storing information and instructions.

Computer system 2800 may be coupled via bus 2802 to a display 2812, such as a cathode ray tube (CRT), a liquid crystal display (LCD), a plasma display, thin film transistor (TFT) display, a TFT touch screen display or other display type, for displaying information to a user. An input device 2814, including alphanumeric and other keys, is coupled to bus 2802 for communicating information and command selections to processor 2804. Another type of user input device is cursor control 2816, such as a mouse, a trackball, or cursor direction keys for communicating direction information and command selections to processor 2804 and for controlling cursor movement on display 2812. This input device typically has two degrees of freedom in two axes, a first axis (e.g., x) and a second axis (e.g., y), that allows the device to specify positions in a plane.

Computer system 2800 may implement the techniques described herein using customized hard-wired logic, one or more ASICs or FPGAs, firmware and/or program logic which in combination with the computer system causes or programs computer system 2800 to be a special-purpose machine. According to one embodiment, the techniques herein are performed by computer system 2800 in response to processor 2804 executing one or more sequences of one or more instructions contained in main memory 2806. Such instructions may be read into main memory 2806 from another storage medium, such as storage device 2810. Execution of the sequences of instructions contained in main memory 2806 causes processor 2804 to perform the process steps described herein. In alternative embodiments, hard-wired circuitry may be used in place of or in combination with software instructions.

The term “storage media” as used herein refers to any non-transitory media that store data and/or instructions that cause a machine to operation in a specific fashion. Such storage media may comprise non-volatile media and/or volatile media. Non-volatile media includes, for example, optical or magnetic disks, such as storage device 2810. Volatile media includes dynamic memory, such as main memory 2806. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, and networked mass storage devices including but not limited to cloud storage.

Storage media is distinct from but may be used in conjunction with transmission media. Transmission media participates in transferring information between storage media. For example, transmission media includes coaxial cables, copper wire and fiber optics, including the wires that comprise bus 2802. Transmission media can also take the form of acoustic or light waves, such as those generated during radio-wave and infra-red data communications.

Various forms of media may be involved in carrying one or more sequences of one or more instructions to processor 2804 for execution. For example, the instructions may initially be carried on a magnetic disk or solid state drive of a remote computer. The remote computer can load the instructions into its dynamic memory and send the instructions over a telephone line using a modem. A modem local to computer system 2800 can receive the data on the telephone line and use an infra-red transmitter to convert the data to an infra-red signal. An infra-red detector can receive the data carried in the infra-red signal and appropriate circuitry can place the data on bus 2802. Bus 2802 carries the data to main memory 2806, from which processor 2804 retrieves and executes the instructions. The instructions received by main memory 2806 may optionally be stored on storage device 2810 either before or after execution by processor 2804.

Computer system 2800 also includes a communication interface 2818 coupled to bus 2802. Communication interface 2818 provides a two-way data communication coupling to a network link 2820 that is connected to a local network 2822. For example, communication interface 2818 may be an integrated services digital network (ISDN) card, cable modem, satellite modem, or a modem to provide a data communication connection to a corresponding type of telephone line. As another example, communication interface 2818 may be a local area network (LAN) card to provide a data communication connection to a compatible LAN. Wireless links may also be implemented. In any such implementation, communication interface 2818 sends and receives electrical, electromagnetic or optical signals that carry digital data streams representing various types of information.

Network link 2820 typically provides data communication through one or more networks to other data devices. For example, network link 2820 may provide a connection through local network 2822 to a host computer 2824 or to data equipment operated by an Internet Service Provider (ISP) 2826. ISP 2826 in turn provides data communication services through the world wide packet data communication network now commonly referred to as the “Internet” 2828. Local network 2822 and Internet 2828 both use electrical, electromagnetic or optical signals that carry digital data streams. The signals through the various networks and the signals on network link 2820 and through communication interface 2818, which carry the digital data to and from computer system 2800, are example forms of transmission media.

Computer system 2800 can send messages and receive data, including program code, through the network(s), network link 2820 and communication interface 2818. In the Internet example, a server 2830 might transmit a requested code for an application program through Internet 2828, ISP 2826, local network 2822 and communication interface 2818.

The received code may be executed by processor 2804 as it is received, and/or stored in storage device 2810, or other non-volatile storage for later execution.

### 6.0 Extensions and Improvements

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

### 7.0 Additional Disclosure

Aspects of the subject matter described herein are set out in the following numbered clauses:

1. A data processing method comprising:

receiving, from one or more users, during a period relating to a healthcare interaction between one or more managers and the one or more users, one or more structured healthcare data items representing objective conditions and subjective conditions of the one or more users;

facilitating an exchange, between the one or more managers and the one or more users, of the structured data items;

forming and causing a display, on a computer display unit, of one or more of the structured data items in comparison to comparative healthcare information based upon one or more electronic protocols that define communications and tracking of changes in specified healthcare conditions or procedures;

generating and sending, to one or more of the managers, one or more automated alerts about impending failures or worsening of one or more of the objective conditions or subjective conditions;

wherein the method is performed by one or more computing devices.

2. The method of clause 1 wherein the period is a follow-up period of care.

3. The method of clause 1 wherein each of the one or more electronic protocols define how to inform a patient during follow-up through automated reminders, emails, and other communications, and/or how to track a patient's signs, symptoms, objective measures, and/or condition after a diagnosis.

4. The method of clause 1 wherein the one or more managers are any of physicians, nurses, medical assistants, physician assistants, physical therapists, or other members of a healthcare team.

5. The method of clause 1 wherein the one or more users are patients or caregivers.

6. The method of clause 5 wherein the patients are animals.

7. The method of clause 1 wherein the one or more managers are affiliated with a seller of products or services and wherein the one or more users are customers or clients of the seller.

8. The method of clause 1, wherein the one or more managers are healthcare providers, the one or more users are patients of the healthcare providers, the interactions comprise healthcare interventions, the structured data items represent objective health signs and subjective symptoms of the one or more patients during a period of care by the healthcare providers;

wherein the comparative healthcare information comprises one or more ARC OF RECOVERY profiles for the signs and symptoms and composites of the signs and symptoms;

further comprising the comparative healthcare information based upon one or more Loop protocols for following acute or chronic health conditions or procedures.

9. The method of clause 8, further comprising generating and sending the one or more automated alerts to the one or more healthcare providers regarding impending treatment failures or worsening of the objective health signs and subjective symptoms.

10. The method of clause 8 wherein each of the one or more ARC OF RECOVERY profiles comprises a graph having an X-axis representing time, a Y-axis representing a healthcare condition, sign, or symptom, and one or more plot lines representing an expected state of the condition, sign or symptom according to one or more rates of improvement.

11. The method of clause 1 wherein the generating and sending are based on analytics and/or machine learning algorithms.

12. The method of clause 1 wherein the period is a pre-operative, pre-procedure, or pre-encounter period of care.

13. The method of clause 1, further comprising:

determining, based on comparing a first number of the inquiry messages to a second number of the response messages associated with a particular one of the users, an engagement metric representing a level of engagement of the particular one of the users;

generating and providing, as part of the display, a graphical engagement icon representing the engagement metric for each of the users.

14. The method of clause 1, wherein the engagement metric is computed as a percentage of all the inquiry messages that received response messages from the particular one of the users, and wherein the graphical engagement icon comprises a pie chart.

15. The method of clause 1, wherein the one or more electronic protocols comprise one or more elements of tracking logic that define a tracked metric and one or more interactions with the one or more users to obtain information about the tracked metric.

16. The method of clause 1 further comprising generating and displaying one or more tracking graphs for the conditions, wherein each of the one or more tracking graphs comprises a graphical representation of historic performance of the user with respect to a tracked metric.

17. The method of clause 15, wherein the tracking logic defines:

a period;

a multiple of the period, at which the one or more interactions should occur;

optionally, an importance value;

wherein the tracking logic is configured to cause generating a change in the status of a Tracker in the display that represents the tracking logic and/or a patient's condition on a Loop feed and/or a Dashboard in the display;

wherein the tracking logic is configured to cause generating and sending the one or more automated alerts based, in part, upon a weighting of the importance value and the objective conditions or subjective conditions.

18. The method of clause 15 wherein the tracked metric comprises any one or more of:

pain level;

mood;

appetite;

blood pressure;

weight;

shortness of breath;

calf pain or calf swelling;

erythema;

incision site drainage;

hemorrhage;

a biomarker;

another indicator, sign, or symptom associated with recovery or effectiveness in follow-up care;

another indicator, sign or symptom associated with pre-visit, pre-operative, or pre-procedure care.

19. The method of clause 15 wherein one or more of the electronic protocols specifies one or more periodic reminder messages to be sent to the user on a scheduled basis or in response to a particular change in one or more of the objective conditions or subjective conditions.

20. The method of clause 15 wherein one or more of the electronic protocols specifies one or more medication instructions to be sent to the user on a scheduled basis or in response to a particular change in one or more of the objective conditions or subjective conditions.

21. The method of clause 15 wherein one or more of the electronic protocols specifies one or more care instructions to be sent to the user on a scheduled basis or in response to a particular change in one or more of the objective conditions or subjective conditions.

22. The method of clause 15 wherein one or more of the electronic protocols specifies one or more confirmations to be sent to the user on a scheduled basis or in response to a particular change in one or more of the objective conditions or subjective conditions.

23. The method of clause 15, further comprising, for a particular one of the elements of tracking logic:

receiving one or more input data items specifying a name and one or more questions with associated choices, wherein each of the one or more questions relates to a particular objective medical sign or a particular subjective patient symptom;

creating and storing the input data items as part of the particular one of the elements of tracking logic and in association with a particular name.

24. The method of clause 23 further comprising:

receiving and storing, for each of the objective medical signs and each of the subjective patient symptoms, two or more measurement values that a user is permitted to select, wherein the two or more measurement values are organized as an increasing or decreasing scale;

causing sending one or more of the inquiry messages comprising prompts to enter response values for the one or more structured healthcare data items representing objective conditions and subjective conditions of the one or more users, using the two or more measurement values according to the scale.

25. The method of clause 23 wherein the one or more questions are any of:

multiple choice questions;

numeric questions;

discrete questions having a fixed number of answers;

questions that accept a value within a specified range.

26. The method of clause 24, further comprising:

receiving, as one or more of the data items, one or more subjective responses to the questions;

storing the one or more subjective responses in the form of structured data in combination with other structured data representing objective signs of the same user;

generating and displaying a view of the objective signs and the subjective responses in combination with one or more personal images or comments received from the user relating to the user's condition.

27. The method of clause 15, wherein particular tracking logic is configured to generate one or more alert messages based upon a change in the tracked metric for a particular population set.

28. The method of clause 15, wherein the display further comprises, for each of the users, a graphical status icon representing a health status of an associated user, and wherein particular tracking logic is configured to generate a changed graphical status icon for a particular user based upon a change in the tracked metric for the particular user.

29. The method of clause 28, wherein the match is based upon a Kalman filter, Bayesian model, predictive model, regression model, stochastic model, and/or logistic model.

30. The method of clause 28, further comprising receiving an importance marker, and wherein the particular tracking logic is configured to generate the one or more alert messages based in part on an importance indicated by the importance marker.

31. The method of clause 1, wherein the generating and sending the one or more automated alerts is performed based on one or more alert conditions defined as part of application logic of the one or more computing devices, and further comprising automatically modifying the one or more alert conditions in response to trends indicated in the objective conditions and subjective conditions of the one or more users.

32. The method of clause 1, further comprising, before the generating and sending:

receiving first input identifying a patient as one of the users;

receiving second input identifying a healthcare provider;

receiving third input identifying zero or more caregivers, other than the patient, as one or more of the users;

wherein the facilitating an exchange comprises providing different data items, comparative healthcare information or automated alerts to the patient, the healthcare provider, and the zero or more caregivers.

33. The method of clause 1, further comprising:

generating data configured to cause a graphical user interface on the computer display unit, wherein the graphical user interface includes the structured data items in comparison to comparative healthcare information and the one or more automated alerts;

generating, as part of the graphical user interface, a first electronic message text from any of the one or more users, or the one or more managers;

generating, as part of the graphical user interface, a second electronic message text from any of the one or more users, or the one or more managers, wherein the second electronic message text is visually identified as a reply to the first electronic message text and associated with the first electronic message text using one or more graphical elements that indicate a conversation.

34. The method of clause 33 further comprising receiving any of the first electronic message text and the second electronic message text from any of the one or more users or the one or more managers at a time just before the generating.

35. The method of clause 33, further comprising generating a reverse chronological list that includes the one or more of the first electronic message text and second electronic message text and that comprises one or more posts of one or more patients of a healthcare provider that specify the objective conditions and subjective conditions of the one or more patients at a time when the one or more patients are not located with the healthcare provider.

36. The method of clause 33, further comprising: receiving, from the one or more managers, one or more third electronic message texts that specify comments on or replies to the first electronic message text; generating an updated graphical user interface that includes the one or more third electronic message texts; wherein the one or more third electronic message texts are received just before the generating the updated graphical user interface.

37. The method of clause 15, further comprising:

generating data configured to cause displaying a graphical user interface that includes the structured data items in comparison to comparative healthcare information and the one or more automated alerts;

generating, as part of the graphical user interface, a first electronic message text from any of the one or more users, or the one or more managers;

generating, as part of the graphical user interface, a second electronic message text from any of the one or more users, or the one or more managers, wherein the second electronic message text is visually identified as a reply to the first electronic message text and associated with the first electronic message text using one or more graphical elements that indicate a conversation.

38. The method of clause 37 further comprising receiving any of the first electronic message text and the second electronic message text from any of the one or more users or the one or more managers at a time just before the generating.

39. The method of clause 37, further comprising generating a reverse chronological list that includes the one or more of the first electronic message text and second electronic message text and that comprises one or more posts of one or more patients of a healthcare provider that specify the objective conditions and subjective conditions of the one or more patients at a time when the one or more patients are not located with the healthcare provider.

40. The method of clause 37, further comprising: receiving, from the one or more managers, one or more third electronic message texts that specify comments on or replies to the first electronic message text; generating an updated graphical user interface that includes the one or more third electronic message texts; wherein the one or more third electronic message texts are received just before the generating the updated graphical user interface.

41. The method of clause 37, further comprising presenting one or more commercial offers to the one or more users, wherein the one or more commercial offers are relevant to the tracked metric, objective conditions, subjective conditions, or healthcare information.

42. The method of clause 41 wherein the commercial offers are any of digital coupons, digital points, or digital advertisements.

43. A data processing method comprising:

creating and storing expected recovery data representing an expected progression of recovery of a patient after any of a healthcare diagnosis, treatment, procedure, surgery, or clinical encounter;

receiving, from one or more users, during a period relating to a healthcare interaction between one or more managers and the one or more users after the respective healthcare diagnosis, treatment, procedure, surgery, or clinical encounter, one or more structured healthcare data items representing objective conditions and subjective conditions of the one or more users;

comparing the one or more structured healthcare data items to the expected recovery data;

generating and causing displaying a graph comprising two or more curves that represent, for the one or more users, a first path of actual recovery and a second path of expected recovery, based on the expected recovery data and the one or more structured healthcare data items.

wherein the method is performed by one or more computing devices.

44. The method of clause 43, wherein the two or more curves represent population-based values for individuals who are reasonably matched to the one or more users and comprise different percentile trend lines.

45. The method of clause 43, further comprising:

facilitating an exchange, between the one or more managers and the one or more users, of the structured data items;

forming and causing a display, on a computer display unit, of one or more of the structured data items in comparison to comparative healthcare information based upon one or more electronic protocols that define communications and tracking of changes in specified healthcare conditions or procedures;

generating and sending, to one or more of the managers, one or more automated alerts about impending failures or worsening of one or more of the objective conditions or subjective conditions.

46. The method of clause 43, further comprising updating the expected recovery data based upon receiving the one or more structured healthcare data items for a plurality of the one or more users.

47. A data processing apparatus comprising:

a computer comprising one or more processors;

a non-transitory computer-readable storage medium storing one or more sequences of instructions comprising an electronic mail server, a hypertext transfer protocol (HTTP) server, and healthcare follow-up logic;

a database coupled to the computer and configured to store one or more accounts, loop subscription tables, and loop definition tables;

wherein the healthcare messaging logic comprises one or more sequences of instructions which when executed by the one or more processors cause performing:

receiving, from one or more users, during a period relating to a healthcare interaction between one or more managers and the one or more users, one or more structured healthcare data items representing objective conditions and subjective conditions of the one or more users;

facilitating an exchange, between the one or more managers and the one or more users, of the structured data items;

forming and causing a display, on a computer display unit, of one or more of the structured data items in comparison to comparative healthcare information based upon one or more electronic protocols that define communications and tracking of changes in specified healthcare conditions or procedures;

generating and sending, to one or more of the managers, one or more automated alerts about impending failures or worsening of one or more of the objective conditions or subjective conditions.

48. A non-transitory computer-readable storage medium storing one or more sequences of instructions which when executed cause one or more processors to perform a computer-implemented method comprising:

receiving, from one or more users, during a period relating to a healthcare interaction between one or more managers and the one or more users, one or more structured healthcare data items representing objective conditions and subjective conditions of the one or more users;

facilitating an exchange, between the one or more managers and the one or more users, of the structured data items;

forming and causing a display, on a computer display unit, of one or more of the structured data items in comparison to comparative healthcare information based upon one or more electronic protocols that define communications and tracking of changes in specified healthcare conditions or procedures;

generating and sending, to one or more of the managers, one or more automated alerts about impending failures or worsening of one or more of the objective conditions or subjective conditions.

What is claimed is:

1. A data processing method comprising:
receiving, from one or more users, during a period relating to a healthcare interaction between one or more managers and the one or more users, one or more structured healthcare data items representing objective conditions and subjective conditions of the one or more users;
facilitating an exchange, between the one or more managers and the one or more users, of the structured data items;
forming and causing a display, on a computer display unit, of one or more of the structured data items in comparison to comparative healthcare information based upon one or more electronic protocols that define communications and tracking of changes in specified healthcare conditions or procedures;
generating and sending, to one or more of the managers, one or more automated alerts about impending failures or worsening of one or more of the objective conditions or subjective conditions;
wherein the method is performed by one or more computing devices.

2. The method of claim 1 wherein the period is a follow-up period of care.

3. The method of claim 1 wherein each of the one or more electronic protocols define how to inform a patient during follow-up through automated reminders, emails, and other communications, and/or how to track a patient's signs, symptoms, objective measures, and/or condition after a diagnosis.

4. The method of claim 1 wherein the one or more managers are any of physicians, nurses, medical assistants, physician assistants, physical therapists, or other members of a healthcare team.

5. The method of claim 1 wherein the one or more users are patients or caregivers.

6. The method of claim 5 wherein the patients are animals.

7. The method of claim 1 wherein the one or more managers are affiliated with a seller of products or services and wherein the one or more users are customers or clients of the seller.

8. The method of claim 1, wherein the one or more managers are healthcare providers, the one or more users are patients of the healthcare providers, the interactions comprise healthcare interventions, the structured data items represent objective health signs and subjective symptoms of the one or more patients during a period of care by the healthcare providers;
wherein the comparative healthcare information comprises one or more ARC OF RECOVERY profiles for the signs and symptoms and composites of the signs and symptoms;
further comprising the comparative healthcare information based upon one or more Loop protocols for following acute or chronic health conditions or procedures.

9. The method of claim 8, further comprising generating and sending the one or more automated alerts to the one or more healthcare providers regarding impending treatment failures or worsening of the objective health signs and subjective symptoms.

10. The method of claim 8 wherein each of the one or more ARC OF RECOVERY profiles comprises a graph having an X-axis representing time, a Y-axis representing a healthcare condition, sign, or symptom, and one or more plot lines representing an expected state of the condition, sign or symptom according to one or more rates of improvement.

11. The method of claim 1 wherein the generating and sending are based on analytics and/or machine learning algorithms.

12. The method of claim 1 wherein the period is a pre-operative, pre-procedure, or pre-encounter period of care.

13. The method of claim 1, further comprising:
determining, based on comparing a first number of the inquiry messages to a second number of the response messages associated with a particular one of the users, an engagement metric representing a level of engagement of the particular one of the users;
generating and providing, as part of the display, a graphical engagement icon representing the engagement metric for each of the users.

14. The method of claim 1, wherein the engagement metric is computed as a percentage of all the inquiry messages that received response messages from the particular one of the users, and wherein the graphical engagement icon comprises a pie chart.

15. The method of claim 1, wherein the one or more electronic protocols comprise one or more elements of tracking logic that define a tracked metric and one or more interactions with the one or more users to obtain information about the tracked metric.

16. The method of claim 1 further comprising generating and displaying one or more tracking graphs for the conditions, wherein each of the one or more tracking graphs comprises a graphical representation of historic performance of the user with respect to a tracked metric.

17. The method of claim 15, wherein the tracking logic defines:
a period;
a multiple of the period, at which the one or more interactions should occur;
optionally, an importance value;
wherein the tracking logic is configured to cause generating a change in the status of a Tracker in the display that represents the tracking logic and/or a patient's condition on a Loop feed and/or a Dashboard in the display;
wherein the tracking logic is configured to cause generating and sending the one or more automated alerts based, in part, upon a weighting of the importance value and the objective conditions or subjective conditions.

18. The method of claim 15 wherein the tracked metric comprises any one or more of:
pain level;
mood;
appetite;
blood pressure;
weight;
shortness of breath;
a biomarker;
another indicator, sign, or symptom associated with recovery or effectiveness in follow-up care;
another indicator, sign or symptom associated with pre-visit, pre-operative, or pre-procedure care.

19. The method of claim 15 wherein one or more of the electronic protocols specifies one or more periodic reminder messages to be sent to the user on a scheduled basis or in response to a particular change in one or more of the objective conditions or subjective conditions.

20. The method of claim 15 wherein one or more of the electronic protocols specifies one or more medication instructions to be sent to the user on a scheduled basis or in response to a particular change in one or more of the objective conditions or subjective conditions.

21. The method of claim 15 wherein one or more of the electronic protocols specifies one or more care instructions to be sent to the user on a scheduled basis or in response to a particular change in one or more of the objective conditions or subjective conditions.

22. The method of claim 15 wherein one or more of the electronic protocols specifies one or more confirmations to be sent to the user on a scheduled basis or in response to a particular change in one or more of the objective conditions or subjective conditions.

23. The method of claim 15, further comprising, for a particular one of the elements of tracking logic:
receiving one or more input data items specifying a name and one or more questions with associated choices, wherein each of the one or more questions relates to a particular objective medical sign or a particular subjective patient symptom;
creating and storing the input data items as part of the particular one of the elements of tracking logic and in association with a particular name.

24. The method of claim 23 further comprising:
receiving and storing, for each of the objective medical signs and each of the subjective patient symptoms, two or more measurement values that a user is permitted to select, wherein the two or more measurement values are organized as an increasing or decreasing scale;
causing sending one or more of the inquiry messages comprising prompts to enter response values for the one or more structured healthcare data items representing objective conditions and subjective conditions of the one or more users, using the two or more measurement values according to the scale.

25. The method of claim 23 wherein the one or more questions are any of:
multiple choice questions;
numeric questions;
discrete questions having a fixed number of answers;
questions that accept a value within a specified range.

26. The method of claim 24, further comprising:
receiving, as one or more of the data items, one or more subjective responses to the questions;
storing the one or more subjective responses in the form of structured data in combination with other structured data representing objective signs of the same user;
generating and displaying a view of the objective signs and the subjective responses in combination with one or more personal images or comments received from the user relating to the user's condition.

27. The method of claim 15, wherein particular tracking logic is configured to generate one or more alert messages based upon a change in the tracked metric for a particular population set.

28. The method of claim 15, wherein the display further comprises, for each of the users, a graphical status icon representing a health status of an associated user, and wherein particular tracking logic is configured to generate a changed graphical status icon for a particular user based upon a change in the tracked metric for the particular user.

29. The method of claim 28, wherein an alert is based upon a Kalman filter, Bayesian model, predictive model, regression model, stochastic model, and/or logistic model.

30. The method of claim 28, further comprising receiving an importance marker, and wherein the particular tracking logic is configured to generate the one or more alert messages based in part on an importance indicated by the importance marker.

31. The method of claim 1, wherein the generating and sending the one or more automated alerts is performed based on one or more alert conditions defined as part of application logic of the one or more computing devices, and further comprising automatically modifying the one or more alert conditions in response to trends indicated in the objective conditions and subjective conditions of the one or more users.

32. The method of claim 1, further comprising, before the generating and sending:
receiving first input identifying a patient as one of the users;
receiving second input identifying a healthcare provider;
receiving third input identifying zero or more caregivers, other than the patient, as one or more of the users;
wherein the facilitating an exchange comprises providing different data items, comparative healthcare information or automated alerts to the patient, the healthcare provider, and the zero or more caregivers.

33. The method of claim 1, further comprising:
generating data configured to cause a graphical user interface on the computer display unit, wherein the graphical user interface includes the structured data items in comparison to comparative healthcare information and the one or more automated alerts;
generating, as part of the graphical user interface, a first electronic message text from any of the one or more users, or the one or more managers;
generating, as part of the graphical user interface, a second electronic message text from any of the one or more users, or the one or more managers, wherein the second electronic message text is visually identified as a reply to the first electronic message text and associated with the first electronic message text using one or more graphical elements that indicate a conversation.

34. The method of claim 33 further comprising receiving any of the first electronic message text and the second electronic message text from any of the one or more users or the one or more managers at a time just before the generating.

35. The method of claim 33, further comprising generating a reverse chronological list that includes the one or more of the first electronic message text and second electronic message text and that comprises one or more posts of one or more patients of a healthcare provider that specify the objective conditions and subjective conditions of the one or more patients at a time when the one or more patients are not located with the healthcare provider.

36. The method of claim 33, further comprising: receiving, from the one or more managers, one or more third electronic message texts that specify comments on or replies to the first electronic message text; generating an updated graphical user interface that includes the one or more third electronic message texts; wherein the one or more third electronic message texts are received just before the generating the updated graphical user interface.

37. The method of claim 15, further comprising:
generating data configured to cause displaying a graphical user interface that includes the structured data items in comparison to comparative healthcare information and the one or more automated alerts;
generating, as part of the graphical user interface, a first electronic message text from any of the one or more users, or the one or more managers;
generating, as part of the graphical user interface, a second electronic message text from any of the one or more users, or the one or more managers, wherein the second electronic message text is visually identified as a reply to the first electronic message text and associated with the first electronic message text using one or more graphical elements that indicate a conversation.

38. The method of claim 37 further comprising receiving any of the first electronic message text and the second electronic message text from any of the one or more users or the one or more managers at a time just before the generating.

39. The method of claim 37, further comprising generating a reverse chronological list that includes the one or more of the first electronic message text and second electronic message text and that comprises one or more posts of one or more patients of a healthcare provider that specify the objective conditions and subjective conditions of the one or more patients at a time when the one or more patients are not located with the healthcare provider.

40. The method of claim 37, further comprising: receiving, from the one or more managers, one or more third electronic message texts that specify comments on or replies to the first electronic message text; generating an updated graphical user interface that includes the one or more third electronic message texts; wherein the one or more third electronic message texts are received just before the generating the updated graphical user interface.

41. The method of claim 37, further comprising presenting one or more commercial offers to the one or more users, wherein the one or more commercial offers are relevant to the tracked metric, objective conditions, subjective conditions, or healthcare information.

42. The method of claim 41 wherein the commercial offers are any of digital coupons, digital points, or digital advertisements.

43. A data processing method comprising:
creating and storing expected recovery data representing an expected progression of a patient before and/or after any of a healthcare diagnosis, treatment, procedure, surgery, or clinical encounter;
receiving, from one or more users, during a period relating to a healthcare interaction between one or more managers and the one or more users after the respective healthcare diagnosis, treatment, procedure, surgery, or clinical encounter, one or more structured healthcare data items representing objective conditions and subjective conditions of the one or more users;
comparing the one or more structured healthcare data items to the expected progression or recovery data;
generating and causing displaying a graph comprising two or more curves that represent, for the one or more users, a first path of actual progression or recovery and a second path of expected progression or recovery, based on the expected progression or recovery data and the one or more structured healthcare data items.
wherein the method is performed by one or more computing devices.

44. The method of claim 43, wherein the two or more curves represent population-based values for individuals who are reasonably matched to the one or more users and comprise different percentile trend lines.

45. The method of claim 43, further comprising:
facilitating an exchange, between the one or more managers and the one or more users, of the structured data items;
forming and causing a display, on a computer display unit, of one or more of the structured data items in comparison to comparative healthcare information based upon one or more electronic protocols that define communications and tracking of changes in specified healthcare conditions or procedures;
generating and sending, to one or more of the managers, one or more automated alerts about impending failures or worsening of one or more of the objective conditions or subjective conditions.

46. The method of claim 43, further comprising updating the expected progression or recovery data based upon receiving the one or more structured healthcare data items for a plurality of the one or more users.

47. A data processing apparatus comprising:
a computer comprising one or more processors;
a non-transitory computer-readable storage medium storing one or more sequences of instructions comprising an electronic mail server, a hypertext transfer protocol (HTTP) server, and healthcare follow-up logic;
a database coupled to the computer and configured to store one or more accounts, loop subscription tables, and loop definition tables;
wherein the healthcare messaging logic comprises one or more sequences of instructions which when executed by the one or more processors cause performing:
receiving, from one or more users, during a period relating to a healthcare interaction between one or more managers and the one or more users, one or more structured healthcare data items representing objective conditions and subjective conditions of the one or more users;
facilitating an exchange, between the one or more managers and the one or more users, of the structured data items;
forming and causing a display, on a computer display unit, of one or more of the structured data items in comparison to comparative healthcare information based upon one or more electronic protocols that define communications and tracking of changes in specified healthcare conditions or procedures;
generating and sending, to one or more of the managers, one or more automated alerts about impending failures or worsening of one or more of the objective conditions or subjective conditions.

48. A non-transitory computer-readable storage medium storing one or more sequences of instructions which when executed cause one or more processors to perform a computer-implemented method comprising:
receiving, from one or more users, during a period relating to a healthcare interaction between one or more managers and the one or more users, one or more structured healthcare data items representing objective conditions and subjective conditions of the one or more users;
facilitating an exchange, between the one or more managers and the one or more users, of the structured data items;
forming and causing a display, on a computer display unit, of one or more of the structured data items in comparison to comparative healthcare information based upon one or more electronic protocols that define communications and tracking of changes in specified healthcare conditions or procedures;
generating and sending, to one or more of the managers, one or more automated alerts about impending failures or worsening of one or more of the objective conditions or subjective conditions.
